(19) United States
(12) Patent Application Publication
(10) Pub. No.: US 2020/0196649 A1
(43) Pub. Date: Jun. 25, 2020

(54) IMPROVING THE TASTE OF CONSUMABLES

(71) Applicant: The Product Makers (Australia) Pty Ltd, Keysborough, Victoria (AU)

(72) Inventors: Shane MITCHELL, Keysborough, Victoria (AU); Barry KITCHEN, Keysborough, Victoria (AU); Gregor MACNAB, Keysborough, Victoria (AU); Julian NEOH, Keysborough, Victoria (AU); Matthew FLAVEL, Keysborough, Victoria (AU)

(21) Appl. No.: 16/643,281

(22) PCT Filed: Aug. 30, 2018
(86) PCT No.: PCT/AU2018/050934

§ 371 Date: Feb. 28, 2020

(30) Foreign Application Priority Data
Aug. 31, 2017 (AU) 2017903513

(51) Int. Cl. A23L 27/00; A23L 2/56; A23L 27/30; A23L 2/60; A23F 3/40; A23C 9/156; C13B 20/14; C13B 20/16

(52) U.S. Cl. CPC A23L 27/88; A23L 27/84; A23L 2/56; A23L 27/34; C13B 20/165; A23F 3/405; A23C 9/156; C13B 20/148; A23L 2/60

(57) ABSTRACT

This application relates to polyphenol containing sugar cane extracts for improving or masking taste or mouthfeel of consumables containing a sugar substitute, low sugar consumables or reduced sugar consumables. The polyphenol containing sugar cane extracts can be used in methods for improving or masking the taste of consumables containing a sugar substitute, low sugar consumables or reduced sugar consumables by including an effective amount of a polyphenol containing sugar cane extract in the consumable. The polyphenol containing sugar cane extracts can also be used in compositions for improving or masking the taste of a sugar substitute by including an effective amount of a polyphenol containing sugar cane extract in the composition.

### CROSS-REFERENCE TO RELATED APPLICATIONS

The present application claims priority from Australian Provisional Patent Application No 2017903513 filed on 31 Aug. 2017, the content of which is incorporated herein by reference.

### TECHNICAL FIELD

This application relates to polyphenol containing sugar cane extracts for improving or masking taste or mouthfeel of consumables containing a sugar substitute, low sugar consumables or reduced sugar consumables. The polyphenol containing sugar cane extracts can be used in methods for improving or masking the taste of consumables containing a sugar substitute, low sugar consumables or reduced sugar consumables by including an effective amount of a polyphenol containing sugar cane extract in the consumable. The polyphenol containing sugar cane extracts can also be used in compositions for improving or masking the taste of a sugar substitute by including an effective amount of a polyphenol containing sugar cane extract in the composition.

### BACKGROUND

With increasing concerns about healthy living and reducing obesity, there has been a push to provide low sugar or reduced sugar alternatives for consumables. However, simply reducing the amount of sugar in a consumable can negatively impact consumer satisfaction as it can impact on the overall flavour of the consumable. Hence, there is a need to improve the taste of a low sugar consumable or reduced sugar consumable.

Sugar substitutes provide sugar-like taste while their food energy is much lower than that of sugar. Sugar substitutes have been widely used in various consumables such as food products, beverages and pharmaceutical preparations for taste preference, for lifestyle reasons, or for certain individuals (such as diabetic patients) for health-related goals.

Some sugar substitutes have sweetness many times higher than that of common sugar; these sugar substitutes are called high-intensity sweeteners. High-intensity sweeteners include stevia, aspartame, sucralose, neotame, acesulfame potassium, saccharin, mogroside and advantame. Since high-intensity sweeteners have sweetness much higher that of sugar, a much smaller amount of high-intensity sweeteners compared to common sugar is required to sweeten consumables.

Even though there is widespread use of sugar substitutes some consumers disfavour consumables containing sugar substitutes because the sensation or texture of the sugar substitutes are often notably different from that of common sugar. Different mouthfeel, different body, slow onset of sweet taste, bitter after note, lingering sweetness, lingering bitterness, metallic taste and/or side effects of sugar substitutes are some of the reasons that some consumers dislike consumables containing sugar substitutes.

Several methods have been described for modifying or improving a taste or mouthfeel of consumables containing sugar substitutes.

U.S. Pat. No. 5,336,513 discloses a process for reducing bitterness of a food preparation containing artificial sweeteners such as acesulfame potassium by means of adding ferulic acid or a salt thereof to the food preparation.

WO2009137838 discloses a sweetener comprising a high intensity sweetener and a taste modifying composition comprising at least one non-congruent flavour volatile.

WO2008112967 discloses methods of improving taste of a non-nutritive steviol glycoside sweetener by using anisic acid to mask metallic aftertaste of the non-nutritive steviol glycoside sweetener when the sweetener is contained in a beverage, beverage concentrate or syrup, or reduced calorie sweetener.

However, none of the documents describes a method for modifying or improving a taste or mouthfeel of a consumable containing a sugar substitute, a low sugar consumable or a reduced sugar consumable, by means of using polyphenol containing sugar cane extracts such as those of the present disclosure.

There is a need to develop an extract derived from a natural source, which improves or masks the taste or mouthfeel of a consumable containing a sugar substitute, a low sugar consumable or a reduced sugar consumable.

Any discussion of documents, acts, materials, devices, articles or the like which has been included in the present disclosure is not to be taken as an admission that any or all of these matters form part of the prior art base or were common general knowledge in the field relevant to the present disclosure as it existed before the priority date of each claim of this application.

### SUMMARY

In one aspect of the disclosure there is provided a method for improving or masking taste or mouthfeel of a consumable containing a sugar substitute, the method comprising including from about 0.01 wt % to about 10 wt % or about 0.01% v/v to about 10% v/v of an extract derived from sugar cane in the consumable, the extract derived from sugar cane comprising from about 10 catechin equivalent (CE) g/L to about 50 CE g/L of polyphenols or from about 100 CE mg/g to about 500 CE mg/g of polyphenols.

In one aspect of the disclosure there is provided a method for improving or masking taste or mouthfeel of a low sugar or reduced sugar consumable, the method comprising including from about 0.01 wt % to about 10 wt % or about 0.01% v/v to about 10% v/v of an extract derived from sugar cane in the consumable, the extract derived from sugar cane comprising from about 10 catechin equivalent (CE) g/L to about 50 CE g/L of polyphenols or from about 100 CE mg/g to about 500 CE mg/g of polyphenols.

In another aspect of the disclosure there is provided use of an extract derived from sugar cane comprising about 10 CE g/L to about 50 CE g/L of polyphenols or from about 100 CE mg/g to about 500 CE mg/g of polyphenols for improving or masking taste or mouthfeel of a consumable containing a sugar substitute, wherein the consumable contains from about 0.01 wt % to about 10 wt % or about 0.01% v/v to about 10% v/v of the extract derived from sugar cane.

In another aspect of the disclosure there is provided use of an extract derived from sugar cane comprising about 10 CE g/L to about 50 CE g/L of polyphenols or from about 100 CE mg/g to about 500 CE mg/g of polyphenols for improving or masking taste or mouthfeel of a low sugar or reduced sugar consumable, wherein the consumable contains from about 0.01 wt % to about 10 wt % or about 0.01% v/v to about 10% v/v of the extract derived from sugar cane.

In another aspect of the disclosure there is provided a composition comprising a sugar substitute and a constituent to improve or mask taste or mouthfeel of the sugar substitute, wherein the constituent comprises an extract derived from sugar cane comprising about 10 CE g/L to about 50 CE g/L of polyphenols or from about 100 CE mg/g to about 500 CE mg/g of polyphenols, wherein the constituent contains from about 0.01 wt % to about 10 wt % or about 0.01% v/v to about 10% v/v of the extract derived from sugar cane.

In another aspect of the disclosure there is provided a taste or mouthfeel improving or masking agent, wherein the agent is an extract derived from sugar cane comprising about 10 CE g/L to about 50 CE g/L of polyphenols or from about 100 CE mg/g to about 500 CE mg/g of polyphenols.

In one embodiment, the low sugar consumable contains less than about 5% of sugar.

In one embodiment, the reduced sugar consumable contains about 10% to about 30% less sugar than a standard version of the consumable.

In one embodiment, the consumable comprises from about 0.01 wt % to about 1.0 wt % or about 0.01% v/v to about 1.0% v/v of the extract.

In one embodiment, the sugar substitute is in the range of from about 0.0001 wt % to about 0.1 wt % of the consumable.

In one embodiment, the sugar substitute is in the range of from about 0.001 wt % to about 0.01 wt % of the consumable.

In one embodiment, the taste is selected from the group consisting of sweet, bitter, metallic, astringent, acidity, sour, fruity, salty, liquorice, umami and combinations thereof.

In one embodiment, the taste is an aftertaste.

In one embodiment, the mouthfeel is selected from the group consisting of smooth, dry, chalky, grainy, greasy, gummy, watery, oily, tingly, waxy, bound, rough, round, slimy, body and combinations thereof.

In one embodiment, the sugar substitute is selected from the group consisting of stevia, steviol glycosides, aspartame, acesulfame potassium, sucralose, cyclamate, saccharin, mogroside, rubusoside, siamenoside, monatin, curculin, glycyrrhizic acid, thaumatin, monellin, mabinlin, brazzein, hernandulcin, phyllodulcin, glycyphyllin, phloridzin, trilobatin, baiyunoside, osladin, polypodoside, pterocaryoside, mukurozioside, phlomisoside, periandrin, abrusoside, clocarioside, Monk fruit extracts, neotame, advantame, sugar alcohols, salts and combinations thereof.

In one embodiment, the sugar substitute is selected from the group consisting of stevioside, rebaudioside A, rebaudioside B, rebaudioside C, rebaudioside D, rebaudioside E, rebaudioside F, dulcoside A, dulcoside B, rubusoside, mogroside IV, mogroside V, siamenoside, monatin, monatin SS, monatin RR, monatin RS, monatin SR, curculin, glycyrrhizic acid and its salts, thaumatin, monellin, mabinlin, brazzein, hernandulcin, phyllodulcin, glycyphyllin, phloridzin, trilobatin, baiyunoside, osladin, polypodoside A, pterocaryoside A, pterocaryoside B, mukurozioside, phlomisoside I, periandrin I, abrusoside A, cyclocarioside I, aspartame, acesulfame potassium, sucralose, cyclamate, saccharin, Monk fruit extract, neotame, advantame, erythritol, arabitol, isomalt, lactitol, maltitol, mannitol, sorbitol, xylitol, isomaltulose and combinations thereof.

In one embodiment, the sugar substitute is selected from the group consisting of stevia, steviol glycosides, stevioside, rebaudioside A, rebaudioside B, dulcoside A, dulcoside B, erythritol, aspartame, acesulfame potassium, sucralose, cyclamate, saccharin, mogroside, Monk fruit extract, neotame, advantame, isomaltulose and combinations thereof.

In one embodiment, the sugar substitute is stevia, steviol glycosides, stevioside, rebaudioside A or combinations thereof.

In one embodiment, the consumable is selected from the group consisting of a food, beverage and pharmaceutical preparation.

In one embodiment, the consumable is a beverage.

In one embodiment, the beverage is a carbonated beverage.

In one embodiment, the carbonated beverage is selected from the group consisting of a cola, fruit-flavoured beverage, a root beer, alcoholic beverage and flavoured water.

In one embodiment, the carbonated beverage is a cola.

In one embodiment, the beverage is selected from the group consisting of a fruit juice, fruit-containing beverage, vegetable juice, vegetable-containing beverage, tea, coffee, dairy beverage, cocoa beverage, soy milk, flavoured animal milk, almond milk, coconut milk, liquid breakfast, sports drink, energy drink, alcoholic beverage, fermented products and flavoured water.

In one embodiment, the beverage is fruit-flavoured beverage, sports drink, energy drink, flavoured water or tea.

In one embodiment, the extract is derived from a sugar cane derived product selected from the group consisting of molasses, massecuite, bagasse, first expressed juice, mill mud, clarified sugar cane juice, clarified syrup, treacle, golden syrup, field trash, cane strippings, dunder and combinations thereof.

In one embodiment, the sugar cane derived product is molasses.

In one embodiment, the extract derived from sugar cane comprises from about 15 CE g/L to about 40 CE g/L of polyphenols or about 150 CE mg/g to about 400 CE mg/g of polyphenols.

In one embodiment, the polyphenols comprise one or more of syringic acid, chlorogenic acid, caffeic acid, vanillin, sinapic acid, p-coumaric acid, ferulic acid, gallic acid, vanillic acid, diosmin, diosmetin, apigenin, vitexin, orientin, homoorientin, swertisin, tricin, (+)catechin, (−)catechin gallate, (−)epicatechin, quercetin, kaempherol, myricetin, rutin, schaftoside, isoschaftoside and luteolin.

In one embodiment, the composition is in a dry form or a liquid form.

In one embodiment, the constituent is coated onto the sugar substitute.

In one embodiment, a consumable comprises the composition.

In one embodiment, a beverage comprises the composition.

### BRIEF DESCRIPTION OF DRAWINGS

Whilst it will be appreciated that a variety of embodiments of the disclosure may be utilised, in the following, we describe a number of examples of the disclosure with reference to the following drawings:

FIG. 1 exhibits an exemplary process for the preparation of extracts derived from molasses.

FIG. 2 exhibits another exemplary process for the preparation of extracts derived from molasses.

FIG. 3 exhibits base peak chromatograms (FTMS negative) of three extracts from molasses obtained by the process of FIG. 1 and analysed by LCMS. A) resin bound sample, B) resin unbound sample, and C) 74 Brix sample;

FIG. 4 exhibits ¹H NMR spectra of three extracts from molasses obtained by the process of FIG. 1 in D₂O with TSP (at 0.00 ppm) as reference. A) resin bound sample, B) resin unbound sample, and C) 74 Brix sample. Arrows indicate associated peak signals to specific sugars: nine arrows pointing up—sucrose; two arrows pointing down and two arrows pointing diagonally down—glucose; two arrows pointing down in the middle—fructose.

FIG. 5 exhibits expanded 0.6-3.2 ppm region of the ¹H NMR spectra of the resin unbound (B) and resin bound (A) extracts obtained by the process of FIG. 1 in D₂O with TSP as reference.

FIG. 6 exhibits expanded 5.0-10.0 ppm region of the ¹H NMR spectra of the resin unbound (B) and resin bound (A) extracts obtained by the process of FIG. 1 in D₂O with TSP as reference.

FIG. 7 exhibits the spectra of three extracts from molasses analysed by GC-MS. A) resin bound sample (Extract A) prepared according to the process in FIG. 1, and B) resin bound sample (Extract D) prepared according to the process in FIG. 2.

FIG. 8 exhibits a LC-MS spectrum of a representative extract derived from sugar cane molasses prepared according to Example 3.

FIG. 9 exhibits a process for the preparation of extracts derived from dunder.

FIG. 10 exhibits LC-MS spectra for sugar cane dunder starting material (A) and an extract of sugar cane dunder prepared according to Example 4 (B).

FIG. 11 exhibits a process for the preparation of extracts derived from dunder and molasses.

FIG. 12 exhibits a radar chart comparing taste and mouthfeel of Coca Cola Life standard with Coca Cola Life test with 0.1% extract derived from sugar cane.

FIG. 13 exhibits a radar chart comparing taste and mouthfeel of Coca Cola Zero standard with Coca Cola Zero test with 0.1% extract derived from sugar cane.

FIG. 14 exhibits a radar chart comparing taste and mouthfeel of Diet Coke standard with Diet Coke test with 0.1% extract derived from sugar cane.

FIG. 15 exhibits a radar chart comparing taste and mouthfeel of Pepsi Max standard with Pepsi Max test with 0.1% extract derived from sugar cane.

FIG. 16 exhibits a radar chart comparing taste and mouthfeel of Pepsi Lite standard with Pepsi Lite test with 0.1% extract derived from sugar cane.

FIG. 17 exhibits a radar chart comparing taste and mouthfeel of Lipton Light Peach Tea standard with Lipton Light Peach Tea test with 0.1% extract derived from sugar cane.

FIG. 18 exhibits a radar chart comparing taste and mouthfeel of Lipton Peach Tea standard with Lipton Peach Tea test with 0.1% extract derived from sugar cane.

FIG. 19 exhibits a radar chart comparing taste and mouthfeel of Sunkist Orange standard with Sunkist Orange test with 0.1% extract derived from sugar cane.

FIG. 20 exhibits a radar chart comparing taste and mouthfeel of Powerade Zero standard with Powerade Zero test with 0.1% extract derived from sugar cane.

FIG. 21 exhibits a radar chart comparing taste and mouthfeel of V Zero standard with V Zero test with 0.1% extract derived from sugar cane.

FIG. 22 exhibits a radar chart comparing taste and mouthfeel of V Sugar Free standard with V Sugar Free test with 0.1% extract derived from sugar cane.

FIG. 23 exhibits a radar chart comparing taste and mouthfeel of Red Bull Zero standard with Red Bull Zero test with 0.1% extract derived from sugar cane.

FIG. 24 exhibits a radar chart comparing taste and mouthfeel of Red Bull Sugar Free standard with Red Bull Sugar Free test with 0.1% extract derived from sugar cane.

FIG. 25 exhibits a radar chart comparing taste of cola with standard sugar with cola with 20% reduced sugar test with 0.1% of an extract derived from sugar cane.

FIG. 26 exhibits a radar chart comparing taste and mouthfeel of cola with 20% or 30% reduced sugar with cola with 20% or 30% reduced sugar tests with 0.1% extract derived from sugar cane.

FIG. 27 exhibits a radar chart comparing taste and mouthfeel of a chocolate soy milk standard with chocolate soy milk with 20% reduced sugar test with 0.1% extract derived from sugar cane.

FIG. 28 exhibits a radar chart comparing taste and mouthfeel of a lemon tea standard with lemon tea with 20% reduced sugar test with 0.1% extract derived from sugar cane.

FIG. 29 exhibits a radar chart comparing taste and mouthfeel of a coffee drink standard with coffee drink with 20% reduced sugar test with 0.1% extract derived from sugar cane.

FIG. 30 exhibits a radar chart comparing taste and mouthfeel of an energy drink standard with an energy drink with 20% reduced sugar test with 0.05% extract derived from sugar cane.

FIG. 31 exhibits a radar chart comparing taste and mouthfeel of chocolate Up & Go standard with chocolate Up & Go with 20% reduced sugar test with 0.03% extract derived from sugar cane.

### DETAILED DESCRIPTION

### General Techniques and Definitions

Unless specifically defined otherwise, all technical and scientific terms used herein shall be taken to have the same meaning as commonly understood by one of ordinary skill in the art (e.g., chemistry, biochemistry, formulation science, food and nutritional science, cell culture, and molecular biology). Further, unless otherwise required by context, singular terms shall include pluralities and plural terms shall include the singular. Thus, as used in this specification and the appended claims, the singular forms “a”, “an” and “the” include plural referents unless the context clearly indicates otherwise. Thus, the term “a subject” means “one or more subjects” unless the context clearly indicates otherwise.

The phrase “an effective amount” as used herein, refers to an amount which is sufficient to improve or mask taste or mouthfeel of a consumable containing a sugar substitute, a low sugar consumable or a reduced sugar consumable to an animal or human that is being sought by a researcher, taste specialist or consumer.

An appropriate “effective amount” in any individual case may be determined by one of ordinary skill in the art using routine experimentation. The effective amount in this context includes an amount required to improve or mask taste or mouthfeel of a consumable containing a sugar substitute, a low sugar consumable or a reduced sugar consumable.

The term “about” as used herein refers to a range of +/−5% of the specified value.

The term “CE”, or “catechin equivalent” as used herein, is a measure of total polyphenolic content, expressed as catechin equivalents mg/g extract derived from sugar cane or catechin equivalents g/L extract derived from sugar cane.

The term “GAE”, or “gallic acid equivalent” as used herein, is a measure of total polyphenolic content, expressed as gallic acid equivalents mg/g extract derived from sugar cane or gallic acid equivalents g/L extract derived from sugar cane.

Throughout this specification, references to amounts of polyphenols appear, for example as, “CE g/L of polyphenols” and “CE mg/g of polyphenols”. Such references define the amount of polyphenols expressed as catechin equivalents in grams or milligrams in each gram or litre (respectively) of the extract derived from sugar cane.

The term “free amino acids” as used herein, refers to amino acids which are singular molecules and structurally not attached to peptide bonds which are attached to other amino acids.

The term “low sugar consumable” as used herein, refers to a consumable comprising less than 5% w/w, w/v, v/v or v/w of sugar.

The term “reduced sugar consumable” as used herein, refers to a consumable which contains about 5% to about 50% w/w, w/v, v/v or v/w less sugar than a standard version of the consumable.

The term “%” as used herein, may refer to % w/w, % v/v, % w/v or % v/w. An appropriate “%” in any individual case may be determined by one of ordinary skill in the art depending on the specific circumstances. For example, a solid or liquid sugar substitute may be added to a solid or liquid consumable and as such the appropriate “%” will depend on the form of the sugar substitute and the form of the consumable. Similarly, the extract from sugar cane may be a liquid or solid and may be added to a liquid or solid consumable. One of ordinary skill in the art will readily be able to determine the appropriate “%” given the circumstances.

The term “sugar cane derived product” as used herein, refers to products of the sugar cane milling and refining processes including, but not limited to, sugar, molasses, massecuite, bagasse, first expressed juice, mill mud, clarified sugar cane juice, clarified syrup, treacle, golden syrup, field trash, cane strippings, leaves, growing tips, pulp and dunder and combinations thereof. Dunder is the residue produced when a product such as sugar or molasses is fermented to give, for example, ethanol. Sugar cane dunder is also referred to as biodunder, stillage or vinasse. As used herein, the terms “dunder”, “bio-dunder”, “stillage” and “vinasse” are equivalent and used interchangeably.

Throughout this specification, various aspects and components of the disclosure can be presented in a range format. The range format is included for convenience and should not be interpreted as an inflexible limitation on the scope of the disclosure. Accordingly, the description of a range should be considered to have specifically disclosed all the possible sub-ranges as well as individual numerical values within that range, unless specifically indicated. For example, description of a range such as from 1 to 5 should be considered to have specifically disclosed sub-ranges such as from 1 to 3, from 1 to 4, from 1 to 5, from 2 to 4, from 2 to 5, from 3 to 5 etc., as well as individual and partial numbers within the recited range, for example, 1, 2, 3, 4, 5, 5.5 and 6, unless where integers are required or implicit from context. This applies regardless of the breadth of the disclosed range. Where specific values are required, these will be indicated in the specification.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Extracts Derived from Sugar Cane

It has been previously demonstrated that sugar cane waste and sugar cane extracts can provide various benefits to human beings and animals. For example, sugar cane waste has been used for feed for animals and for a source to the bio-fuel industry. It has also been reported that some sugar cane extracts containing phytochemicals may be used as a nutritional supplements to provide a boost of energy and that some sugar cane extracts containing phytochemicals have the ability to lower the glycaemic index (GI) of foods and beverages. Lowering the GI of foods and beverages has potential applications, such as in reducing the risk of, and regulating and/or managing, conditions such as obesity and diabetes.

Certain documents provide processes for producing sugar cane extracts and the use of such extracts in methods of lowering the available calorific value of foods and/or beverages, in treating or preventing diseases, and as a nutritional supplements, dietary supplements, food ingredients, food modifiers, sports nutrition products, food coatings and/or pharmaceutical products (e.g. WO2014032100, WO2012106761).

However, the use of extracts derived from sugar cane comprising a specific range of polyphenol content has not previously been described in the application of improving or masking taste or mouthfeel of a consumable containing a sugar substitute, a low sugar consumable or a reduced sugar consumable. The present inventors have surprisingly found that the polyphenol containing extracts derived from sugar cane of the present disclosure can be used to improve or mask taste or mouthfeel of a consumable containing a sugar substitute, a low sugar consumable or a reduced sugar consumable.

Polyphenol containing extracts derived from sugar cane of the present disclosure have been demonstrated to improve or mask taste or mouthfeel of a consumable containing a sugar substitute, a low sugar consumable or a reduced sugar consumable.

Exemplary Processes for Producing Extracts Derived from Sugar Cane

A suitable process for producing the extract derived from sugar cane may be determined by a person skilled in the art. Exemplary processes are provided below.

### Feedstock for the Extraction Process

After being mechanically harvested, sugar cane is transported to a mill and crushed between serrated rollers. The crushed sugar cane is then pressed to extract raw sugar juice and leaves fibrous material known as bagasse (typically used as fuel). The raw juice is then heated to its boiling point to extract any impurities, then lime and bleaching agents are added and mill mud is removed. The raw juice is further heated under vacuum to concentrate and increase the Brix value. The concentrated syrup is seeded to produce bulk sugar crystals and a thick syrup known as molasses. The two are separated by a centrifuge and typically the molasses waste stream is collected for use as a low-grade animal feedstock.

The extracts produced according to the processes of the disclosure can be derived from any sugar cane derived product, including those produced during the sugar cane milling process, the sugar cane refining process and other processes using sugar cane products.

Accordingly, the term “sugar cane derived product” as used herein refers to products of the sugar cane milling and refining processes including, but not limited to, molasses, massecuite, bagasse, first expressed juice, mill mud, clarified sugar cane juice, clarified syrup, treacle, golden syrup, field trash, cane strippings, growing tips, pulp, dunder and combinations thereof. In one embodiment, the sugar cane derived product is molasses or dunder. In another embodiment, the sugar cane derived product is molasses. In another embodiment, the sugar cane derived product is dunder. In another embodiment, the sugar cane derived product is massecuite. In another embodiment, the sugar cane derived product is a combination of molasses and dunder. In another embodiment, the sugar cane derived product is bagasse. In another embodiment, the sugar cane derived product is first expressed juice. In another embodiment, the sugar cane derived product is mill mud. In another embodiment, the sugar cane derived product is clarified sugar cane juice. In another embodiment, the sugar cane derived product is clarified syrup. In another embodiment, the sugar cane derived product is treacle. In another embodiment, the sugar cane derived product is golden syrup. In another embodiment, the sugar cane derived product is field trash. In another embodiment, the sugar cane derived product is cane strippings. In another embodiment, the sugar cane derived product is growing tips. In another embodiment, the sugar cane derived product is pulp.

Sugar cane derived products generally comprise complex mixtures of substances including, but not limited to, polyphenols, phytosterols, monosaccharides, disaccharides, oligosaccharides, polysaccharides, organic acids, amino acids, peptides, proteins, vitamins, and minerals.

As would be understood by a person skilled in the art, polyphenols are compounds characterized by the presence of multiple phenol structural units. Polyphenols may be classified into sub-groups by their chemical structure. Examples of sub-groups of polyphenols include, but are not limited to, flavonoids (including flavones, flavanols, flavonols), hydroxybenzoic acids, hydroxycinamic acids, catechins, proanthocyanidins, anthocyanidins, stilbenes, lignans, and phenolic acids. The polyphenols of sugar cane derived products also include conjugates such as, for example, glycosides, glucosides, galactosides, galacturonides, ethers, esters, arabino sides, sulphates, phosphates, aldopentoses (xylose, arabinose) and aldohexoses.

### Exemplary Processes Involving an Extraction Step

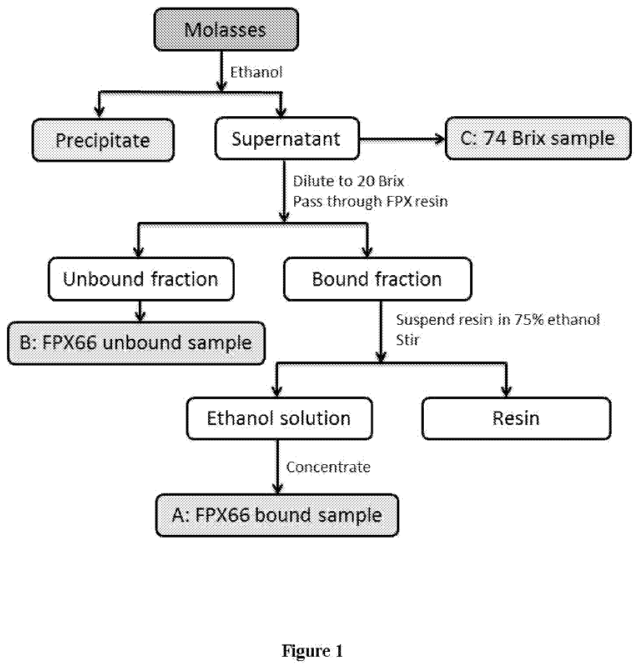

One exemplary process with molasses as the sugar cane derived product is depicted in FIG. 1.

In one process for producing extracts of the disclosure, the sugar cane derived product is used as a feedstock and mixed with a suitable solvent such as ethanol to form an extraction mixture.

The skilled person will understand that in order to facilitate mixing of the sugar cane derived product with a suitable solvent such as ethanol, the sugar cane derived product may need to be mixed with a liquid, for example but not limited to water, and/or heated in order to achieve a desired viscosity. In one embodiment of the disclosure in which the sugar cane derived product is molasses, for example, the molasses may be mixed with a liquid, for example, water to achieve a desired viscosity. The sugar cane derived product, either mixed with a liquid or not, may be heated to decrease viscosity.

For sugar cane derived products comprising solid material such as bagasse, field trash and cane shippings, it is desirable that the product is first blended or homogenised with a liquid, for example but not limited to water, prior to mixing with ethanol to form the extraction mixture. The amount of a liquid with which the sugar cane derived product is blended or homogenised can be readily determined by the skilled person in order to achieve a sugar cane derived product having a suitable viscosity for mixing with ethanol to form an extraction mixture.

In one embodiment, the sugar cane derived product will have a viscosity less than or equal to about 100 centipoise. In another embodiment, the sugar cane derived product will have a viscosity of between about 50 to about 100 centipoise. In another embodiment, the sugar cane derived product will have a viscosity of between about 50 to about 80 centipoise.

The high viscosity of molasses is as a result of the high total solids (particularly soluble carbohydrates) and this is typically measured by determination of Brix degrees. In one embodiment, the sugar cane derived product may have about 10° to about 80° Brix. In another embodiment, the sugar cane derived product may have about 20° to about 70° Brix. In another embodiment, the sugar cane derived product may have about 20° to about 50° Brix. In another embodiment, the sugar cane derived product may have about 30° to about 60° Brix. In another embodiment, the sugar cane derived product may have about 40° to about 50° Brix. In one embodiment, the sugar cane derived product is at least about 70° Brix.

### Addition of Ethanol to the Sugar Cane Derived Product

To extract compounds such as polyphenols, the sugar cane derived product is mixed with ethanol to form an extraction mixture. In one embodiment, the extraction mixture comprises at least about 50% v/v ethanol. In another embodiment, the extraction mixture comprises at least about 55%, 60%, 65%, 70%, 71%, 72%, 73%, 74%, 75%, 76%, 77%, 78%, 79%, 80%, 81%, 82%, 83%, 84% or 85% v/v ethanol.

The optimal concentration of ethanol in the extraction mixture for removing colour in the supernatant while minimising reduction in polyphenols is about 70% to about 85% v/v. In one embodiment, the extraction mixture comprises about 65% to about 75% v/v ethanol. In one embodiment, the extraction mixture comprises about 70% to about 80% v/v ethanol. In one embodiment, the extraction mixture comprises about 70% to about 75% v/v ethanol. In one embodiment, the extraction mixture comprises about 75% to about 80% v/v ethanol. In one embodiment, the extraction mixture comprises about 80% to about 85% v/v ethanol. In one embodiment, the extraction mixture comprises about 80% to about 83% v/v ethanol. In one embodiment, the extraction mixture comprises about 65% v/v ethanol. In another embodiment, the extraction mixture comprises about 70% v/v ethanol. In another embodiment, the extraction mixture comprises about 75% v/v ethanol. In another embodiment, the extraction mixture comprises about 80% v/v ethanol. In another embodiment, the extraction mixture comprises about 83% v/v ethanol. In another embodiment, the extraction mixture comprises about 85% v/v ethanol.

In the process of the disclosure, it may be desirable that extremes of pH be avoided in the extraction mixture. Extreme pH can have a deleterious effect on the components of the extraction mixture. Accordingly, in one embodiment the extraction mixture has a pH of about pH 4 to about pH 7.5. In another embodiment, the extraction mixture has a pH of about pH 4 to about pH 6. In another embodiment, the extraction mixture has a pH of about pH 4 to about pH 5.

### Removal of Precipitate and Ethanol

Following the formation of precipitate in the extraction mixture, the precipitate may be removed from the mixture by any suitable method known in the art. For example the precipitate may be removed by centrifugation and the supernatant may be obtained. Alternatively, the precipitate may be allowed to settle for a time sufficient to allow the supernatant to be obtained while leaving precipitate behind, such as, for example, by sedimentation under gravity. The skilled person will understand that other techniques such as filtration can be used alone or in combination with centrifugation or sedimentation in order to produce the extract derived from sugar cane.

Once the supernatant has been obtained the ethanol is removed using techniques known in the art. By way of non-limiting example, the ethanol may be removed from the supernatant by evaporation, such as by using a rotary evaporator with a heating bath at approximately 45° C. or higher. In some instances it may be desirable to further remove water from the supernatant to increase the Brix value of the supernatant. In one embodiment the process provides an extract having at least about 60° Bx (degrees Brix). In some instances the Bx value of the extract derived from sugar cane is at least about 65° Bx. In some instances the Bx value of the extract derived from sugar cane is at least about 70° Bx. In some instances the Bx value of the extract derived from sugar cane is about 60-65° Bx. In some instances the Bx value of the extract derived from sugar cane is about 65-70° Bx. In some instances the Bx value of the extract derived from sugar cane is about 64-65° Bx. In some instances the Bx value of the extract derived from sugar cane is about 70-75° Bx.

Fractionation of the Extract Derived from Sugar Cane

In one embodiment of the process of the disclosure, the supernatant comprising ethanol, or the extract derived from sugar cane from which ethanol has been removed may be used without further processing. Optionally the supernatant comprising ethanol, or the extract derived from sugar cane from which ethanol has been removed may be subjected to purification or fractionation.

A purification step may remove impurities, such as pigments that contribute to the colour of the extract derived from sugar cane. By way of non-limiting example, the supernatant or the extract derived from sugar cane may be subject to a purification step which includes, one or more or of, membrane filtration, size exclusion chromatography, ion exchange chromatography, and/or hydrophobic interaction chromatography. In one embodiment, the supernatant or extract may be subjected to hydrophobic interaction chromatography.

There are several techniques known in the art for separating compounds based on size. For example, it is known in the art that components of a supernatant or extract falling within a specific molecular weight range may be separated by size exclusion processing methods such as gel permeation chromatography or ultrafiltration.

Separation of components in the supernatant and/or the extract derived from sugar cane may also be achieved using chromatographic techniques or combinations of techniques. In one embodiment, chromatographic techniques include, but are not limited to, ion exchange chromatography, hydrophobic interaction chromatography, liquid chromatography-mass spectrometry (LCMS) and/or HPLC. Appropriate stationary and mobile phases of any chromatographic technique used will be readily determined by a skilled person. Appropriate elution techniques will also be readily determined by a skilled person. Chromatographic techniques may utilise fractional elution by stepwise increase in pH or with suitable solvents.

In one embodiment, the supernatant and/or the extract derived from sugar cane is subjected to one or more chromatographic techniques. In one embodiment, the supernatant and/or the extract derived from sugar cane is subjected to hydrophobic interaction chromatography. In one embodiment, the supernatant and/or the extract derived from sugar cane is subjected to hydrophobic interaction chromatography with an XAD, sephadex LH-20 or FPX66 resin. In one embodiment, the supernatant and/or the extract derived from sugar cane is subjected to sephadex LH-20 resin. In one embodiment, the supernatant and/or the extract derived from sugar cane is subjected to XAD resin. In one embodiment, the supernatant and/or the extract derived from sugar cane is subjected to FPX66 resin.

The supernatant and/or the extract derived from sugar cane may also be processed by standard techniques such as, but not limited to, microfiltration, reverse osmosis, gel permeation, vacuum evaporation and freeze drying, spray drying and/or tunnel drying.

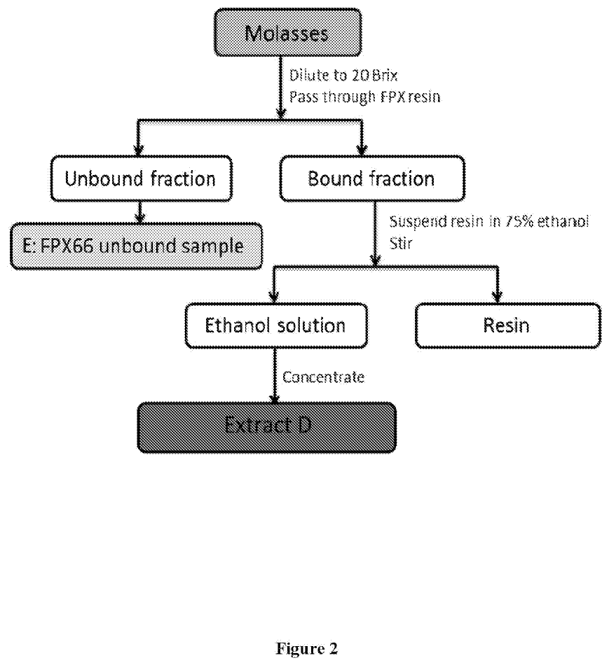

Exemplary processes without an extraction step Another exemplary process with molasses as the sugar cane derived product is depicted in FIG. 2. In this process for producing extracts of the disclosure, the molasses and is not mixed with ethanol in a preliminary step.

The extract derived from sugar cane may be obtained from a process without the addition of ethanol in the first step (FIG. 2).

To obtain the extract derived from sugar cane, molasses may first be diluted in a liquid, for example but not limited to water, to a desired Brix value. In one embodiment, the molasses is diluted to about 20° Bx with water. The components of the diluted solution may be subjected to one or more chromatographic techniques known in the art, for example by passing over a FPX66 ion exchange resin. A range of components from the molasses bind to the ion exchange resin beads and these components are collected later in the process as the bound fraction. The unbound fraction is eluted and may or may not be processed further. Once the unbound fraction has been removed from the system, ethanol may be used to elute the bound fraction. In one embodiment, 75% ethanol is used to elute the bound fraction. Following elution, the ethanol may be evaporated from the solution. Any method for removing the ethanol may be employed, including for example, heat exchange and evaporation. In one embodiment, ethanol is removed by evaporation.

Exemplary Processes with Multiple Filtration Steps

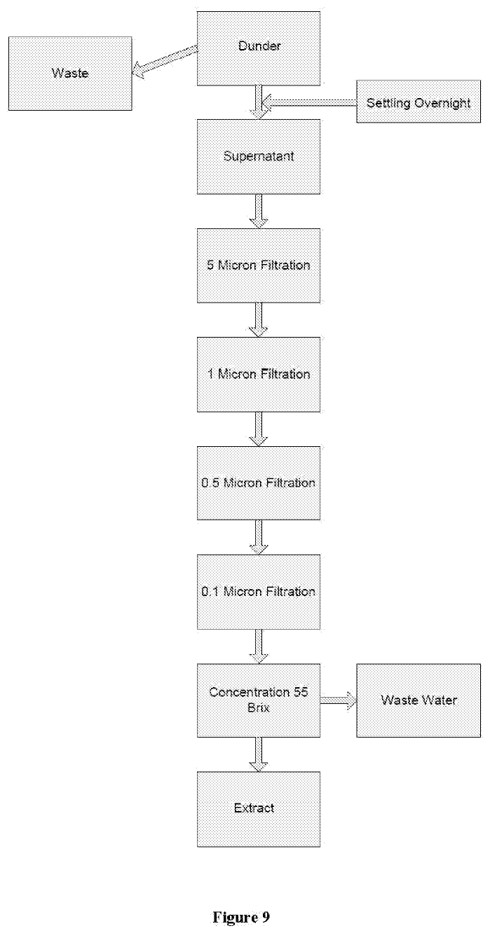

Another exemplary process for producing an extract according to the disclosure is described below. This exemplary process involves multiple filtration steps. This exemplary process with dunder as the sugar cane derived product is depicted in FIG. 9.

Sugar cane dunder is allowed to settled overnight (typically eight hours) in a V—bottom tank. The supernatant is then subjected to a number of filtration steps. The skilled person will understand that a variety of filtration steps (such as, for example, microfiltration or ultrafiltration) may be performed and the appropriate filtration steps will be readily determined by the skilled person.

In one embodiment, the supernatant is subjected to sequential microfiltration. In one embodiment the supernatant is sequentially filtered through: (i) a 5 micron filter; (ii) a 1 micron filter; (iii) a 0.5 micron filter; and (iv) a 0.1 micron filter. The skilled person would understand that a variety of filters could be used in the process to remove the desired sediment and undissolved matter. Exemplary filters are stainless steel filters, ceramic filters and cellulose filters.

The filtered supernatant is subsequently concentrated to remove water providing the extract. Any method for removing the water may be employed, including for example, heat exchange and evaporation. In one embodiment, the filtered supernatant is concentrated in a heat exchanger to remove water until the desired Brix level of the extract is achieved. In one embodiment, the process provides an extract having at least about 40° Bx. In one embodiment, the Bx value of the extract is at least about 50° Bx. In one embodiment, the Bx value of the extract is at least about 55° Bx. In one embodiment, the Bx value of the extract is at least about 60° Bx. In one embodiment, the Bx value of the extract is at least about 70° Bx. In one embodiment, the Bx value of the extract is about 45-55° Bx. In one embodiment, the Bx value of the extract is about 50° Bx. In one embodiment, the Bx value of the extract is about 50-55° Bx. In one embodiment, the Bx value of the extract is about 55-60° Bx. In one embodiment, the Bx value of the extract is about 50-70° Bx.

Exemplary Processes with Mixtures of Sugar Cane Derived Products

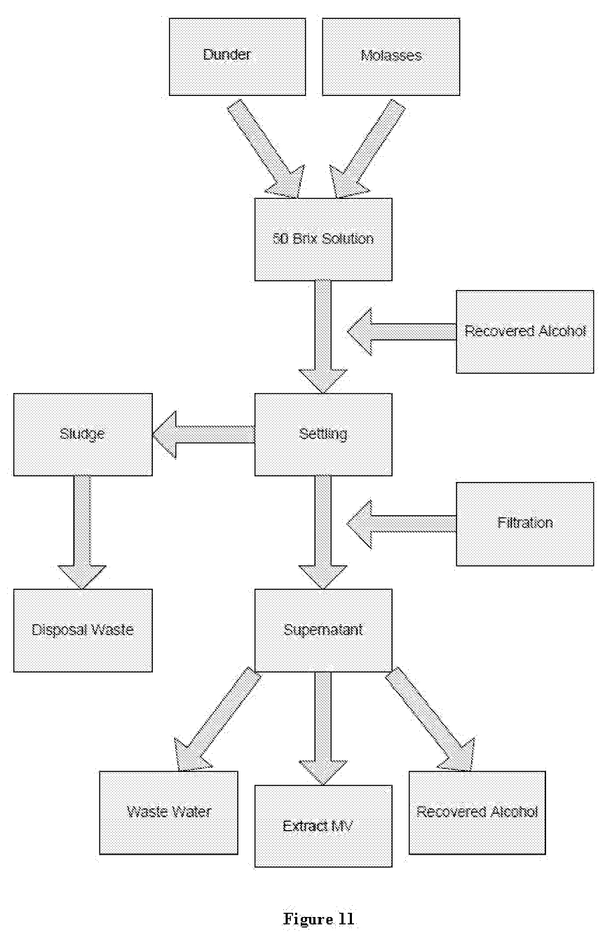

Another exemplary process for producing an extract according to the disclosure is described below. This exemplary process with a combination of dunder and molasses as the sugar cane derived product is depicted in FIG. 11.

Sugar cane mill molasses is mixed with settled sugar cane dunder (as described above) and stirred well to provide a mixture with the desired Brix level. The skilled person will understand that in order to facilitate mixing of the molasses and dunder, a liquid, for example but not limited to water, may be added. The liquid may be added to the molasses and/or the dunder prior to combining the two or the liquid may be added to the combined molasses and dunder. Additionally, heat may be applied to achieve a desired viscosity. In one embodiment, the combined mixture of molasses and dunder is about 50-55° Bx. In one embodiment, the combined mixture of molasses and dunder is about 50° Bx. In one embodiment, the combined mixture of molasses and dunder is about 55° Bx. In one embodiment, the combined mixture of molasses and dunder is at least about 50° Bx. In one embodiment, the combined mixture of molasses and dunder is at least about 60° Bx. In one embodiment, the combined mixture of molasses and dunder is at least about 70° Bx.

The combined mixture of molasses and dunder is maintained at a constant temperature (for example between 20-25° C.) and ethanol (for example 95% food grade ethanol) is added and stirred to ensure that the ethanol is evenly and quickly dispersed. Ethanol is added until the desired ethanol level is reached. The desired ethanol content can be from about 50% v/v to about 90% v/v. The desired ethanol content can be about 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90% v/v. In one embodiment, the desired ethanol level is at least about 60% v/v. In one embodiment, the desired ethanol level is at least about 70% v/v. In one embodiment, the desired ethanol level is at least about 80% v/v. In one embodiment, the desired ethanol level is about 60-70% v/v. In one embodiment, the desired ethanol level is about 70-80% v/v. In one embodiment, the desired ethanol level is about 75% v/v. In one embodiment, the desired ethanol level is about 76% v/v.

The addition and mixing of ethanol may lead to the formation of a gelatinous precipitate. The precipitate in the mixture is allowed to settle and the supernatant is removed, by, for example decantation and/or filtration. In one embodiment, the supernatant is decanted. In one embodiment, the supernatant is filtered. In one embodiment, the supernatant is decanted and filtered.

The ethanol is removed from the supernatant to provide the extract. Any method for removing the ethanol may be employed, including for example, heat exchange and evaporation. In one embodiment, the ethanol is removed by evaporation until the desired Brix level of the extract is achieved. In one embodiment, the process provides an extract having at least about 50° Bx. In one embodiment, the Bx value of the extract is at least about 60° Bx. In one embodiment, the Bx value of the extract is at least about 70° Bx. In one embodiment, the Bx value of the extract is at least about 80° Bx. In one embodiment, the Bx value of the extract is about 50-60° Bx. In one embodiment, the Bx value of the extract is about 60-70° Bx. In one embodiment, the Bx value of the extract is about 70-80° Bx. In one embodiment, the Bx value of the extract is about 65-75° Bx. In one embodiment, the Bx value of the extract is about 75° Bx. In one embodiment, the Bx value of the extract is at least about 70° Bx.

Extracts Derived from Sugar Cane

As described above, extracts derived from sugar cane generally comprise complex mixtures of substances including, but not limited to, polyphenols, phytosterols, oligosaccharides, polysaccharides, monosaccharide, disaccharides, organic acids, amino acids, peptides, proteins, vitamins, and minerals.

In one embodiment, the extract derived from sugar cane of the present disclosure comprises at least about 10 CE g/L of polyphenols or at least about 150 mg CE/g of polyphenols. As explained above, the term “CE”, or “catechin equivalent” is a measure of total polyphenolic content, expressed as catechin equivalents mg/g extract derived from sugar cane or catechin equivalents g/L extract derived from sugar cane.

In one embodiment, the extract derived from sugar cane of the present disclosure comprises at least about 10, 15, 20, 25, 30, 35, 40, 45, 50, 55, 60, 65, 70, 75, 80, 85, 90, 95, or 100 CE g/L of polyphenols.

In one embodiment, the extract derived from sugar cane of the present disclosure comprises at least about 100, 110, 120, 130, 140, 150, 160, 170, 180, 190, 200, 210, 220, 230, 240, 250, 250, 275, 300, 325, 350, 375, 400, 425, 450, 500, 525, 550, 575, 600, 625, 650, 675, 700, 725, 750, 775 or 800 mg CE/g of polyphenols.

In one embodiment, the extract derived from sugar cane of the present disclosure comprises from about 10 CE g/L to about 70 CE g/L of polyphenols or from about 100 CE mg/g to about 700 CE mg/g of polyphenols.

In one embodiment, the extract derived from sugar cane of the present disclosure comprises from about 10 CE g/L to about 60 CE g/L of polyphenols or from about 100 CE mg/g to about 600 CE mg/g of polyphenols.

In one embodiment, the extract derived from sugar cane of the present disclosure comprises from about 10 CE g/L to about 50 CE g/L of polyphenols or from about 100 CE mg/g to about 500 CE mg/g of polyphenols.

In one embodiment, the extract derived from sugar cane of the present disclosure comprises from about 15 CE g/L to about 40 CE g/L of polyphenols or from about 150 CE mg/g to about 400 CE mg/g of polyphenols.

In one embodiment, the extract derived from sugar cane of the present disclosure comprises from about 20 CE g/L to about 30 CE g/L of polyphenols or from about 200 CE mg/g to about 300 CE mg/g of polyphenols.

In one embodiment, the extract derived from sugar cane of the disclosure comprises from about 20 CE g/L to about 27 g CE/L of polyphenols or from about 200 CE mg/g to about 270 CE mg/g of polyphenols.

In one embodiment, the extract derived from sugar cane of the disclosure comprises from about 27 CE g/L to about 35 g CE/L of polyphenols or about 270 CE mg/g to about 350 CE mg/g of polyphenols.

In one embodiment, the extract derived from sugar cane of the disclosure comprises from about 35 CE g/L to about 40 g CE/L of polyphenols or from about 350 CE mg/g to about 400 CE mg/g of polyphenols.

In one embodiment, the extract derived from sugar cane of the disclosure comprises from about 40 CE g/L to about 50 g CE/L of polyphenols or from about 400 CE mg/g to about 500 CE mg/g of polyphenols.

In one embodiment, the extract derived from sugar cane of the disclosure comprises from about 45 CE g/L to about 50 g CE/L of polyphenols or about 450 CE mg/g to about 500 CE mg/g of polyphenols.

The extract derived from sugar cane of the present disclosure may contain the flavonoid class of polyphenols. The extract derived from sugar cane may contain flavonoids in any amount. In one embodiment, the extract derived from sugar cane of the disclosure comprises at least about 1 CE g/L of flavonoids or at least about 10 CE mg/g of flavonoids.

In one embodiment, the extract derived from sugar cane of the disclosure comprises from about 1 CE g/L to about 15 CE g/L of flavonoids or from about 10 CE mg/g to about 150 CE mg/g of flavonoids. In one embodiment, the extract derived from sugar cane of the disclosure comprises from about 3 CE g/L to about 10 CE g/L of flavonoids or about 30 CE mg/g to about 100 CE mg/g of flavonoids. In one embodiment, the extract derived from sugar cane of the disclosure comprises about 5 CE g/L to about 8 CE g/L of flavonoids or about 50 CE mg/g to about 80 CE mg/g of flavonoids. In one embodiment, the extract derived from sugar cane of the disclosure comprises about 6 CE g/L to about 8 CE g/L of flavonoids or about 60 CE mg/g to about 80 CE mg/g of flavonoids. In one embodiment, the extract derived from sugar cane of the disclosure comprises about 6.5 CE g/L to about 7.5 CE g/L of flavonoids or about 65 CE mg/g to about 75 CE mg/g of flavonoids.

The extract derived from sugar cane of the present disclosure may contain the proanthocyanidin class of polyphenols. The extract derived from sugar cane may contain proanthocyandins in any amount. In one embodiment, the extract derived from sugar cane of the present disclosure comprises at least about 1.5 CE g/L of proanthocyanidins or at least about 15 CE mg/g of proanthocyanidins. In one embodiment, the extract derived from sugar cane of the disclosure comprises at least about 1.8 CE g/L of proanthocyanidins or at least about 18 CE mg/g of proanthocyanidins. In one embodiment, the extract derived from sugar cane of the disclosure comprises about 1.5 CE g/L to about 2.5 CE g/L of proanthocyanidins or about 15 CE mg/g to about 25 CE mg/g of proanthocyanidins. In one embodiment, the extract derived from sugar cane of the disclosure comprises about 1.8 CE g/L to about 2.2 CE g/L of proanthocyanidins or about 18 CE mg/g to about 22 CE mg/g of pro anthocyanidins.

The extract derived sugar cane of the present disclosure may be a liquid extract. In one embodiment, the liquid extract is a syrup.

The extract derived from sugar cane of the present disclosure may be in a powder form. In one embodiment, the powder form is a freeze dried powder form, or a dehydrated powder form or a spray dried powder form.

The polyphenols of the extract derived from sugar cane of the disclosure include, but are not limited to, one or more of syringic acid, chlorogenic acid, caffeic acid, vanillin, sinapic acid, vitexin, p-coumaric acid, ferulic acid, gallic acid, vanillic acid, diosmin, diosmetin, apigenin, vitexin, orientin, homoorientin, swertisin, tricin, (+)catechin, (−) catechin gallate, (−)epicatechin, quercetin, kaempherol, myricetin, rutin, schaftoside, isoschaftoside, luteolin, scoparin and/or derivatives thereof. The polyphenols of the extract derived from sugar cane of the present disclosure may also include, but are not limited to, one or more of hydroxycinnamic acid, isoorientin, swertiajaponin, neocarlinoside, isovitexin, vicenin, and/or derivatives thereof.

The polyphenols of the extract derived from sugar cane also include conjugates, such as, for example, glycosides, glucosides, galactosides, galacturonides, ethers, esters, arabinosides, sulphates, phosphates, aldopentoses (xylose, arabinose) and aldohexoses.

In one embodiment, the extract derived from sugar cane of the present disclosure comprises syringic acid, chlorogenic acid, caffeic acid, vanillin, sinapic acid, diosmin, diosmetin, apigenin, vitexin, orientin, homoorientin, swertisin, tricin and/or derivatives thereof.

In one embodiment, the extract derived from sugar cane of the disclosure comprises syringic acid, chlorogenic acid, diosmin and/or derivatives thereof.

In one embodiment, the extract derived from sugar cane of the disclosure comprises syringic acid.

In one embodiment, the extract derived from sugar cane of the disclosure comprises chlorogenic acid.

In one embodiment, the extract derived from sugar cane of the disclosure comprises diosmin. In one embodiment, the extract derived from sugar cane of the present disclosure comprises caffeic acid. In one embodiment, the extract derived from sugar cane of the present disclosure comprises vanillin. In one embodiment, the extract derived from sugar cane of the present disclosure comprises sinapic acid. In one embodiment, the extract derived from sugar cane of the present disclosure comprises vitexin. In one embodiment, the extract derived from sugar cane of the present disclosure comprises p-coumaric acid. In one embodiment, the extract derived from sugar cane of the present disclosure comprises ferulic acid. In one embodiment, the extract derived from sugar cane of the present disclosure comprises gallic acid. In one embodiment, the extract derived from sugar cane of the present disclosure comprises vanillic acid. In one embodiment, the extract derived from sugar cane of the present disclosure comprises diosmetin. In one embodiment, the extract derived from sugar cane of the present disclosure comprises apigenin. In one embodiment, the extract derived from sugar cane of the present disclosure comprises orientin. In one embodiment, the extract derived from sugar cane of the present disclosure comprises homoorientin. In one embodiment, the extract derived from sugar cane of the present disclosure comprises swertisin. In one embodiment, the extract derived from sugar cane of the present disclosure comprises tricin. In one embodiment, the extract derived from sugar cane of the present disclosure comprises (+)-catechin. In one embodiment, the extract derived from sugar cane of the present disclosure comprises (−)-catechin gallate. In one embodiment, the extract derived from sugar cane of the present disclosure comprises (−)-epicatechin. In one embodiment, the extract derived from sugar cane of the present disclosure comprises quercetin. In one embodiment, the extract derived from sugar cane of the present disclosure comprises kaempherol. In one embodiment, the extract derived from sugar cane of the present disclosure comprises myricetin. In one embodiment, the extract derived from sugar cane of the present disclosure comprises rutin. In one embodiment, the extract derived from sugar cane of the present disclosure comprises schaftoside. In one embodiment, the extract derived from sugar cane of the present disclosure comprises isoschaftoside. In one embodiment, the extract derived from sugar cane of the present disclosure comprises luteolin. In one embodiment, the extract derived from sugar cane of the present disclosure comprises scoparin. In one embodiment, the extract derived from sugar cane of the present disclosure comprises hydroxycinnamic acid. In one embodiment, the extract derived from sugar cane of the present disclosure comprises isoorientin. In one embodiment, the extract derived from sugar cane of the present disclosure comprises swertiajaponin. In one embodiment, the extract derived from sugar cane of the present disclosure comprises neocarlino side. In one embodiment, the extract derived from sugar cane of the present disclosure comprises isovitexin. In one embodiment, the extract derived from sugar cane of the present disclosure comprises vicenin.

In one embodiment, syringic acid, chlorogenic acid and diosmin are the three most abundant polyphenols of the extract derived from sugar cane of the disclosure.

In one embodiment, the extract derived from sugar cane of the disclosure comprises about 5-20 μg/g dry weight of syringic acid. In one embodiment, the extract derived from sugar cane of the disclosure comprises about 7-15 μg/g dry weight of syringic acid. In one embodiment, the extract derived from sugar cane of the disclosure comprises about 10-12 μg/g dry weight of syringic acid. In one embodiment, the extract derived from sugar cane of the disclosure, when present, comprises about 10.9 μg/g dry weight of syringic acid. The extract derived from sugar cane may be in a syrup form.

In one embodiment, the extract derived from sugar cane of the disclosure comprises about 50-200 μg/g dry weight of syringic acid. In one embodiment, the extract derived from sugar cane of the disclosure comprises about 90-130 μg/g dry weight of syringic acid. In one embodiment, the extract derived from sugar cane of the disclosure comprises about 100-120 μg/g dry weight of syringic acid. In one embodiment, the extract derived from sugar cane of the disclosure comprises about 107 μg/g dry weight of syringic acid. The extract derived from sugar cane may be in a powder form.

In one embodiment, the extract derived from sugar cane of the disclosure comprises about 1-15 μg/g dry weight of chlorogenic acid. In one embodiment, the extract derived from sugar cane of the disclosure comprises about 3-10 μg/g dry weight of chlorogenic acid. In one embodiment, the extract derived from sugar cane of the disclosure comprises about 5-8 μg/g dry weight of chlorogenic acid. In one embodiment, the extract derived from sugar cane of the disclosure comprises about 6.53 μg/g dry weight of chlorogenic acid. The extract derived from sugar cane may be in a syrup form.

In one embodiment, the extract derived from sugar cane of the disclosure comprises about 30-150 μg/g dry weight of chlorogenic acid. In one embodiment, the extract derived from sugar cane of the disclosure comprises about 60-90 μg/g dry weight of chlorogenic acid. In one embodiment, the extract derived from sugar cane of the disclosure comprises about 70-80 μg/g dry weight of chlorogenic acid. In one embodiment, the extract derived from sugar cane of the disclosure comprises about 74 μg/g dry weight of chlorogenic acid. The extract derived from sugar cane may be in a powder form.

In one embodiment, the extract derived from sugar cane of the disclosure comprises about 10-30 μg/g dry weight of diosmin. In one embodiment, the extract derived from sugar cane of the disclosure comprises about 15-25 μg/g dry weight of diosmin. In one embodiment, the extract derived from sugar cane of the disclosure comprises about 18-21 μg/g dry weight of diosmin. In one embodiment, the extract derived from sugar cane of the disclosure comprises about 19-45 μg/g dry weight of diosmin. The extract derived from sugar cane may be in a syrup form.

In one embodiment, the extract derived from sugar cane of the disclosure comprises about 100-300 μg/g dry weight of diosmin. In one embodiment, the extract derived from sugar cane of the disclosure comprises about 190-260 μg/g dry weight of diosmin. In one embodiment, the extract derived from sugar cane of the disclosure comprises about 210-240 μg/g dry weight of diosmin. In one embodiment, the extract derived from sugar cane of the disclosure comprises about 227 μg/g dry weight of diosmin. The extract derived from sugar cane may be in a powder form.

In one embodiment, the extract derived from sugar cane of the present disclosure comprises about 7-15 μg/g dry weight of syringic acid, and/or about 4-9 μg/g dry weight of chlorogenic acid, and/or about 0.1-0.5 μg/g dry weight of caffeic acid, about 0.05-0.3 μg/g dry weight of vanillin, and/or about 0.1-0.3 μg/g dry weight of sinapic acid, and/or about 15-25 μg/g dry weight of diosmin, and/or about 0.1-0.4 μg/g dry weight of orientin, and/or about 0.4-0.9 μg/g dry weight of swertisin, and/or about 0.05-0.3 μg/g dry weight of disomentin. The extract derived from sugar cane may be in a syrup form.

In one embodiment, the extract derived from sugar cane of the present disclosure comprises about 10-12 μg/g dry weight of syringic acid, and/or about 5-8 μg/g dry weight of chlorogenic acid, and/or about 0.2-0.4 μg/g dry weight of caffeic acid, and/or about 0.1-0.2 μg/g dry weight of vanillin, and/or about 0.1-0.25 μg/g dry weight of sinapic acid, and/or about 18-21 μg/g dry weight of diosmin, and/or about 0.2-0.3 μg/g dry weight of orientin, and/or about 0.5-0.8 μg/g dry weight of swertisin, and/or about 0.1-0.2 μg/g dry weight of disomentin. The extract derived from sugar cane may be in a syrup form.

In one embodiment, the extract derived from sugar cane of the present disclosure comprises about 10.9 μg/g dry weight of syringic acid, and/or about 6.53 μg/g dry weight of chlorogenic acid, and/or about 0.29 μg/g dry weight of caffeic acid, and/or about 0.153 μg/g dry weight of vanillin, and/or about 0.18 μg/g dry weight of sinapic acid, and/or about 19.45 μg/g dry weight of diosmin, and/or about 0.245 μg/g dry weight of orientin, and/or about 0.69 μg/g dry weight of swertisin, and/or about 0.15 μg/g dry weight of disomentin. The extract derived from sugar cane may be in a syrup form.

In one embodiment, the extract derived from sugar cane of the present disclosure comprises about 90-130 μg/g dry weight of syringic acid, and/or about 60-90 μg/g dry weight of chlorogenic acid, and/or about 4-10 μg/g dry weight of caffeic acid, and/or about 1-4 μg/g dry weight of vanillin, about 1-3 μg/g dry weight of sinapic acid, and/or about 190-260 μg/g dry weight of diosmin, and/or about 3-7 μg/g dry weight of orientin, and/or 3-8 μg/g dry weight of swertisin, and/or about 0.05-0.3 μg/g dry weight of disomentin. The extract derived from sugar cane may be in a powder form.

In one embodiment, the extract derived from sugar cane of the present disclosure comprises about 100-120 μg/g dry weight of syringic acid, and/or about 70-80 μg/g dry weight of chlorogenic acid, and/or about 6-8 μg/g dry weight of caffeic acid, about 2-3 μg/g dry weight of vanillin, and/or about 1.5-2.5 μg/g dry weight of sinapic acid, and/or about 210-240 μg/g dry weight of diosmin, about 4-5 μg/g dry weight of orientin, 4-6 μg/g dry weight of swertisin, and/or about 0.1-0.2 μg/g dry weight of disomentin. The extract derived from sugar cane may be in a powder form.

In one embodiment, the extract derived from sugar cane of the present disclosure comprises about 107 μg/g dry weight of syringic acid, and/or about 74 μg/g dry weight of chlorogenic acid, and/or about 7.5 μg/g dry weight of caffeic acid, and/or about 2 μg/g dry weight of vanillin, and/or about 1.7 μg/g dry weight of sinapic acid, and/or about 227 μg/g dry weight of diosmin, and/or about 4.5 μg/g dry weight of orientin, 5.2 μg/g dry weight of swertisin, and/or about 0.16 μg/g dry weight of disomentin. The extract derived from sugar cane may be in a powder form.

The extract derived from sugar cane of the present disclosure may contain a range of organic acids that are found naturally in sugar cane. These organic acids may include, but are not limited to, aconitic (cis- and trans-), oxalic, citric, tartaric, glycolic, succinic, citric, malic, fumaric and shikimic acids. In one embodiment, the extract derived from sugar cane contains higher levels of citric and malic acids than other organic acids. In another embodiment, the extract derived from sugar cane contains low to trace amounts of oxalic, citric, tartaric, glycolic, succinic and citric acids. In another embodiment, the two most abundant organic acids in the extract derived from sugar cane are trans- and cis-aconitic acids.

The extract derived from sugar cane of the present disclosure may contain trans- and/or cis-aconitic acids. In one embodiment the extract derived from sugar cane of the present disclosure comprises trans-aconitic in amount of about 10,000-40,000 mg per kg and/or cis-aconitic in amount of about 3,000-7,000 mg/kg. In one embodiment, the extract derived from sugar cane of the present disclosure may contain trans-aconitic in an amount of about 17,000-30,000 mg per kg and/or cis-aconitic in amount of about 4,000-6,500 mg/kg. In one embodiment, the extract derived from sugar cane of the present disclosure may contain trans-aconitic in amount of about 20,000-25,000 mg per kg and/or cis-aconitic in amount of about 5,000-5,500 mg/kg.

The extract derived from sugar cane of the present disclosure may contain amino acids. In one embodiment, the total amino acids levels of the extract derived from sugar cane of the present disclosure is about 50,000-80,000 μg per gram, or about 60,000-70,000 μg per gram, or about 65,000 μg per gram. In one embodiment, about 10-40% of these total amino acids are essential amino acids. In one embodiment, about 15-30% of these total amino acids are essential amino acids. In one embodiment, about 20-25% of these total amino acids are essential amino acids.

The extract derived from sugar cane of the present disclosure may contain free amino acids. In one embodiment, the extract derived from sugar cane of the present disclosure comprises about 10,000-50,000 μg of free amino acids per gram. In one embodiment, the extract derived from sugar cane of the present disclosure may contain about 20,000-35,000 μg of free amino acids per gram. The extract derived from sugar cane of the present disclosure may contain about 25,000-30,000 μg of free amino acids per gram.

As defined above, the term “free amino acids” as used herein refers to amino acids which are singular molecules and structurally not attached to peptide bonds which are attached to other amino acids.

The extract derived from sugar cane of the present disclosure may contain leucine, a branched chain essential amino acid. In one embodiment, the concentration of leucine in the extract derived from sugar cane, is about 1-5 mM, or about 1.5-4 mM, or about 2-3 mM. In one embodiment, the amount of leucine in the extract derived from sugar cane is about 1,000-20,000 μg per gram, or about 1,000-10,000 μg per gram, or about 1,000-5,000 μg per gram, or about 1,000-2,000 μg per gram, or about 5,000-10,000 μg per gram, or about 10,000-20,000 μg per gram.

The extract derived from sugar cane of the present disclosure may contain minerals. In one embodiment, the extract derived from sugar cane derived from sugar cane contains minerals that are found naturally in sugar cane. In one embodiment, the extract derived from sugar cane derived from sugar contains one or more minerals including, but not limited to, potassium, sodium, calcium, magnesium, iron, zinc, selenium and chromium.

In one embodiment, the extract derived from sugar cane contains minerals bound to the polyphenols. In one embodiment, the extract derived from sugar cane contains divalent ions bound to the polyphenols. In one embodiment, the extract derived from sugar cane contains calcium, magnesium and/or iron bound to the polyphenols. In one embodiment, the extract derived from sugar cane contains iron bound to the polyphenols.

In one embodiment, the extract derived from sugar cane of the present disclosure comprises about 20,000-32,000 mg of potassium per kilogram, and/or about 300-600 mg of sodium per kilogram, and/or about 800-1,300 mg of calcium per kilogram, and/or about 3,000-6,000 mg of magnesium per kilogram, and/or about 40-90 mg of iron per kilogram, and/or about 3-10 mg of zinc per kilogram, and/or about 500-900 μg of selenium per kilogram and/or about 1,000-1,600 μg of chromium per kilogram. The extract derived from sugar cane may be in a syrup form.

In one embodiment, the extract derived from sugar cane of the present disclosure comprises about 25,000-27,000 mg of potassium per kilogram, and/or about 400-500 mg of sodium per kilogram, and/or about 1,000-1,200 mg of calcium per kilogram, and/or about 4,000-5,500 mg of magnesium per kilogram, and/or about 55-75 mg of iron per kilogram, and/or about 5.5-7.5 mg of zinc per kilogram, and/or about 700-850 μg of selenium per kilogram, and/or about 1,200-1,400 μg of chromium per kilogram. The extract derived from sugar cane may be in a syrup form.

In one embodiment, the extract derived from sugar cane of the present disclosure comprises about 26,000 mg of potassium per kilogram, and/or about 450 mg of sodium per kilogram, and/or about 1,090 mg of calcium per kilogram, and/or about 4,700 mg of magnesium per kilogram, and/or about 65 mg of iron per kilogram, about 6.6 mg of zinc per kilogram, and/or about 786 μg of selenium per kilogram and/or about 1,300 μg of chromium per kilogram. The extract derived from sugar cane may be in a syrup form.

In one embodiment, the extract derived from sugar cane of the present disclosure comprises about 50-350 mg of potassium per kilogram, and/or about 5-70 mg of sodium per kilogram, and/or about 7,000-10,000 mg of calcium per kilogram, and/or about 1,000-3,000 mg of magnesium per kilogram, and/or about 500-1,300 mg of iron per kilogram. The extract derived from sugar cane may be in a powder form.

In one embodiment, the extract derived from sugar cane of the present disclosure comprises about 100-250 mg of potassium per kilogram, and/or about 10-50 mg of sodium per kilogram, and/or about 8,000-9,000 mg of calcium per kilogram, and/or about 1,500-2,500 mg of magnesium per kilogram, and/or about 800-1,000 mg of iron per kilogram. The extract derived from sugar cane may be in a powder form.

In one embodiment, the extract derived from sugar cane of the present disclosure comprises about 190 mg of potassium per kilogram, and/or about 30 mg of sodium per kilogram, and/or about 8,800 mg of calcium per kilogram, and/or about 2,000 mg of magnesium per kilogram, and/or about 890 mg of iron per kilogram. The extract derived from sugar cane may be in a powder form.

The extract derived from sugar cane of the present disclosure may contain monosaccharides, disaccharides, oligosaccharides and/or polysaccharides. Examples of these include, but are not limited to, sucrose, glucose, galactose, xylose, ribose, mannose, rhamnose, fructose, maltose, lactose, maltotriose, xylopyarnose, raffinose, 1-kestose, theanderose, 6-kestose, panose, neo-kestose, nystose, glucans and xylans.

The extract derived from sugar cane of the present disclosure may contain fiber. The fiber may be present in the extract as obtained by the process or fiber may be added to the extract. The term “fiber” as used herein refers to indigestible portion of food derived from plants. The fiber may be soluble or insoluble fiber. Non-limiting examples of fiber include, sugar cane fiber, oat bran, flour (including, for example soy, rice, wheat, bran, rye, corn, sorghum, potato), modified starch, gelatin, non-starch polysaccharides such as arabinoxylans, cellulose, chia fiber, psyillium fiber, fenugreek fiber and many other plant components such as resistant starch, resistant dextrins, inulin, lignin, chitins, pectins, beta-glucans, and oligosaccharides. In one embodiment, the extract derived from sugar cane of the present disclosure contains sugar cane fiber. In one embodiment, the extract derived from sugar cane of the present disclosure contains flour. In one embodiment, the extract derived from sugar cane of the present disclosure contains modified starch. In one embodiment, the extract derived from sugar cane of the present disclosure contains cellulose. In one embodiment, the extract derived from sugar cane of the present disclosure contains chia fiber. In one embodiment, the extract derived from sugar cane of the present disclosure contains pysillium fiber. In one embodiment, the extract derived from sugar cane of the present disclosure contains fenugreek fiber.

In one embodiment, the fiber is present in the extract of the present disclosure. In one embodiment, the fiber is added to the extract of the present disclosure.

It may be desirable that extremes of pH of the extract derived from sugar cane or the supernatant of the present disclosure be avoided. In one embodiment the pH of the extract or the supernatant derived from sugar cane of the present disclosure is in the range of about 3 to about 7, or about 3 to about 6, or about 4 to about 5.5, or about 4.5 to about 5, or about 4.6 to about 4.8.

The Brix value of the extract derived from sugar cane of the present disclosure may vary. In some instances the Bx value of the extract is at least about 40° Bx (degrees Brix). In some instances the Bx value of the extract is at least about 50° Bx. In some instances the extract of the present disclosure has at least about 60° Bx (degrees Brix). In some instances the Bx value of the extract is at least about 65° Bx. In some instances the Bx value of the extract is at least about 70° Bx. In some instances the Bx value of the extract is about 50-75° Bx. In some instances the Bx value of the extract is about 50-70° Bx. In some instances the Bx value of the extract is about 60-65° Bx. In some instances the Bx value of the extract is about 50-60° Bx. In some instances the Bx value of the extract is about 55° Bx. In some instances the Bx value of the extract is about 60-65° Bx. In some instances the Bx value of the extract is about 64-65° Bx. In some instances the Bx value of the extract is about 65-70° Bx. In some instances the Bx value of the extract is about 70-75° Bx. In some instances the Bx value of the extract is about 75-80° Bx.

Compositions, Methods and Uses of the Extracts Derived from Sugar Cane

The extracts derived from sugar cane of the present disclosure may be added to compositions and may have application in various uses and methods.

In one aspect of the disclosure there is provided a taste or mouthfeel improving or masking agent, wherein the agent is an extract derived from sugar cane comprising about 10 CE g/L to about 50 CE g/L of polyphenols or from about 100 CE mg/g to about 500 CE mg/g of polyphenols.

In one aspect of the disclosure there is provided a composition comprising a sugar substitute and a constituent to improve or mask taste or mouthfeel of the sugar substitute. The constituent to improve or mask taste or mouthfeel of the sugar substitute comprises an extract derived from sugar cane comprising polyphenols of the present disclosure. The extract derived from sugar cane comprises polyphenols in the amounts as defined above.

In one embodiment there is provided a composition comprising a sugar substitute and a constituent to improve or mask taste or mouthfeel of the sugar substitute, wherein the constituent comprises an extract derived from sugar cane comprising about 10 CE g/L to about 50 CE g/L of polyphenols or from about 100 CE mg/g to about 500 CE mg/g of polyphenols.

The compositions of the disclosure may also contain other ingredients. For example, but not limited to, the compositions of the disclosure may also contain the components as listed hereafter. A binder such as gum, acacia, corn starch or gelatin; excipients such as dicalcium phosphate; a disintegrating agent such as corn starch, potato starch, alginic acid and the like; a lubricant such as magnesium stearate; a sweetening agent such as sucrose, lactose or saccharin; and a liquid carrier, may be added. Various other ingredients may be present as coatings or to otherwise modify the physical form of the composition. The compositions may contain methyl and propylparabens as preservatives, a dye and flavouring agents such as cherry or orange flavour.

The compositions of the disclosure may be presented in a single unit form or in a bulk form and may be prepared by any of the methods well known in the art. All methods include the step of bringing the extract derived from sugar cane of the present disclosure, into association with one or more accessory ingredients including the sugar substitute when used. In general, the compositions are prepared by uniformly and intimately bringing the extract derived from sugar cane of the present disclosure, into association with a liquid carrier or a finely divided solid carrier or both, and then, if necessary, shaping the product into the desired formulation. As used herein, the term “composition” is intended to encompass a product comprising the specified ingredients, as well as any product which results, directly or indirectly, from combination of the specified ingredients.

The compositions include solutions, syrups and powders. In one embodiment, the composition is in a dry form or a liquid form. In one embodiment, the composition is in a dry form. In one embodiment, the composition is in a liquid form. Such forms are conveniently stable under the conditions of manufacture and storage and are generally preserved against the contaminating action of microorganisms such as bacteria and fungi.

The extract derived from sugar cane of the present disclosure may be an admixture with the sugar substitute or the extract derived from sugar cane of the present disclosure may be coated onto the sugar substitute. In one embodiment, the extract derived from sugar cane of the present disclosure is an admixture with the sugar substitute. In one embodiment, the extract derived from sugar cane of the present disclosure may be coated onto the sugar substitute.

The extract derived from sugar cane of the present disclosure may be present in a kit with the sugar substitute or the consumable containing the sugar substitute. The extract derived from sugar cane of the present disclosure may be present in a kit with the low sugar consumable or reduced sugar consumable.

In one aspect of the disclosure there is provided the use of an extract derived from sugar cane comprising polyphenols of the present disclosure for improving or masking taste or mouthfeel of a consumable containing a sugar substitute. The extract derived from sugar cane comprises polyphenols in the amounts as defined above.

In one aspect of the disclosure there is provided the use of an extract derived from sugar cane comprising polyphenols of the present disclosure for improving or masking taste or mouthfeel of a low sugar consumable. The extract derived from sugar cane comprises polyphenols in the amounts as defined above.

In one aspect of the disclosure there is provided the use of an extract derived from sugar cane comprising polyphenols of the present disclosure for improving or masking taste or mouthfeel of a reduced sugar consumable. The extract derived from sugar cane comprises polyphenols in the amounts as defined above.

In one embodiment there is provided the use of an extract derived from sugar cane comprising about 10 CE g/L to about 50 CE g/L of polyphenols or from about 100 CE mg/g to about 500 CE mg/g of polyphenols for improving or masking taste or mouthfeel of a consumable containing a sugar substitute.

In one embodiment there is provided the use of an extract derived from sugar cane comprising about 10 CE g/L to about 50 CE g/L of polyphenols or from about 100 CE mg/g to about 500 CE mg/g of polyphenols for improving or masking taste or mouthfeel of a low sugar consumable.

In one embodiment there is provided the use of an extract derived from sugar cane comprising about 10 CE g/L to about 50 CE g/L of polyphenols or from about 100 CE mg/g to about 500 CE mg/g of polyphenols for improving or masking taste or mouthfeel of a reduced sugar consumable.

In one aspect of the disclosure there is provided a method for improving or masking taste or mouthfeel of a consumable containing a sugar substitute. The method comprises including an effective amount of an extract derived from sugar cane comprising polyphenols of the present disclosure. The extract derived from sugar cane comprises polyphenols in the amounts as defined above.

In one aspect of the disclosure there is provided a method for improving or masking taste or mouthfeel of a low sugar consumable. The method comprises including an effective amount of an extract derived from sugar cane comprising polyphenols of the present disclosure. The extract derived from sugar cane comprises polyphenols in the amounts as defined above.

In one aspect of the disclosure there is provided a method for improving or masking taste or mouthfeel of a reduced sugar consumable. The method comprises including an effective amount of an extract derived from sugar cane comprising polyphenols of the present disclosure. The extract derived from sugar cane comprises polyphenols in the amounts as defined above.

In one embodiment, the method comprises including an effective amount of an extract derived from sugar cane in the consumable, the extract derived from sugar cane comprising from about 10 CE g/L to about 50 CE g/L of polyphenols or from about 100 CE mg/g to about 500 CE mg/g of polyphenols.

The effective amount of an extract derived from sugar cane in the consumable can be any amount which is sufficient to improve or mask taste or mouthfeel of a consumable containing a sugar substitute, a low sugar consumable or a reduced sugar consumable to an animal or human that is being sought by a researcher, taste specialist or consumer. An appropriate “effective amount” in any individual case may be determined by one of ordinary skill in the art using routine experimentation. The effective amount in this context includes an amount required to improve or mask taste or mouthfeel of a consumable containing a sugar substitute, a low sugar consumable or a reduced sugar consumable.

In one embodiment, the effective amount of the extract derived from sugar cane is in the range of from about 0.01 wt % to about 10 wt %, 0.01 wt % to about 9 wt %, 0.01 wt % to about 8 wt %, 0.01 wt % to about 7 wt %, 0.01 wt % to about 6 wt %, 0.01 wt % to about 5 wt %, 0.01 wt % to about 4 wt %, 0.01 wt % to about 3 wt %, 0.01 wt % to about 2 wt %, 0.01 wt % to about 1.5 wt %, about 0.01 wt % to about 1.0 wt %, about 0.01 wt % to about 0.9 wt %, about 0.01 wt % to about 0.5 wt %, about 0.01 wt % to about 0.4 wt %, about 0.01 wt % to about 0.3 wt %, about 0.01 wt % to about 0.2 wt %, about 0.01 wt % to about 0.1 wt %, about 0.01 wt % to about 0.05 wt %, about 0.05 wt % to about 0.5 wt %, about 0.05 wt % to about 0.15 wt %, 0.05 wt % to about 0.12 wt %, about 0.05 wt % to about 0.1 wt %, about 0.05 wt % to about 0.09 wt %, about 0.05 wt % to about 0.07 wt %, about 0.05 wt % to about 0.1 wt % of the consumable. In one embodiment, the effective amount of the extract derived from sugar cane is about 0.01 wt % of the consumable. In one embodiment, the effective amount of the extract derived from sugar cane is about 0.03 wt % of the consumable. In one embodiment, the effective amount of the extract derived from sugar cane is about 0.05 wt % of the consumable. In one embodiment, the effective amount of the extract derived from sugar cane is about 0.1 wt % of the consumable.

In one embodiment, the effective amount of the extract derived from sugar cane is in the range of from about 0.01% v/v to about 10% v/v, 0.01% v/v to about 9% v/v, 0.01% v/v to about 8% v/v, 0.01% v/v to about 7% v/v, 0.01% v/v to about 6% v/v, 0.01% v/v to about 5% v/v, 0.01% v/v to about 4% v/v, 0.01% v/v to about 3% v/v, 0.01% v/v to about 2% v/v, 0.01% v/v to about 1.5% v/v, about 0.01% v/v to about 1.0% v/v, about 0.01% v/v to about 0.9% v/v, about 0.01% v/v to about 0.5% v/v, about 0.01% v/v to about 0.4% v/v, about 0.01% v/v to about 0.3% v/v, about 0.01% v/v to about 0.2% v/v, about 0.01% v/v to about 0.1% v/v, about 0.01% v/v to about 0.05% v/v, about 0.05% v/v to about 0.5% v/v, about 0.05% v/v to about 0.15% v/v, 0.05% v/v to about 0.12% v/v, about 0.05% v/v to about 0.1% v/v, about 0.05% v/v to about 0.09% v/v, about 0.05% v/v to about 0.07% v/v, about 0.05% v/v to about 0.1% v/v of the consumable. In one embodiment, the effective amount of the extract derived from sugar cane is about 0.01% v/v of the consumable. In one embodiment, the effective amount of the extract derived from sugar cane is about 0.03% v/v of the consumable. In one embodiment, the effective amount of the extract derived from sugar cane is about 0.05% v/v of the consumable. In one embodiment, the effective amount of the extract derived from sugar cane is about 0.1% v/v of the consumable.

In another embodiment, the effective amount of the extract derived from sugar cane in the consumable is in the amounts as defined above as % w/v. In another embodiment, the effective amount of the extract derived from sugar cane in the consumable is in the amounts as defined above as % v/w.

The determination of the effective amount of the extract of the present disclosure to be added to a consumable containing a sugar substitute would easily be performed by the skilled person using routine methods and processes. In one exemplary method, different concentrations of the extract of the present disclosure are added to the consumable containing a sugar substitute. A taste panel analysis is performed to determine which dose of the extract of the present disclosure gives rise to a consumable containing a sugar substitute which has comparable attributes to the standard version of the consumable.

For each low sugar consumable or reduced sugar consumable, the determination of the effective amount of the extract of the present disclosure to be added would be easily performed by a person skilled in the art using routine methods and processes. In one exemplary method, reduced sugar or low sugar variations of the consumable are made with 5-50% less sugar relative to the standard versions of the consumable. Different concentrations of the extract of the present disclosure are then added to the low and reduced sugar variations. A taste panel analysis is performed to determine which dose of the extract of the present disclosure gives rise to a low or reduced sugar variation which has comparable attributes to the standard version of the consumable.

The sugar substitute may be present in the consumable in any amount. Typically the amount of the sugar substitute is an amount sufficient to provide the desired level of sweetness in the consumable. The amount sufficient to provide the desired level of sweetness in the consumable in any individual case may be determined by one of ordinary skill in the art using routine experimentation.

In one embodiment, the sugar substitute is present in the range of from about 0.001 wt % to about 5.0 wt % of the consumable. In one embodiment, the sugar substitute is present in the range of from about 0.001 wt % to about 5 wt % of the consumable. In one embodiment, the sugar substitute is present in the range of from about 0.001 wt % to about 4 wt % of the consumable. In one embodiment, the sugar substitute is present in the range of from about 0.001 wt % to about 3 wt % of the consumable. In one embodiment, the sugar substitute is present in the range of from about 0.001 wt % to about 2 wt % of the consumable. In one embodiment, the sugar substitute is present in the range of from about 0.001 wt % to about 1 wt % of the consumable. In one embodiment, the sugar substitute is present in the range of from about 0.01 wt % to about 1.0 wt % of the consumable. In one embodiment, the sugar substitute is present in the range of from about 0.05 wt % to about 1.0 wt % of the consumable. In one embodiment, the sugar substitute is present in the range of from about 0.01 wt % to about 3.0 wt % of the consumable. In one embodiment, the sugar substitute is present in the range of from about 0.5 wt % to about 2.0 wt % of the consumable. In one embodiment, the sugar substitute is present in the range of from about 0.05 wt % to about 0.5 wt % of the consumable. In one embodiment, the sugar substitute is about 0.1 wt % of the consumable. In one embodiment, the sugar substitute is present in the range of from about 0.0001 wt % to about 0.1 wt % of the consumable. In one embodiment, the sugar substitute is present in the range of from about 0.001 wt % to about 0.01 wt % of the consumable. In one embodiment, the sugar substitute is about 0.001 wt % to about 0.007 wt % of the consumable. In one embodiment, the sugar substitute is present in the range of from about 0.01 wt % to about 0.1 wt % of the consumable.

In another embodiment, the sugar substitute is present in the consumable in the amounts defined above as % v/v. In another embodiment, the sugar substitute is present in the consumable in the amounts defined above as % w/v. In another embodiment, the sugar substitute is present in the consumable in the amounts defined above as % v/w.

The sugar substitute and extract derived from sugar cane may be present in the consumable in any ratio suitable to improve or mask the taste or mouthfeel of the consumable containing a sugar substitute. The appropriate ratio of the sugar substitute and extract derived from sugar cane in the consumable in any individual case may be determined by one of ordinary skill in the art using routine experimentation.

In one embodiment, a ratio of the sugar substitute and the extract derived from sugar cane in the consumable is from 10 to 90 parts by weight to 90 to 10 part by weight. In one embodiment, a ratio of the sugar substitute and the extract derived from sugar cane in the consumable is from 30 to 70 parts by weight to 70 to 30 part by weight. In one embodiment, a ratio of the sugar substitute and the extract derived from sugar cane in the consumable is about 50 to 50 parts by weight.

In another embodiment, the ratio of the sugar substitute and the extract derived from sugar cane in the consumable is as defined above as parts by volume.

The compositions, methods and uses of the present disclosure may further comprise other active agents or compounds which improve or mask taste or mouthfeel of a sugar substitute. The compositions, methods and uses of the present disclosure may further comprise other active agents or compounds which improve or mask taste or mouthfeel of a low sugar consumable. The compositions, methods and uses of the present disclosure may further comprise other active agents or compounds which improve or mask taste or mouthfeel of a reduced sugar consumable. Selection of the appropriate agents or compounds for use in combination may be made by one of ordinary skill in the art.

### Improving or Masking the Taste of Mouthfeel of a Consumable

The extracts derived from sugar cane are effective in improving or masking the taste or mouthfeel of a consumable containing a sugar substitute.

The extracts derived from sugar cane are effective in improving or masking the taste or mouthfeel of a low sugar consumable or a reduced sugar consumable.

The term “improve” as used herein means to provide a more desirable taste or mouthfeel. “Improve” includes, but is not limited to, better, refine, enhance, boost, raise, tweak, develop, increase, augment and elevate, with regard to the taste or mouthfeel of a consumable.

The term “mask” as used herein means to conceal an unpleasant or less favourable taste or mouthfeel. “Mask” includes, but is not limited to, hide, disguise, cover up, obscure, camouflage and veil, with regard to an unpleasant or less favourable taste or mouthfeel of a consumable.

The term “taste” as used herein refers to a sensation of flavour or savour of substances which is perceived when they are brought into contact with the mouth, including the tongue, throat and roof of the mouth.

The term “mouthfeel” as used herein refers to a tactile sensation that a consumable such as a food or beverage creates in the mouth, including the tongue, throat and the roof of the mouth.

The taste or mouthfeel attribute may be any taste or attribute known to a person skilled in the art.

In one embodiment, the taste is selected from, but not limited to, sweet, bitter, metallic, astringent, acidity, sour, fruity, salty, liquorice, umami and combinations thereof. In one embodiment, the taste is sweet. In one embodiment, the taste is bitter. In one embodiment, the taste is metallic. In one embodiment, the taste is astringent. In one embodiment, the taste is sour. In one embodiment, the taste is acidity. In one embodiment, the taste is fruity. In one embodiment, the taste is salty. In one embodiment, the taste is liquorice. In one embodiment, the taste is umami.

In one embodiment, the taste is an aftertaste. In one embodiment, duration of the taste is shortened or lengthened. In one embodiment, duration of the taste is shortened. In one embodiment, duration of the taste is lengthened.

In one embodiment, the mouthfeel is selected from, but not limited to, smooth, dry, chalky, grainy, greasy, gummy, watery, oily, tingly, waxy, bound, rough, round, slimy, cohesive, uniform, dense, body and combinations thereof. In one embodiment, the mouthfeel is smooth. In one embodiment, the mouthfeel is dry. In one embodiment, the mouthfeel is chalky. In one embodiment, the mouthfeel is grainy. In one embodiment, the mouthfeel is greasy. In one embodiment, the mouthfeel is gummy. In one embodiment, the mouthfeel is watery. In one embodiment, the mouthfeel is oily. In one embodiment, the mouthfeel is tingly. In one embodiment, the mouthfeel is waxy. In one embodiment, the mouthfeel is bound. In one embodiment, the mouthfeel is rough. In one embodiment, the mouthfeel is round. In one embodiment, the mouthfeel is slimy. In one embodiment, the mouthfeel is cohesive. In one embodiment, the mouthfeel is uniform. In one embodiment, the mouthfeel is dense. In one embodiment, the mouthfeel is body.

The term “body” as used herein refers to an overall sensation regarding how heavy, thick or viscous a consumable, such as a beverage, feels in the mouth and/or throat. In one embodiment, the body is heavy. In one embodiment, the body is light. In one embodiment, the body is thick. In one embodiment, the body is viscous. In one embodiment, the body is rounded.

### Sugar Substitutes

The sugar substitute may be any sugar substitute known in the art. In one embodiment, the sugar substitute is selected from, but not limited to, stevia, steviol glycosides, aspartame, acesulfame potassium, sucralose, cyclamate, saccharin, mogroside, rubusoside, siamenoside, monatin, curculin, glycyrrhizic acid, thaumatin, monellin, mabinlin, brazzein, hernandulcin, phyllodulcin, glycyphyllin, phloridzin, trilobatin, baiyunoside, osladin, polypodoside, pterocaryoside, mukurozioside, phlomisoside, periandrin, abrusoside, clocarioside, Monk fruit extracts, neotame, advantame, sugar alcohols, salts and combinations thereof.

In one embodiment, the sugar substitute is selected from, but not limited to, stevioside, rebaudioside A, rebaudioside B, rebaudioside C, rebaudioside D, rebaudioside E, rebaudioside F, dulcoside A, dulcoside B, rubusoside, mogroside IV, mogroside V, siamenoside, monatin, monatin SS, monatin RR, monatin RS, monatin SR, curculin, glycyrrhizic acid and its salts, thaumatin, monellin, mabinlin, brazzein, hernandulcin, phyllodulcin, glycyphyllin, phloridzin, trilobatin, baiyunoside, osladin, polypodoside A, pterocaryoside A, pterocaryoside B, mukurozioside, phlomisoside I, periandrin I, abrusoside A, cyclocarioside I, aspartame, acesulfame potassium, sucralose, cyclamate, saccharin, Monk fruit extract, neotame, advantame, erythritol, arabitol, isomalt, lactitol, maltitol, mannitol, sorbitol, xylitol, isomaltulose and combinations thereof.

In one embodiment, the sugar substitute is selected from stevia, steviol glycosides, stevioside, rebaudioside A, rebaudioside B, dulcoside A, dulcoside B, erythritol, aspartame, acesulfame potassium, sucralose, cyclamate, saccharin, mogroside, Monk fruit extract, neotame, advantame, isomaltulose and combinations thereof.

In one embodiment, the sugar substitute is stevia, steviol glycosides, stevioside, rebaudioside A or combinations thereof.

In one embodiment, the sugar substitute is stevia. In one embodiment, the sugar substitute is isomaltulose. In one embodiment, the sugar substitute is aspartame. In one embodiment, the sugar substitute is acesulfame potassium. In one embodiment, the sugar substitute is sucralose. In one embodiment, the sugar substitute is neotame.

In one embodiment, the sugar substitute is advantame. In one embodiment, the sugar substitute is erythritol. In one embodiment, the sugar substitute is sorbitol.

### Consumable Products

The extracts derived from sugar cane comprising polyphenols of the present disclosure may be added to any consumable product. The compositions comprising a sugar substitute and an extract derived from sugar cane comprising polyphenols of the present disclosure may also be added to any consumable product. In one embodiment, a consumable comprises an extract derived from sugar cane comprising polyphenols of the present disclosure. In one embodiment, a consumable comprises a composition comprising a sugar substitute and an extract derived from sugar cane comprising polyphenols of the present disclosure.

In one embodiment, the consumable is a low sugar consumable. In one embodiment, the low sugar consumable contains less than about 5 wt % of sugar. In one embodiment, the low sugar consumable contains less than about 5% v/v of sugar. In one embodiment, the low sugar consumable contains less than about 4 wt % of sugar. In one embodiment, the low sugar consumable contains less than about 4% v/v of sugar. In one embodiment, the low sugar consumable contains less than about 3 wt % of sugar. In one embodiment, the low sugar consumable contains less than about 3% v/v of sugar. In one embodiment, the low sugar consumable contains less than about 2 wt % of sugar. In one embodiment, the low sugar consumable contains less than about 2% v/v of sugar. In one embodiment, the low sugar consumable contains less than about 1 wt % of sugar. In one embodiment, the low sugar consumable contains less than about 1% v/v of sugar.

In another embodiment, the % of sugar in the low sugar consumable is present in the amounts defined above as % v/v. In another embodiment, the % of sugar in the low sugar consumable is present in the amounts defined above as % w/v. In another embodiment, the % of sugar in the low sugar consumable is present in the amounts defined above as % v/w.

In one embodiment, the consumable is a reduced sugar consumable. In one embodiment, the reduced sugar consumable contains about 5% to about 50% less sugar than a standard version of the consumable. In one embodiment, the reduced sugar consumable contains about 10% to about 40% less sugar than a standard version of the consumable. In one embodiment, the reduced sugar consumable contains about 10% to about 30% less sugar than a standard version of the consumable. In one embodiment, the reduced sugar consumable contains about 10% to about 25% less sugar than a standard version of the consumable. In one embodiment, the reduced sugar consumable contains about 10% to about 20% less sugar than a standard version of the consumable.

In one embodiment, the reduced sugar consumable contains about 10% less sugar than a standard version of the consumable. In one embodiment, the reduced sugar consumable contains about 20% less sugar than a standard version of the consumable. In one embodiment, the reduced sugar consumable contains about 30% less sugar than a standard version of the consumable. In one embodiment, the reduced sugar consumable contains about 50% less sugar than a standard version of the consumable.

In another embodiment, the % of sugar in the reduced sugar consumable is present in the amounts defined above as % v/v. In another embodiment, the % of sugar in the reduced sugar consumable is present in the amounts defined above as % w/v. In another embodiment, the % of sugar in the reduced sugar consumable is present in the amounts defined above as % v/w.

Consumable products are goods that are capable of being eaten or ingested. In one embodiment, the consumable is selected from, but not limited to, a food, beverage and pharmaceutical preparation. In one embodiment, the consumable is a food. In one embodiment, the consumable is a beverage. In one embodiment, the consumable is a pharmaceutical preparation.

In one embodiment, the food is selected from, but not limited to, dairy products, fermented products, spreads, frozen dessert, ready to eat packaged products, condiments, snack foods, cereal products, gums, confectionaries or mouth fresheners.

In one embodiment, the food is confectionary. Confectionary products include, but are not limited to biscuits, cake, pastry, cookies, donuts, baking mixes, sweets, lollies, candy, gum, caramels, bubble gum, cocoa and chocolate. In one embodiment, the food is chocolate. In one embodiment, the food is cocoa. In one embodiment, the food is bubble gum.

In one embodiment, the food is mouth fresheners. Mouth fresheners include, but are not limited to mint and chewing gum. In one embodiment, the food is chewing gum.

In one embodiment, the food is spreads. Spreads include, but are not limited to, jams, chocolate spreads, chocolate hazelnut spreads, conserves, fruit preparations, nut butters, fillings and dessert toppings.

In one embodiment, the food is a dairy product. Dairy products include, but are not limited to, yogurts, yogurt drinks, ready-made desserts, ice cream, milk modifiers and mousses.

In one embodiment, the food is a ready to eat product or a packaged product. The ready to eat product or packaged product may be chilled, frozen or lyophilised. Examples of ready to eat packaged products include, but are not limited to, baked beans, soup, spaghetti, frozen pizza, creamed corn, prepared meals, instant noodles and pasta sauce.

In one embodiment, the food is a condiment. Examples of condiments include, but are not limited to, ketchup, tomato sauce, barbeque sauce, mustard, relishes, pickles, mayonnaise, curry paste, gravy mix, soy sauce, sweet sauces and chutneys.

In one embodiment, the food is a snack food. Examples of snack food include, but are not limited to, crisps, potato chips, crackers, popcorn, vegetable chips.

In one embodiment, the food is a cereal product. Examples of cereal products include, but are not limited to, breakfast cereals, muesli bars, breads, muesli, pasta and popcorn.

In one embodiment, the beverage is a non-carbonated beverage or carbonated beverage. In one embodiment, the carbonated beverage is selected from, but not limited to, a cola, fruit-flavoured beverage, a root beer, alcoholic beverage and flavoured water. In one embodiment, the carbonated beverage is a cola. In one embodiment, the fruit-flavoured beverage is a citrus-flavoured beverage. In one embodiment, the citrus-flavoured beverage is a lemon-lime flavoured beverage or orange-flavoured beverage.

In one embodiment, the beverage is selected from, but not limited to, a fruit juice, fruit-containing beverage, cordial, vegetable juice, vegetable-containing beverage, tea, coffee, dairy beverage, cocoa beverage, soy milk, almond milk, flavoured animal milk, coconut milk, liquid breakfast, sports drink, energy drink, alcoholic beverage, fermented products and flavoured water. In one embodiment, the beverage is fruit-flavoured beverage, sports drink, energy drink, flavoured water or tea.

In one embodiment, the beverage is a malted beverage. Malted beverages include, but are not limited to, liquid and powdered chocolate malted beverages.

Fermented products include, but are not limited to, yoghurts, milks, creams, cheeses, beers, breads, tofu, beans (including broad beans and soy beans), and other vegetables.

In one embodiment, the pharmaceutical preparation is selected from, but not limited to, pharmaceutical tablets, pharmaceutical jellies, pharmaceutical capsules, pharmaceutical liquids and oral care products. Oral care products include toothpastes, mouthwashes, mouth sprays, breath freshening tapes and teeth whitening products.

### EXAMPLES

Example 1 provides illustrative and non-limiting examples of characterization of an extract derived from sugar cane of the present disclosure.

### Example 1. Characterisation of an Extract Derived from Sugar Cane

In order to characterise the types and quantity of polyphenols in extracts derived from sugar cane according to the present disclosure, some extracts were analysed by Liquid Chromatography-Mass Spectrometry (LCMS) and by NMR spectroscopy.

The three samples A, B, and C were fractions from molasses (FIG. 1). All the samples were stored at −20° C.

TABLE 1
Extract fractions from molasses

| Code | Sample Name | Description |
|---|---|---|
| A | FPX66 bound fraction | Brown syrup |
| B | FPX66 unbound fraction | Eight yellow syrup |
| C | 74 Brix | Dark brown syrup |

One mL of each of the samples were transferred into pre-weighed vials in duplicate and then freeze-dried for 3 days to obtain dry mass (Table 2). One replicate of each of the samples was analysed by NMR spectroscopy and the other replicate of each of the samples was used for quantitative analysis of polyphenols by LCMS.

TABLE 2
Moisture content of samples

| | | | | Wt. of | % | |
|---|---|---|---|---|---|---|
| | Repli- | Wt. of | Loss in | dried | Mois- | Anal- |
| Sample | cate | 1.0 mL, g | wt., g | extract, g | ture | ysis |
| A: | a | 1.0568 | 0.8471 | 0.2097 | 80.16 | NMR |
| Bound | b | 1.0683 | 0.8559 | 0.2124 | 80.12 | LCMS |
| Fraction | | | | | | |
| B: | a | 1.1324 | 0.7761 | 0.3563 | 68.54 | NMR |
| Unbound | b | 1.1288 | 0.7730 | 0.3558 | 68.48 | LCMS |
| Fraction | | | | | | |
| C: | a | 1.0300 | 0.2491 | 0.7809 | 24.18 | NMR |
| 74 Brix | b | 1.1690 | 0.2751 | 0.8939 | 23.53 | LCMS |
| Fraction | | | | | | |

The 74 Brix sample was fractionated by C18 solid phase extraction (SPE) to remove the sugars and obtain more concentrated phenolic components. One mL was diluted in Milli-Q water and eluted through a Waters 3 mL SPE Vac C18 cartridge that was initially activated with MeOH and then conditioned with Milli-Q water. The polar components were eluted with 6 mL Milli-Q water which was discarded. The remaining metabolites on the SPE cartridge were then eluted with 2×3 mL MeOH into a pre-weighed vial and the solvent was evaporated to dryness under nitrogen gas. The 74 Brix SPE-MeOH fraction was further dried overnight in the freeze dryer and then weighed to obtain the dry weight of fraction (55.6 mg). The extract was reconstituted in 200 μL 80:20 MeOH—H₂O (concentration=278 mg/mL) and analysed on the LCMS.

### Reference Standards

Table 3 lists the reference standards used for the qualitative analysis of phenolic compounds by LCMS. Standard solutions were prepared either in MeOH or 1:1 MeOH—H₂O. Fourteen of the standards were used for quantitative analysis of phenolic compounds by LCMS and a range concentrations was prepared from stock solutions indicated in Table 3 using 80:20 MeOH—H₂O as diluent.

TABLE 3
List of reference standards used for LCMS analysis
with the 14 compounds used for quantitative
analysis in bold and italic letters.

| | | | | Stock |
|---|---|---|---|---|
| | | Molecular. | Molecular | Concentration, |
| Code | Compound | Formula | Wt., g/mol | μg/inL |
| [symbol] | [symbol] | C₉H₁₀O₅ | 198.17 | 6,000 |
| [symbol] | [symbol] | C₉H₈O₄ | 180.16 | 600 |
| [symbol] | [symbol] | C₈H₈O₃ | 152.15 | 60 |
| [symbol] | [symbol] | C₁₁H₁₂O₅ | 224.21 | 115 |
| [symbol] | [symbol] | C₁₇H₁₄O₇ | 330.29 | 100 |
| [symbol] | [symbol] | C₁₆H₁₈O₉ | 354.31 | 1,900 |
| [symbol] | [symbol] | C₂₈H₃₂O₁₅ | 608.54 | 1,000 |
| [symbol] | [symbol] | C₁₆H₁₂O₆ | 300.26 | 100 |
| [symbol] | [symbol] | C₁₅H₁₀O₅ | 270.24 | 10 |
| [symbol] | [symbol] | C₂₁H₂₀O₁₀ | 432.38 | 100 |
| [symbol] | [symbol] | C₂₁H₂₀O₁₁ | 448.38 | 90 |
| [symbol] | [symbol] | C₂₁H₂₀O₁₁ | 448.38 | 40 |
| [symbol] | [symbol] | C₂₂H₂₂O₁₀ | 446.40 | 21 |
| [symbol] | [symbol] | C₁₅H₁₀O₈ | 318.24 | 400 |

### Nuclear Magnetic Resonance (NMR) Spectroscopy

Approximately 1 g of the samples were freeze dried and the dried residue was taken up in at least 1 mL of D₂O (Cambridge Isotopes) with 2 mM of 3-(trimethylsilyl)propionic-2,2,3,3-d₄ acid sodium salt (TSP, Sigma Aldrich 269913) and 0.5% sodium azide (NAN₃). Six hundred μL of each sample was transferred into 5 mm NMR tubes and analysed. ¹H (700.13 MHz) and ¹³C NMR (176.07 MHz) spectra were acquired using a Bruker Avance III NMR spectrometer with cryoprobe and TopSpin v3.2 software.

### Qualitative Analysis by Liquid Chromatography-Mass Spectroscopy (LCMS)

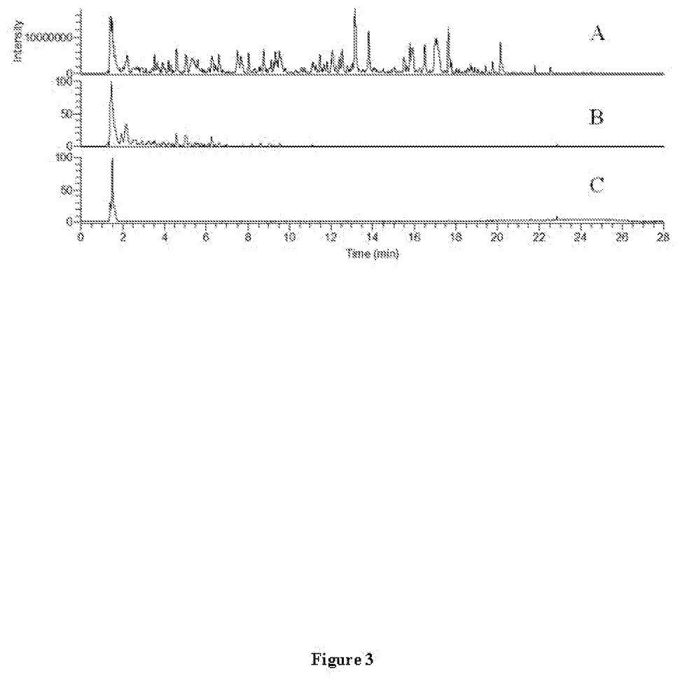

The samples were analysed by LCMS. The negative MS data was analysed using Genedata software and after pre-processing (RT restriction to exclude sugars, noise removal, cluster identification, etc.). 4,250 features were identified across all samples. There were 4,196 features identified in sample A (FPX66 bound fraction), 1,127 in sample B (FPX66 unbound fraction), and 178 in C (74 Brix sample) (FIG. 3).

A number of phenolic compounds were identified in the extract derived from sugar cane by comparison to the 42 standards analysed: vanillin, apigenin, orientin, vitexin, caffeic acid, chlorogenic acid, syringic acid, diosmin, swertisin, homoorientin, diosmetin, sinapic acid (trace amount), myricetin (trace amount), tricin (trace amount).

Table 4 exhibits polyphenol amounts in an extract derived from sugar cane from LCMS analysis in μg/gram dry weight basis.

TABLE 4
Polyphenol amounts in an extract derived from sugar cane.

| | 74 Brix sample (C) | FPX66 bound sample (A) |
|---|---|---|
| Polyphenol | in μg/g | in μg/g |
| Syringic Acid | 10.9 | 107.57 |
| Caffeic Acid | 0.29 | 7.54 |
| Vanillin | 0.153 | 2.13 |
| Sinapic Acid | 0.18 | 1.73 |
| Tricin | 0.03 | 0.4 |
| Chlorogenic Acid | 6.53 | 74.29 |
| Diosmin | 19.45 | 227 |
| Diosmetin | 0.15 | 0.16 |
| Apigenin | 0.001 | 0.01 |
| Vitexin | 0.084 | 1.62 |
| Orientin | 0.245 | 4.5 |
| Homoorientin | 0.041 | 0.58 |
| Swertisin | 0.69 | 5.25 |

### Qualitative Analysis by Nuclear Magnetic Resonance (NMR) Spectroscopy

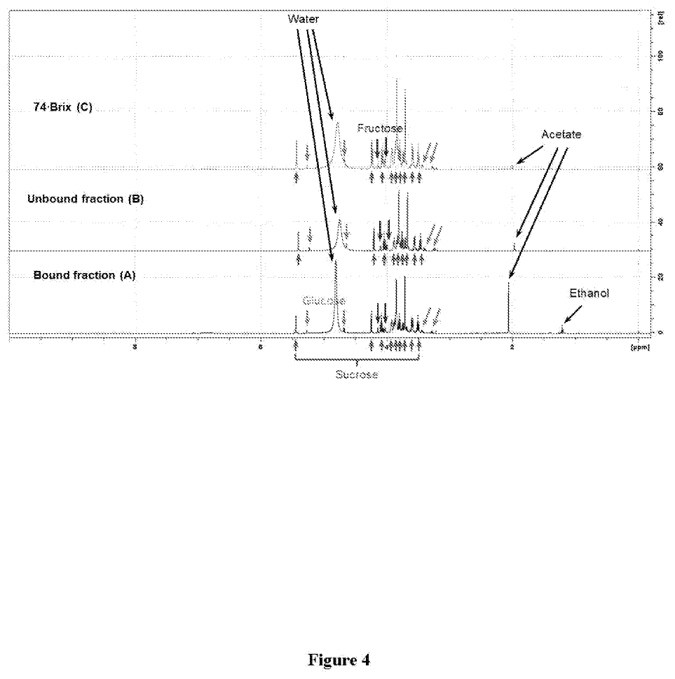

All the samples showed the dominant presence of sucrose and glucose with fructose present in lower amounts (FIG. 4). The samples A, B and C showed well resolved peaks in the 3-5 ppm region where the sugar signals are expected.

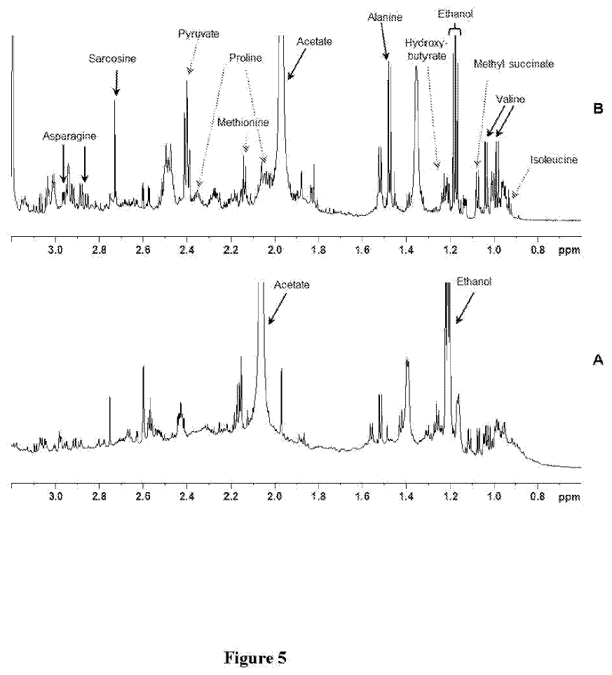

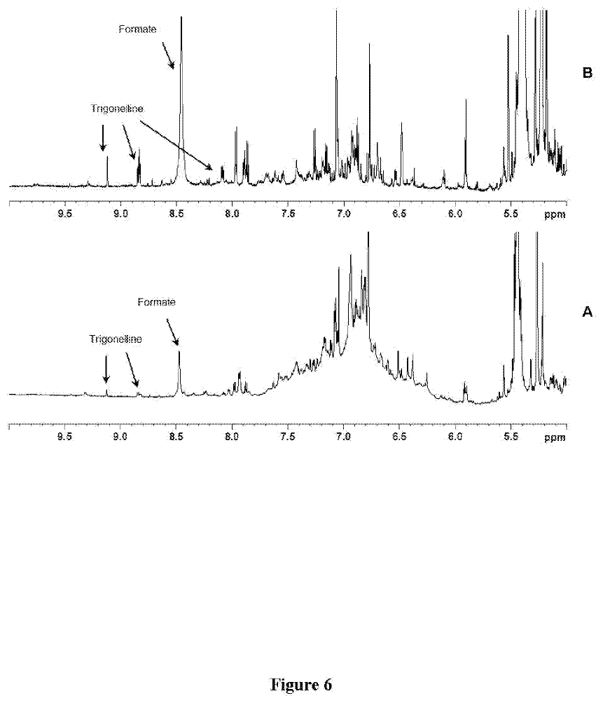

Metabolites such as organic acids and amino acids were identified through database comparison in Chenomx™ and the Human Metabolome Database (www.hmdb.ca). These metabolites were in either or both the bound and unbound fractions (FIGS. 5 and 6).

Organic acids identified were formate, aconitic (cis- and trans-), oxalic, citric, tartaric, glycolic, succinic, citric and malic acids. Levels of citric and malic acids were higher than those of other organic acids. Low to trace amounts of oxalic, citric, tartaric, glycolic, succinic and citric acids were identified. The two most abundant organic acids in the extract derived from sugar cane were trans- and cis-aconitic acids.

Amino acids identified were isoleucine, valine, methyl succinate, hydroxybutyrate, alanine, proline, methionine, sarcosine, asparagine.

Trigonelline, which is an alkaloid typically present in coffee was also identified (FIG. 6).

Total amino acids, free amino acids, essential amino acids and leucine, minerals of the extract were measured by using standard technique.

Table 5 exhibits mineral concentration of an extract derived from sugar cane of the present disclosure in mg/Kg dry weight basis. The concentration of selenium and chromium is shown in μg/kg dry weight basis.

TABLE 5
Mineral composition of an extract derived
from sugar cane of the present disclosure.

| | 74 Brix | | FPX66 bound | | FPX66 bound | |
|---|---|---|---|---|---|---|
| Anions | Sample (C) | | sample (A) | | sample (A) | |
| Potassium | 26,000 | mg/kg | 100-250 | mg/kg | 190 | mg/kg |
| Sodium | 450 | mg/kg | 10-50 | mg/kg | 30 | mg/kg |
| Calcium | 1,090 | mg/kg | 8,000-9,000 | mg/kg | 8,800 | mg/kg |
| Magnesium | 4,700 | mg/kg | 1,500-2,500 | mg/kg | 2,000 | mg/kg |
| Iron | 65 | mg/kg | 800-1000 | mg/kg | 890 | mg/kg |

| | | | | |
|---|---|---|---|---|
| Zinc | 6.6 | mg/kg | Not detected | Not detected |
| Selenium | 786 | μg/kg | Not detected | Not detected |
| (μg/kg) | | | | |
| Chromium | 1300 | μg/kg | Not detected | Not detected |
| (μg/kg) | | | | |

### Analysis by Gas Chromatography-Mass Spectroscopy (GC-MS)

In order to characterise the types of compounds in extracts derived from sugar cane molasses, extracts A and D were additionally analysed by Gas Chromatography-Mass Spectrometry (GC-MS). The two extracts A and D were fractions from molasses (FIGS. 1 and 2).

### Polar Metabolite Derivatization

All samples were dissolved in 10 μL of 30 mg/mL methoxyamine hydrochloride in pyridine and derivatized at 37° C. for 120 minutes with mixing at 500 rpm. The samples were incubated for 30 minutes with mixing at 500 rpm after addition of both 20 μL N,O-bis-(trimethylsilyl)trifluoroacetamide (BSTFA) and 1 μL retention time standard mixture [0.029% (v/v) n-dodecane, n-pentadecane, n-nonadecane, n-docosane, n-octacosane, n-dotriacontane, n-hexatriacontane dissolved in pyridine]. Each derivatized sample was allowed to rest for 60 min prior to injection.

### GC-MS Instrument Conditions

Samples (1 μL) were then injected into a GC-MS system in split (1:20 split ratio) or splitless mode, comprised of a Gerstel PAL3 Autosampler, a 7890B Agilent gas chromatograph and a 5977B Agilent quadrupole MS (Agilent, Santa Clara, USA). The Mass Spectrometer was adjusted according to the manufacturer's recommendations using tris-(perfluorobutyl)-amine (CF43). A J&W Scientific VF-5MS column (30 m long with 10 m guard column, 0.25 mm inner diameter, 0.25 μm film thickness) was used. The injection temperature was set at 250° C.; the Mass Spectrometer transfer line at 290° C., the ion source adjusted to 250° C. and the quadrupole at 150° C. Helium (UHP 5.0) was used as the carrier gas at a flow rate of 1.0 mL/minute. The following temperature program was used; injection at 70° C., hold for 1 minute, followed by a 7° C./minute oven temperature, ramp to 325° C. and a final 6 minute heating at 325° C. Mass spectra were recorded at 2 scans/s with an 50-600 m/z scanning range.

### Data Processing and Statistical Analysis

Both chromatograms and mass spectra were processed using the Agilent MassHunter Workstation Software, Quantitative Analysis, Version B.07.01/Build 7.1.524.0. Mass spectra of eluting compounds were identified using the commercial mass spectra library NIST 08 (http://www.nist.gov), the public domain mass spectra library of Max-Planck-Institute for Plant Physiology, Golm, Germany (http://csbdb.mpimp-golm.mpg.de/csbdb/dbma/msri.html) and the in-house mass spectral library. All matching mass spectra were additionally verified by determination of the retention time by analysis of authentic standard substances. If a specific metabolite had multiple TMS derivatives, the metabolite with the greater detector response and better peak shape within the dynamic range of the instrument was selected.

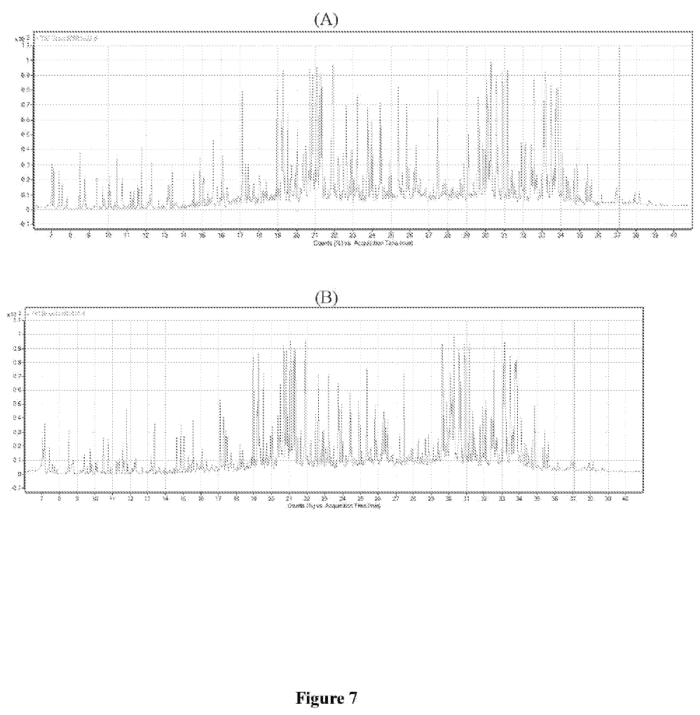

The results of the GC-MS analysis (Tables 6-8) confirmed the LC-MS study and many additional compounds were detected. Each sample contained more than 100 different identified compounds. These mainly included a diverse range of acids, polyphenols, sugars and phytosterols. The GC-MS traces of the extracts are shown in FIG. 7.

TABLE 6
Identified peaks and retention times of Extract A

| | Retention |
|---|---|
| Compound | Time |
| CONT: 1038.1 | 6.252 |
| Pyruvic Acid (1TMS) | 7.00900 |
| Lactic Acid (2TMS) | 7.12300 |
| Glycolic Acid | 7.38700 |
| Oxalic Acid (2TMS) | 7.56100 |
| CONT 1228 | 8.17000 |
| 3-Hydroxypropanoic acid | 8.49900 |
| 3-hydroxy-pyridine (1TMS) | 8.52000 |
| CONT: 1228 | 8.76250 |
| n-Heptanoic acid (1TMS) | 9.38600 |
| Malonic Acid (2TMS) | 9.54500 |
| Benzoic acid (1TMS) | 10.4667 |
| DL- Serine (2TMS) | 10.523 |
| Phosphoric acid (3TMS) | 10.686 |
| Succinic Acid (2TMS) | 11.553 |
| DL-Glyceric Acid (3TMS) | 11.772 |
| Uracil (2TMS) | 11.997 |
| Fumaric Acid (2TMS) | 12.222 |
| n-Nonanoic acid (1TMS) | 12.432 |
| Thymine (2TMS) | 13.12 |
| DL-Aspartic acid (2TMS) | 13.562 |
| DL-Malic Acid (3TMS) | 14.622 |
| DL- Lactic Acid Dimer (2TMS) | 14.861 |
| 2,4-dihydroxy Butanoic Acid | 13.256 |
| Salicylic acid (2TMS) | 15.071 |
| Erythronic acid (4TMS) | 15.509 |
| DL-Phenylalanine (1TMS) | 15.807 |
| trans-Cinnamic acid (TMS) | 15.845 |
| 3-Hydroxy- Benzoic Acid | 16.046 |
| 4-Hydroxyphenylethanol | 16.128 |
| 3-Hydroxy-3-methylglutaric | 16.5649 |
| 4- hydroxy-Benzoic Acid | 17.099 |
| 1,4-lactone Pentonic acid (3TMS) | 17.12 |
| 1,4-lactone, 2-methoximine Gluconic acid | 17.286 |
| Arabinose | 17.419 |
| 1-O-methyl alpha D | 18.703 |
| 2, Deoxy-pentos-3-ylose | 18.8857 |
| 3-deoxy-Gluco sone | 18.961 |
| Vanillic acid (2TMS) | 19.271 |
| 2-Keto-L-gluconic acid (5TMS) | 19.308 |
| 4-hydroxy-cis-cinnamic acid | 19.642 |
| Azelaic acid (2TMS) | 19.715 |
| Shikimic acid (4TMS) | 19.818 |
| D(−)- Quinic acid (5TMS) | 20.477 |
| Fructose MX1 | 20.641 |
| Fructose MX2 | 20.785 |
| 1,5-lactone Gluconic acid | 20.958 |
| Glucose MX1 | 21.019 |
| Unknown21.85 | 21.285 |
| Glucose MX2 | 21.285 |
| 1-Ethylglucopyranoside | 21.649 |
| Sorbitol | 21.841 |
| 4-hydroxy trans-cinnamic | 21.924 |
| Gluconic acid (6TMS) | 22.463 |
| Unknown 22.614 | 22.614 |
| Unknown 22.650 | 22.65 |
| 1-o-methyl beta-D-Galactopyranoside (4TMS) | 22.926 |
| 3,4-dimethoxy-trans- | 23.13 |
| n-Hexadecanoic acid | 23.274 |
| Inositol | 23.718 |
| n-Octadecan-l-ol (Steryl | 23.793 |
| trans-Ferulic acid (2TMS) | 23.944 |
| 3,4-dimethoxy-trans | 24.471 |
| 2-O-Glcyerol-beta-D- | 24.896 |
| trans-Sinapic acid (2TMS) | 25.852 |
| 1-Benzylglucopyranoside | 27.474 |
| Thymidine (3TMS) | 27.745 |
| Uridine (3TMS) | 28.267 |
| Unknown_28.673 | 28.384 |
| Unknown_28.722 | 28.722 |
| Unknown_29.097 | 29.097 |
| Salicylic acid | 29.515 |
| (Arbutin) Hydroquinone-beta-D-glucopyranoside (5TMS) | 29.614 |
| Unknown 29.700 | 29.7 |
| Adenosine (3TMS) | 29.861 |
| Unknown_29.995 | 29.9987 |
| Sucrose | 30.073 |
| Cellobiose MX1 | 30.74 |
| Trehalose | 31.14 |
| Turanose MX1 | 31.273 |

TABLE 7
Identified peaks and retention times of Extract D

| Compound | RT |
|---|---|
| CONT: 1038.1 | 6.252 |
| Pyruvic Acid (1TMS) | 7.05400 |
| Lactic Acid (2TMS) | 7.16200 |
| Glycolic Acid | 7.42600 |
| Oxalic Acid (2TMS) | 7.58700 |
| CONT 1228 | 8.17000 |
| 3-Hydroxypropanoic acid (2TMS) | 8.52500 |
| 3-hydroxy-pyridine (1TMS) | 8.55100 |
| CONT: 1228 | 8.76800 |
| DL-Isoleucine (1TMS) | 9.18700 |
| n-Heptanoic acid (1TMS) | 9.40500 |
| Malonic Acid (2TMS) | 9.56600 |
| Benzoic acid (1TMS) | 10.4667 |
| DL- Serine (2TMS) | 10.537 |
| Phosphoric acid (3TMS) | 10.75 |
| Thymidine (BP) | 10.857 |
| Maleic Acid (2TMS) | 11.375 |
| Succinic Acid (2TMS) | 11.565 |
| DL-Glyceric Acid (3TMS) | 11.78 |
| Itaconic acid (2TMS) | 12.072 |
| Fumaric Acid (2TMS) | 12.23 |
| n-Nonanoic acid (1TMS) | 12.438 |
| Nicotinic acid (1TMS) | 12.749 |
| Cytosine (2TMS) | 12.822 |
| 2,4-dihydroxy Butanoic Acid (3TMS) | 13.262 |
| 2-methyl-DL-Malic Acid (3TMS) | 14.319 |
| Salicylic acid (2TMS) | 14.432 |
| 3,4,5,6-D4-Salicylic acid (2TMS) | 14.555 |
| DL- Malic acid (3TMS) | 14.626 |
| Nicotinimide (1TMS) | 14.691 |
| DL- Lactic acid dimer (2TMS) | 14.863 |
| Glutaric acid (2TMS) | 15.049 |
| DL-Pyroglutamic acid (2TMS) | 15.296 |
| 2- Hydroxyglutatic acid (3TMS) | 15.365 |
| Erythronic acid (4TMS) | 15.508 |
| Trihydroxybenzene (3TMS) | 15.53 |
| DL-Phenylalanine (1TMS) | 15.82 |
| trans-Cinnamic acid (TMS) | 15.845 |
| 3-Hydroxy- Benzoic Acid (2TMS) | 16.045 |
| 4-Hydroxyphenylethanol (2TMS) | 16.128 |
| 2-oxo-Glutaric acid (1MEOX) (2TMS) | 16.16 |
| 3-Hydroxy-3-methylglutaric acid (3TMS) | 16.564 |
| 4- hydroxy-Benzoic Acid (2TMS) | 17.087 |
| 1,4-lactone Pentonic acid (3TMS) | 177.116 |
| 1,4-lactone, 2-methoximine Gluconic acid | 17.286 |
| Arabinose | 17.419 |
| 1-O-methyl beta-D-Galactopyrano side | 18.701 |
| 2, Deoxy-pentos-3-ylose dimethoxyamine | 18.883 |
| cis-Aconitic acid (3TMS) | 18.951 |
| 4-Hydroxyphenylpropionic acid (2TMS) | 19.192 |
| Vanillic acid (2TMS) | 19.261 |
| 2-Keto-L-gluconic acid (5TMS) | 19.309 |
| 3-deoxy-Gluco sone | 19.531 |
| 4-hydroxy-cis-cinnamic acid | 19.641 |
| Azelaic acid (2TMS) | 19.709 |
| Shikimic acid (4TMS) | 19.818 |
| D(−)- Quinic acid (5TMS) | 20.481 |
| Fructose MX1 | 20.63 |
| Fructose MX2 | 20.785 |
| 1,5-lactone Gluconic acid | 20.954 |
| Glucose MX1 | 20.996 |
| Glucose MX2 | 21.285 |
| Sorbitol | 21.841 |
| 4-hydroxy trans-cinnamic acid | 21.913 |
| Gluconic acid (6TMS) | 22.462 |
| 1-o-methyl beta-D-Galactopyranoside (4TMS) | 22.535 |
| 3,4-dimethoxy-trans-Cinnamic acid | 23.127 |
| n-Hexadecanoic acid (1TMS) | 23.277 |
| Inositol | 23.718 |
| n-Octadecan-1-ol (Steryl alcohol) | 23.791 |
| trans-Ferulic acid (2TMS) | 23.937 |
| trans-Caffeic acid (3TMS) | 24.468 |
| 2-O-Glcerol-beta-D-galactopyranoside (6TMS) | 25.514 |
| 1-Methyl-beta-D-galactopyranoside (4TMS) | 25.517 |
| trans-Sinapic acid (2TMS) | 25.85 |
| 1-Benzylglucopyranoside | 27.471 |
| Thymidine (3TMS) | 27.74 |
| Uridine (3TMS) | 28.272 |
| Salicylaldehyde-beta-D-glucoside (TMS) | 29.521 |
| Salicylic acid glucopyranoside (5TMS) | 29.522 |
| (Arbutin) Hydroquinone-beta-D-glucopyranoside (5TMS) | 29.924 |
| Unknown 29.704 | 29.704 |
| Adenosine (3TMS) | 29.866 |
| Sucrose | 30.073 |
| Cellobiose MX1 | 30.751 |
| Maltose | 31.129 |
| Trehalose | 31.151 |
| Turanose MX1 | 31.273 |
| Guanosine | 31.638 |
| Melibiose MX1 | 32.406 |
| beta-D-Glucopyranuronic acid (5TMS) | 33.164 |
| Galactinol | 33.573 |
| 3-p-coumaroyl-trans-Quinic acid | 33.658 |
| Unknown_33.736 | 33.736 |
| 3-caffeoyl-trans-Quinic acid | 34.859 |
| Unknown_34.708 | 35.32 |
| 4-Caffeoyl-trans-Quinic Acid | 35.418 |
| Unknown_35.549 | 35.55 |
| 5-Caffeoyl-trans-Quinic Acid | 35.619 |
| 1-Kestose | 37.083 |

TABLE 8
Library of individual compounds detected across each sample.

| | Extract | Extract | |
|---|---|---|---|
| Compounds | A | D | Notes |
| Hydroquinone-beta-D- | x | x | glycoside |
| glucopyranoside | | | |
| (Arbutin) (5TMS) | | | |
| Salicylaldehyde-beta-D- | | x | O-glucoside |
| glucoside (Helicin) | | | |
| 1,4-lactone Pentonic acid | x | x | sugar acid |
| (3TMS) | | | |
| 1,4-lactone, 2- | x | x | sugar acid |
| methoximine Gluconic | | | |
| acid | | | |
| 1,5-lactone Gluconic acid | x | x | sugar acid |
| 1-Benzylglucopyranoside | x | x | glucoside |
| 1-Ethylglucopyranoside | x | | glucoside |
| (4TMS) | | | |
| 1-Kestose | | x | inulin |
| 1-O-methyl alpha D | x | | found in cereals and |
| Mannopyranoside | | | alfalfa |
| (4TMS) | | | |
| 1-o-methyl beta-D- | x | x | glucoside |
| Galactopyranoside | | | |
| (4TMS) | | | |
| 2, Deoxy-pentos-3-xylose | x | x | amine |
| dimethoxyamine (2TMS) | | | |
| 2,4-dihydroxy-Butanoic | x | x | carboxylic acid |
| acid (3TMS) | | | |
| 2-Hydroxyglutaric Acid | | x | fatty acid |
| (3TMS) | | | |
| 2-Keto-L-gluconic acid | x | x | sugar acid |
| (5TMS) | | | |
| 2-O-Glycerol-beta-D- | x | x | glucoside |
| galactopyranoside | | | |
| (6TMS) | | | |
| 2-oxo-Glutaric acid | | x | sugar acid |
| (1MEOX) (2TMS) | | | |
| 3,4-dimethoxy-trans | x | x | phenolic acid |
| Cinnamic Acid | | | |
| 3,4,5,6-D4-Salicylic acid | | x | carboxylic acid |
| (2TMS) | | | |
| 3-caffeoyl-trans-Quinic | x | x | cyclic polyol |
| acid | | | |
| 3-deoxy-Glucosone | x | x | maillard reaction |
| | | | product |
| 3-Hydroxy- Benzoic Acid | x | x | carboxylic acid |
| (2TMS) | | | |
| 3-Hydroxy-3- | x | x | fatty acid |
| methylglutaric acid | | | |
| (3TMS) | | | |
| 3-Hydroxypropanoic | x | x | carboxylic acid |
| Acid (2TMS) | | | |
| 3-hydroxy-pyridine | x | x | pyridine |
| (1TMS) | | | |
| 3-p-coumaroyl-trans- | x | x | cyclic polyol |
| Quinic acid | | | |
| 4-Caffeoyl-trans-Quinic | x | x | cyclic polyol |
| Acid | | | |
| 4-hydroxy trans-cinnamic | x | x | phenolic acid |
| acid | | | |
| 4-hydroxy-Benzoic Acid | | x | carboxylic acid |
| (2TMS) | | | |
| 4-hydroxy-cis-cinnamic | x | x | phenolic acid |
| acid | | | |
| 4-Hydroxyphenylethanol | x | x | antioxidant phenol |
| (2TMS) (Tyrosol) | | | |
| 4- | | x | carboxylic acid |
| Hydroxyphenylpropionic | | | |
| acid (2TMS) | | | |
| 5-caffeoyl-trans-Quinic | x | x | cyclic polyol |
| Acid | | | |
| Adenosine (3TMS) | x | x | nucleoside |
| Arabinose | x | x | aldopentose |
| Azelaic acid (2TMS) | x | x | |
| Benzoic acid (1TMS) | x | x | carboxylic acid |
| beta-D-Glucopyranuronic | | x | o-glucuronides |
| acid (5TMS) | | | |
| Cellobiose MX1 | x | x | disaccharide |
| cis-Aconitic acid (3TMS) | | x | organic acid |
| Cytosine (2TMS) | | x | nucleobase |
| D(−)- Quinic acid (5TMS) | x | x | cyclic polyol |
| DL- 2-methyl Malic Acid | | x | organic acid |
| (3TMS) | | | |
| DL- Isoleucine (1TMS) | | x | organic acid |
| DL- Lactic Acid (2TMS) | x | x | organic acid |
| DL- Malic Acid (3TMS) | x | x | organic acid |
| DL- Serine (2TMS) | x | x | organic acid |
| DL-Aspartic acid (2TMS) | x | | organic acid |
| DL-Glyceric Acid | x | x | sugar acid |
| (3TMS) | | | |
| DL-Lactic acid dimer | x | x | organic acid |
| (2TMS) | | | |
| DL-Phenylalanine | x | x | organic acid |
| (1TMS) | | | |
| DL-Pyroglutamic Acid | | x | organic acid |
| (2TMS) | | | |
| Erythronic acid (4TMS) | x | x | sugar acid |
| Fructose MX1 | x | x | monosaccharide |
| Fructose MX2 | x | x | monosaccharide |
| Fumaric Acid (2TMS) | x | x | carboxylic acid |
| Galactinol | x | x | galactose |
| | | | metabolism |
| | | | intermediate |
| Gluconic acid (6TMS) | x | x | sugar acid |
| Glucose MX1 | x | x | monosaccharide |
| Glucose MX2 | x | x | monosaccharide |
| Glutaric acid (2TMS) | | x | fatty acid |
| Glycolic Acid | x | x | organic acid |
| Guanosine | | x | nucleoside |
| Inositol | x | x | carbocyclic sugar |
| Itaconic acid (2TMS) | | x | organic acid |
| Maleic Acid (2TMS) | | x | organic acid |
| Malonic Acid (2TMS) | x | x | organic acid |
| Maltose | | x | disaccharide |
| Melibiose MX1 | x | x | reducing |
| | | | disaccharide |
| n-Heptanoic acid (1TMS) | x | x | fatty acid |
| n-hexadecanoic acid | x | x | fatty acid |
| (1TMS) | | | |
| Nicotinic acid (Niacin) | | x | Vitamin B3 form |
| (1TMS) | | | |
| Nicotinimide (1TMS) | | x | Vitamin B3 form |
| n-Nonanoic acid (1TMS) | x | x | fatty acid |
| n-Octadecan-1-ol (Steryl | x | x | fatty alcohol |
| alcohol) | | | |
| Oxalic Acid (2TMS) | x | x | organic acid |
| Phosphoric acid (3TMS) | x | x | inorganic acid |
| Pyruvic Acid (1TMS) | x | x | organic acid |
| Salicylic acid (2TMS) | x | x | phenolic acid |
| Salicylic acid | x | x | glucoside |
| glucopyranoside (5TMS) | | | |
| Shikimic acid (4TMS) | x | x | cyclic polyol |
| Sorbitol | x | x | sugar alcohol |
| Stigmasterol | x | | phytosterol |
| Succinic acid (2TMS) | x | x | organic acid |
| Sucrose | x | x | disaccharide |
| Thymidine | x | x | nucleotide |
| Thymine (2TMS) | x | | nucleobase |
| trans- Caffeic acid | | x | phenolic acid |
| (3TMS) | | | |
| trans-Cinnamic acid | x | x | phenolic acid |
| (TMS) | | | |
| trans-Ferulic acid | x | x | phenolic acid |
| (2TMS) | | | |
| trans-Sinapic acid | x | | phenolic acid |
| (2TMS) | | | |
| Trehalose | x | x | disaccharide |
| Turanose MX1 | x | x | reducing |
| | | | disaccharide |
| Uracil (2TMS) | x | | nucleobase |
| Uridine (3TMS) | x | x | nucleoside |
| Vanillic acid (2TMS) | x | x | phenolic acid |

Example 2 to Example 6 provide illustrative and non-limiting examples of the preparation and characterisation of extracts derived from sugar cane of the present disclosure.

### Example 2. Sugar Cane Extracts Derived from Molasses

Example sugar cane extracts of the present disclosure were prepared from molasses as follows.

Sugar cane molasses was diluted with de-ionised water, mixed well to give a final Brix of 50°. This mixture was held between 20-25° C. and 95% food grade ethanol added with overhead stirring to ensure that the ethanolic mixture was evenly and quickly dispersed. This step was continued until the final ethanol content reached 76% v/v. During this time, a gelatinous precipitate formed. The precipitate was allowed to settle and the supernatant was decanted and filtered under vacuum in a Buchner Funnel through a Whatman GFA filter paper grade 1. The ethanol was subsequently removed under reduced pressure in a Buchi Rotary Evaporator at 45° C. Evaporation was continued under reduced pressure at 50-55° C. to give a syrup with a final Brix of 70° with a bitter sweet aroma. Characterisation of exemplary syrups obtained by this method is shown in Table 9.

TABLE 9
Properties of sugar cane extracts prepared from molasses

| Property | Extract 1 | | Extract 2 | |
|---|---|---|---|---|
| Brix (° Bx) | 65-70 | | 70° (+/−2) @ 20° C. | |
| pH | 4-5 | | 4.6 (+/−0.2) @ 20° C. | |
| Density (g/mL) | 1.25-1.35 | | 1.35 (+/−0.05 @ 20° C.) | |
| Colour Absorbance 420 | 69.1 | | — | |
| Absorbance 270 | 708 | | — | |
| Ratio A270/A420 | 10 | | — | |
| Total Polyphenol | 16,500 | | Minimum 20,000 | |
| (mg/L as gallic acid | | | | |
| equivalents) | | | | |
| Total Flavonoids (mg/L as | 2800 | | Minimum 7,000 | |
| catechin equivalents) | | | | |
| ORAC 5.0 | — | | Minimum 2.5 mol/kg | |
| CAA | — | | Minimum 2.5 mol/kg as | |
| | | | trolox equivalents | |
| Conductivity (μS/cm) | 138,800 | | — | |
| Calcium | 5100 | mg/kg | 400-1,300 | mg/L |
| Iron | 110 | mg/kg | 10-100 | mg/L |
| Magnesium | 1800 | mg/kg | 2,400-5,500 | mg/L |
| Potassium | 26,000 | mg/kg | 20,000-40,0000 | mg/L |

| | | |
|---|---|---|
| Sodium | 23 mg/100 g | 60-80 mg/100 mL |
| Zinc | — | 0.3-0.8 mg/100 mL |
| Selenium | — | 0.03-0.09 mg/100 mL |
| Chromium | — | 0.03-0.140 mg/100 mL |

### Example 3. Fractionated Sugar Cane Extracts Derived from Molasses

In general, the title fractionated sugar cane extracts may be prepared using hydrophobic chromatography procedures. Extracts prepared using the processes described in Example 2 and any sugar cane derived product may be used as feedstocks for chromatography. The hydrophobic resin used for chromatography may be a food grade resin.

In a representative preparation, FPX66 resin (Dow, Amberlite FPX66, food grade)) was pre-treated by washing with de-ionised water, ethanol and then finally with de-ionised water following the manufacturer's instructions. The washed resin was filtered under vacuum through a Buchner Funnel using Whatman filter paper grade 1 (1 μm pore size). The resin granules were then used as is.

De-ionised water was added to sugar cane molasses with constant stirring until the Brix reached 20°. To a beaker containing 1 litre of the 20° Brix feedstock (maintained at 20-25° C.) and mounted on a magnetic stirrer, 500 g of wet weight pre-treated resin was added with gentle stirring to ensure effective mixing of the resin granules with the feedstock. The mixing was continued for 10 min at which point the mixture was filtered under vacuum and the resin was collected.

The collected resin was washed by resuspension in de-ionised water (1 litre). This step was repeated.

The washed resin was then suspended in 1 litre 70% ethanol solution in de-ionised water, stirred for 10 mins and the filtrate was collected by vacuum filtration. This was repeated twice more with 1 litre batches of the 70% ethanolic solution with each filtrate being collected. Finally, the three 70% ethanolic filtrates were combined and the ethanol removed by evaporation under reduced pressure. The aqueous fraction was lyophilised or spray-dried into a free flowing brown powder with a moisture content of 0.3-2.0% w/w. The properties of the ethanolic fraction are shown below in Table 10.

TABLE 10
Properties of an extract derived from sugar cane molasses

| Properties | Ethanol fraction |
|---|---|
| Colour Absorbance at 420 nm | 10 (1% in solution @ 20° C.) |
| Absorbance at 270 nm | 180 (1% in solution @ 20° C.) |
| Ratio A270 nm/A420 nm | 19 (1% in solution @ 20° C.) |
| Total Polyphenol | Minimum 200 |
| (mg/g gallic acid equivalent) | |
| Total Flavonoid | Minimum 50 |
| (mg/g catechin equivalent) | |
| Calcium (mg/kg) | 840 |
| Iron (mg/kg) | 77 |
| Magnesium (mg/kg) | 2300 |
| Potassium (mg/kg) | 1100 |
| Sodium (mg/g) | 1700 |
| Zinc (mg/kg) | 48 |
| Selenium (mg/kg) | 0.18 |
| Chromium (mg/kg) | 1.8 |

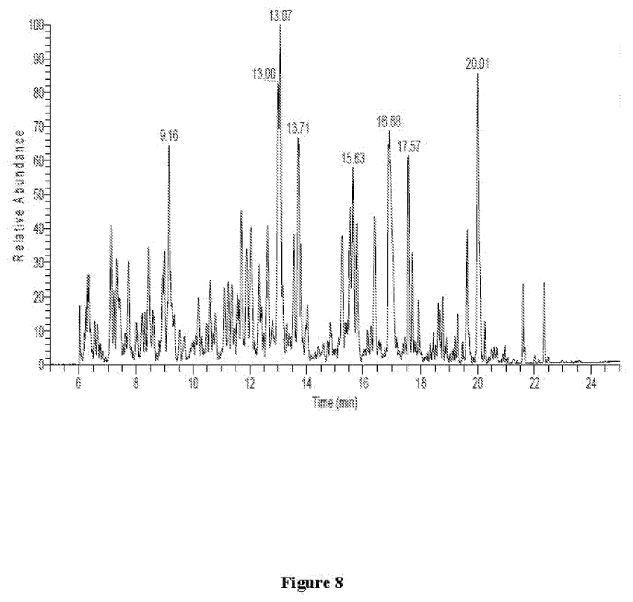

FIG. 8 exhibits a LC-MS spectrum of a representative extract derived from sugar cane molasses using this process.

### Example 4. Sugar Cane Extracts Derived from Dunder

A scheme for the preparation of the title sugar cane extracts is shown in FIG. 9.

Sugar cane dunder was allowed to settled overnight for eight hours in a V—bottom tank. The supernatant was then subjected to sequential microfiltration through: (i) a 5 micron filter; (ii) a 1 micron filter; (iii) a 0.5 micron filter; and (iv) a 0.1 micron filter.

The filtered supernatant was subsequently concentrated in a heat exchanger to remove water to provide the liquid extract with 55° Bx.

The properties of an extract derived from dunder is shown below in Table 11.

TABLE 11
Properties of an extract derived from dunder

| Properties | Sugar cane extract |
|---|---|
| Brix | 55° (+/−2) @ 20° C. |
| pH | 4.6 (+/−0.2) @ 20° C. |
| Density | 1.28 g/mL (+/−0.05) @ 20° C. |
| Colour Absorbance 420 | 190-280 |
| Absorbance 270 | 2300-3000 |
| Ratio A270/A420 | 10-15 |
| Total Polyphenol | Minimum 45,000 |
| (mg/L as gallic acid | |
| equivalent) | |
| Total Flavonoid | Minimum 10,000 |
| (mg/L as catechin | |
| equivalent) | |
| Conductivity (uS/m) | 250,000-350,000 |
| Calcium (mg/kg) | 3,000-4,000 |
| Iron (mg/kg) | 100-150 |
| Magnesium (mg/kg) | 3,000-5,000 |
| Potassium (mg/kg) | 30,000-40,000 |
| Sodium (mg/kg) | 2,000-3,000 |
| Zinc (mg/100 g) | 0.5-1.5 |
| Selenium (mg/100 g) | 0.02-0.05 |
| Chromium (mg/100 g) | 0.20-0.5 |

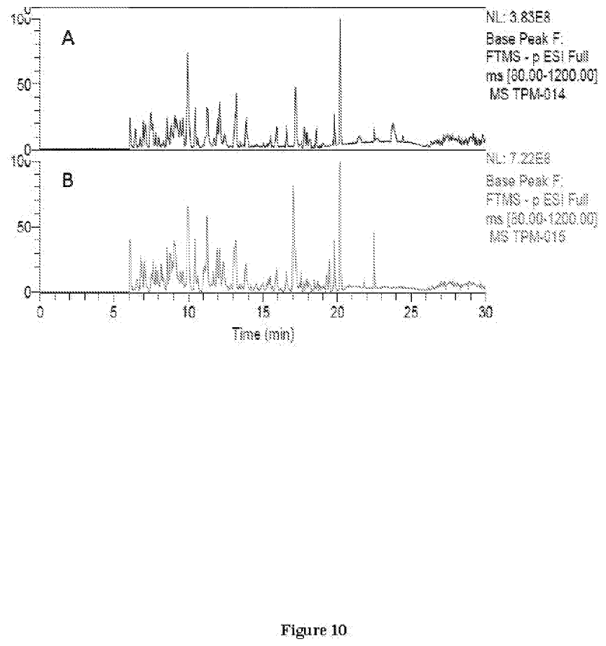

FIG. 10 exhibits example LC-MS spectra for sugar cane dunder starting material (A) and an extract of sugar cane derived dunder (B) in accordance with the above process.

### Example 5. Hybrid Sugar Cane Extracts Derived from a Combination of Sugar Cane Molasses and Dunder

A scheme for the preparation of the title sugar cane extracts is shown in FIG. 11.

Sugar cane mill molasses was diluted with water and mixed with settled sugar cane dunder (as described above) and stirred well to provide a mixture with 50° Bx. The combined mixture of molasses and dunder was maintained at a constant temperature of between 20-25° C. and 95% food grade ethanol added and stirred to ensure that the ethanol was evenly and quickly dispersed. Ethanol was added until the ethanol level was 76% v/v.

The addition and mixing of ethanol led to the formation of a gelatinous precipitate. The precipitate in the mixture was allowed to settle and the supernatant was removed by decantation and vacuum filtration in a Buchner funnel through a Whatman GFA filter paper 1.

The ethanol was removed from the supernatant under vacuum in a Buchi rotary evaporator at 45° C. Evaporation of water from the supernatant was performed under vacuum at 50-55° C. until the final syrup reaches 70° Bx.

Table 12 shows the properties of the hybrid sugar cane extract obtained.

TABLE 12
Properties of a hybrid sugar cane extract

| Property | Sugar cane extract |
|---|---|
| Brix | 70° (+/−2) @ 20° C. |
| pH | 4.6 (+/−0.2) @ 20° C. |
| Density | 1.35 (+/−0.05 @ 20° C.) |
| Colour Absorbance 420 | 90-120 |
| Absorbance 270 | 1900-2300 |
| Ratio A270/A420 | 15-30 |
| Total Polyphenol | Min 30,000 |
| (mg/L as gallic acid | milligrams per litre |
| equivalent) | (as gallic acid |
| | equivalents) |
| Total Flavonoid | Minimum 10,000 |
| (mg/L as catechin | |
| equivalent) | |
| Conductivity (uS/m) | 180,000-200,000 |
| Calcium (mg/kg) | 80-160 |
| Iron (mg/kg) | 2-8 |
| Magnesium (mg/kg) | 300-600 |
| Potassium (mg/kg) | 2000-4000 |
| Sodium (mg/kg) | 60-180 |
| Zinc (mg/100 g) | 1.5-3.0 |
| Selenium (mg/100 g) | 0.04-0.09 |
| Chromium (mg/100 g) | 0.015-0.50 |

### Example 6. Characteristics of Extracts Derived from Sugar Cane

TABLE 13
Two example extracts derived from sugar
cane of the present disclosure

| | Extract 3 | Extract 4 |
|---|---|---|
| | prepared according | prepared according |
| | to the process | to the process |
| | of Example 2 | of Example 3 |
| Brix | 65-70 Brix | 68-70 Brix |
| pH | 5.3-5.9 | 4.5-4.7 |
| Density | 1.25-1.35 | 1.35 |
| Colour Absorbance 420 | 69.1 | 65 |
| Absorbance 270 | 708 | 1506 |
| Ratio A270/A420 | 10 | 23 |
| Total Polyphenol | 16,500 | 24,000-28,000 |
| (mg/L gallic acid equivalent) | | |
| Total Flavonoid | 2800 | 5900 |
| (mg/L catechin equivalent) | | |
| Conductivity (us) | 138,800 | 57,200 |
| Calcium (mg/kg) | 5100 | 1614 |
| Iron (mg/kg) | 110 | 52 |
| Magnesium (mg/kg) | 1800 | 2250 |
| Potassium (mg/kg) | 26,000 | 21,000 |
| Sodium (mg/100 g) | 23 | 47 |

Table 14 exhibits a component comparison between molasses and extracts derived from sugar cane of the present disclosure.

TABLE 14
A comparison between molasses and an extract derived
from sugar cane of the present disclosure.

| | | Extract derived from |
|---|---|---|
| Components | Molasses | sugar cane |
| Total solids (g/L) | 80.5 | 70 |
| Fructose (g/L) | 131.9 | 74.5 |
| Glucose (g/L) | 107.1 | 52.8 |
| Sucrose (g/L) | 473.8 | 343 |
| Total sugars (g/L) | 722.8 | 470 |
| Ratio (Fructose + Glucose/Sucrose) | 0.50 | 0.41 |
| Total polyphenol (mg GAE/L ) | 20,000 | 25,000-28,000 |
| Antioxidants (ABTS mg GAE/L) | 7,000-8,500 | 10,500-11,500 |
| Calcium (mg/L) | 5746 | 2145 |
| Magnesium (mg/L) | 2374 | 3003 |
| Sodium (mg/L) | 303 | 605 |
| Potassium (mg/L) | 20,794 | 27170 |

Examples 7 to 11 provides illustrative and non-limiting examples of applications of extracts derived from sugar cane of the present disclosure.

### Example 7. Taste or Mouthfeel Improving or Masking Activity of Extracts Derived from Sugar Cane on Coca Cola Life

Coca Cola Life

Coca Cola Life contains the sweetener Stevia.

An extract derived from sugarcane according to the present disclosure was tested on human participants to evaluate in-use performance of the extract in Coca Cola Life.

16 participants were recruited for the study. Each of the participants was given standard samples of Coca Cola Life and test samples of Coca Cola Life with 0.1% v/v of an extract derived from sugar cane according to the present disclosure. Standard samples of Coca Cola Life were purchased from the Coca Cola Company. Test samples were prepared by adding 0.1% v/v of an extract derived from sugar cane according to the present disclosure to Coca Cola Life.

Participants were asked to evaluate the standard and test samples based on 3 attributes. Participants first tasted the standard sample and from the basis of personal taste provided a rating from 1 to 10; 1 being the lowest perception of that attribute and 10 being the highest perception of that attribute. Participants then tasted the test sample and rated the test sample relative to the standard sample, i.e., whether the perception of the attribute had increased or decreased relative to the standard sample.

Table 15 exhibits the results of the taste and mouthfeel evaluation of a standard sample of Coca Cola Life in comparison to a test sample of Coca Cola Life with added 0.1% v/v of an extract derived from sugar cane according to the present disclosure.

TABLE 15
Evaluation of the taste and mouthfeel of a standard sample
of Coca Cola Life in comparison to a test sample of Coca
Cola Life with added 0.1% v/v of an extract derived from
sugar cane according to the present disclosure.

| Partic- | Standard | Test | Standard | Test | Standard | Test |
|---|---|---|---|---|---|---|
| ipant | Metallic | Metallic | Body | Body | Sweetness | Sweetness |
| 100 | 5 | 2 | 2 | 8 | 2 | 8 |
| 101 | 4 | 2 | 2 | 8 | 2 | 8 |
| 102 | 5 | 1 | 1 | 9 | 1 | 9 |
| 103 | 5 | 3 | 3 | 7 | 3 | 7 |
| 104 | 6 | 2 | 2 | 8 | 2 | 8 |
| 105 | 4 | 6 | 4 | 6 | 4 | 6 |
| 106 | 5 | 3 | 3 | 7 | 3 | 7 |
| 107 | 6 | 3 | 4 | 7 | 4 | 7 |
| 108 | 7 | 3 | 3 | 7 | 3 | 7 |
| 109 | 5 | 2 | 2 | 7 | 2 | 8 |
| 110 | 4 | 2 | 2 | 8 | 2 | 8 |
| 111 | 5 | 2 | 2 | 8 | 2 | 8 |
| 112 | 6 | 3 | 3 | 7 | 2 | 7 |
| 113 | 5 | 2 | 2 | 8 | 2 | 8 |
| 114 | 6 | 3 | 3 | 7 | 3 | 7 |
| 115 | 5 | 4 | 4 | 6 | 4 | 6 |
| Average | 5.1875 | 2.6875 | 2.625 | 7.375 | 2.5625 | 7.4375 |

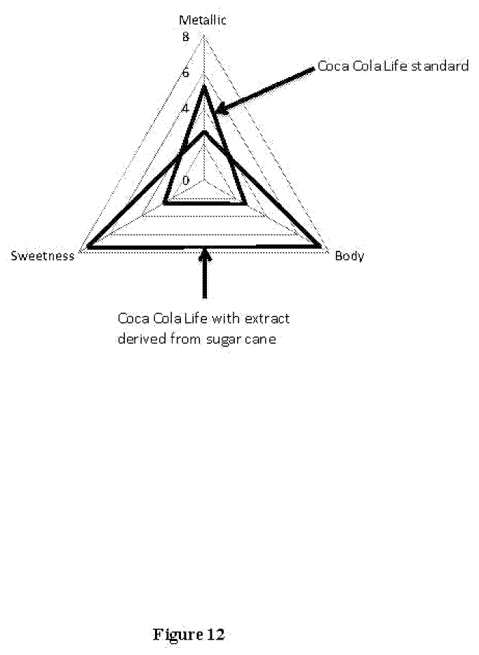

The evaluation results of Table 15 are exhibited in the radar chart comparison of Coca Cola Life vs Coca Cola Life with added 0.1% of an extract derived from sugar cane according to the present disclosure (FIG. 12).

As is demonstrated by the results, 0.1% of an extract derived from sugar cane according to the present disclosure added to Coca Cola Life increased sweetness, provided better body and significantly masked the metallic note of Coca Cola Life.

Although not presented in the table above, participants described that the astringent note of Coca Cola Life was also reduced by the addition of 0.1% of an extract derived from sugar cane according to the present disclosure to Coca Cola Life.

### Example 8. Taste Panel Analysis on Other Beverages Containing High-Intensity Sweeteners

Extracts derived from sugarcane according to the present disclosure were tested on human participants to evaluate in-use performance of the composition included in other beverages. These beverages include Coke Zero, Diet Coke, Pepsi Max, Pepsi Lite, Lipton Light Peach Tea, Lipton Peach Tea, Sunkist Orange, Powerade Zero, V Zero, V Sugar Free, Red Bull Zero and Red Bull Sugar Free.

Standard samples of commercial products were purchased from retailers and supermarkets. Test samples were prepared by adding 0.1% v/v of an extract derived from sugar cane to each of the beverages. Participants were given the standard sample and the test sample to evaluate based on 5 attributes. Participants first tasted the standard sample and from the basis of personal taste provided a rating from 1 to 10; 1 being the lowest perception of that attribute and 10 being the highest perception of that attribute. Participants then tasted the test sample and rated the test sample relative to the standard sample, i.e., whether the perception of the attribute had increased or decreased relative to the standard sample. Results were averaged and plotted on a radar chart.

### Coca Cola Zero

Coca Cola Zero contains a sweetener blend of aspartame and acesulfame potassium.

13 participants were recruited for the study. Each of the participants was given standard samples of Coca Cola Zero and test samples of Coca Cola Zero with 0.1% v/v of an extract derived from sugar cane according to the present disclosure.

Table 16 exhibits the average results of evaluation of the taste and mouthfeel of a standard sample of Coca Cola Zero in comparison to a test sample of Coca Cola Zero with added 0.1% v/v of an extract derived from sugar cane according to the present disclosure.

TABLE 16
Evaluation of the taste and mouthfeel of a standard sample
of Coca Cola Zero in comparison to a test sample of Coca
Cola Zero with added 0.1% v/v of an extract derived from
sugar cane according to the present disclosure.

| | Standard (average) | Test (average) |
|---|---|---|
| Likeability | 6.15 | 6.62 |
| Metallic/Astringent | 6.02 | 5.55 |
| Upfront Sweetness | 6.04 | 6.45 |
| Lingering Sweetness | 6.82 | 6.32 |
| Body | 5.42 | 6.38 |

As is demonstrated by the results, 0.1% of an extract derived from sugar cane according to the present disclosure added to Coca Cola Zero provided better body, reduced the metallic note and astringency and overall, provided a more likeable product. 0.1% of an extract derived from sugar cane according to the present disclosure added to Coca Cola Zero also increased the upfront sweetness and decreased the lingering sweetness.

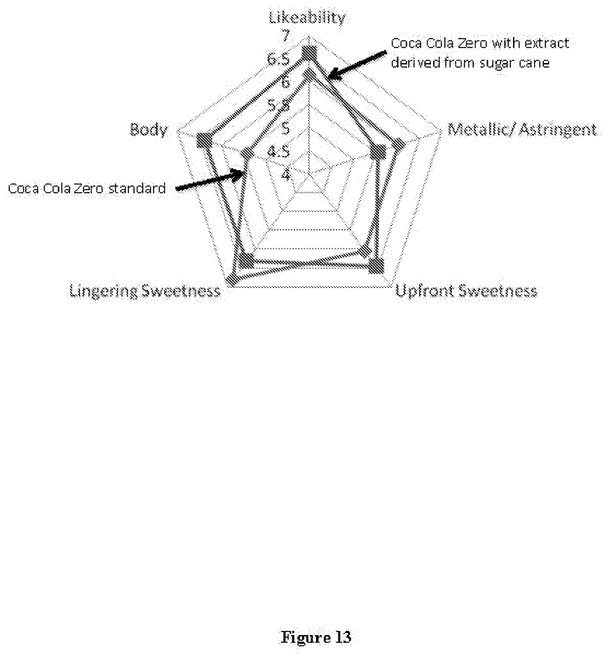

The evaluation results are exhibited in the radar chart comparison of Coca Cola Zero vs Coca Cola Zero with added 0.1% of an extract derived from sugar cane according to the present disclosure (FIG. 13).

### Diet Coke

Diet Coke contains a sweetener blend of acesulfame potassium and aspartame.

13 participants were recruited for the study. Each of the participants was given standard samples of Diet Coke and test samples of Diet Coke with 0.1% v/v of an extract derived from sugar cane according to the present disclosure.

Table 17 exhibits the average results of evaluation of the taste and mouthfeel of a standard sample of Diet Coke in comparison to a test sample of Diet Coke with added 0.1% v/v of an extract derived from sugar cane according to the present disclosure.

TABLE 17
Evaluation of the taste and mouthfeel of a standard
sample of Diet Coke in comparison to a test sample
of Diet Coke with added 0.1% v/v of an extract derived
from sugar cane according to the present disclosure.

| | Standard (average) | Test (average) |
|---|---|---|
| Likeability | 6.23 | 6.31 |
| Metallic/Astringent | 5.88 | 5.23 |
| Upfront Sweetness | 6.42 | 6.12 |
| Lingering Sweetness | 6.65 | 6.45 |
| Body | 5.62 | 6.15 |

As is demonstrated by the results, 0.1% of an extract derived from sugar cane according to the present disclosure added to Diet Coke provided better body, reduced the metallic note and astringency of Diet Coke and overall, provided a more likeable product. 0.1% of an extract derived from sugar cane according to the present disclosure added to Diet Coke also decreased the upfront sweetness and the lingering sweetness.

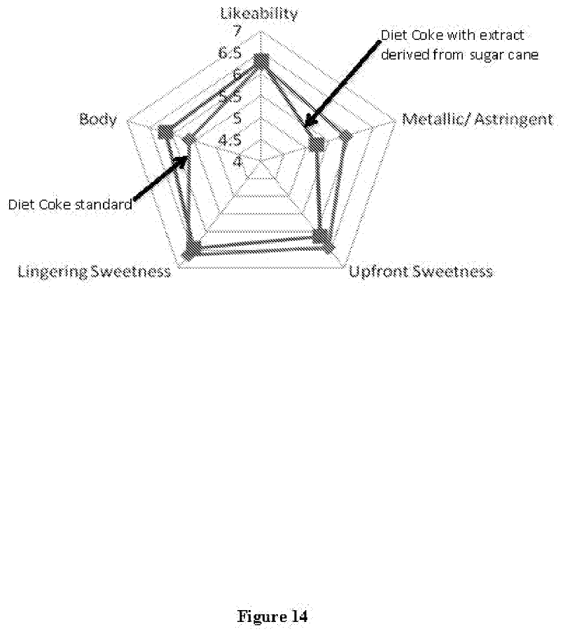

The evaluation results are exhibited in the radar chart comparison of Diet Coke vs Diet Coke with added 0.1% of an extract derived from sugar cane according to the present disclosure (FIG. 14).

### Pepsi Max

Pepsi Max contains a sweetener blend of aspartame and acesulfame potassium.

13 participants were recruited for the study. Each of the participants was given standard samples of Pepsi Max and test samples of Pepsi Max with 0.1% v/v of an extract derived from sugar cane according to the present disclosure.

Table 18 exhibits the average results of evaluation of the taste and mouthfeel of a standard sample of Pepsi Max in comparison to a test sample of Pepsi Max with added 0.1% v/v of an extract derived from sugar cane according to the present disclosure.

TABLE 18
Evaluation of the taste and mouthfeel of a standard
sample of Pepsi Max in comparison to a test sample
of Pepsi Max with added 0.1% v/v of an extract derived
from sugar cane according to the present disclosure.

| | Standard (average) | Test (average) |
|---|---|---|
| Likeability | 6.08 | 6.42 |
| Metallic/Astringent | 5.46 | 5.28 |
| Upfront Sweetness | 6.27 | 5.81 |
| Lingering Sweetness | 6.42 | 5.95 |
| Body | 5.58 | 6.44 |

As is demonstrated by the results, 0.1% of an extract derived from sugar cane according to the present disclosure added to Pepsi Max provided better body, reduced the metallic note and astringency of Pepsi Max and overall, provided a more likeable product. 0.1% of an extract derived from sugar cane according to the present disclosure added to Pepsi Max also decreased the upfront sweetness and the lingering sweetness.

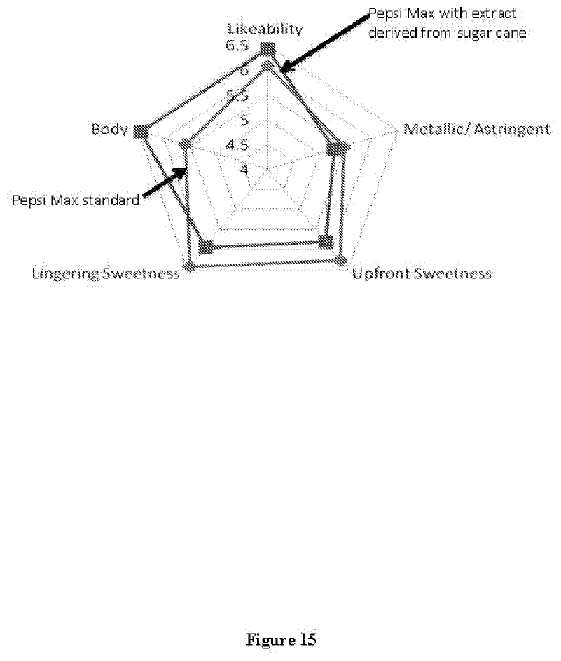

The evaluation results are exhibited in the radar chart comparison of Pepsi Max vs Pepsi Max with added 0.1% of an extract derived from sugar cane according to the present disclosure (FIG. 15).

### Pepsi Lite

Pepsi Lite contains a sweetener blend of aspartame and acesulfame potassium.

13 participants were recruited for the study. Each of the participants was given standard samples of Pepsi Lite and test samples of Pepsi Lite with 0.1% v/v of an extract derived from sugar cane according to the present disclosure.

Table 19 exhibits the average results of evaluation of the taste and mouthfeel of a standard sample of Pepsi Lite in comparison to a test sample of Pepsi Lite with added 0.1% v/v of an extract derived from sugar cane according to the present disclosure.

TABLE 19
Evaluation of the taste and mouthfeel of a standard sample
of Pepsi Lite in comparison to a test sample of Pepsi
Lite with added 0.1% v/v of an extract derived from
sugar cane according to the present disclosure.

| | Standard (average) | Test (average) |
|---|---|---|
| Likeability | 5.23 | 6.12 |
| Metallic/Astringent | 6.04 | 5.42 |
| Upfront Sweetness | 6.25 | 5.77 |
| Lingering Sweetness | 6.31 | 6.5 |
| Body | 5.31 | 6.27 |

As is demonstrated by the results, 0.1% of an extract derived from sugar cane according to the present disclosure added to Pepsi Lite provided better body, reduced the metallic note and astringency of Coca Cola Zero and overall, provided a more likeable product. 0.1% of an extract derived from sugar cane according to the present disclosure added to Pepsi Lite also decreased the upfront sweetness and increased the lingering sweetness. Although not presented in the table above, participants described that the addition of 0.1% of an extract derived from sugar cane according to the present disclosure to Pepsi Lite provided a well rounded beverage.

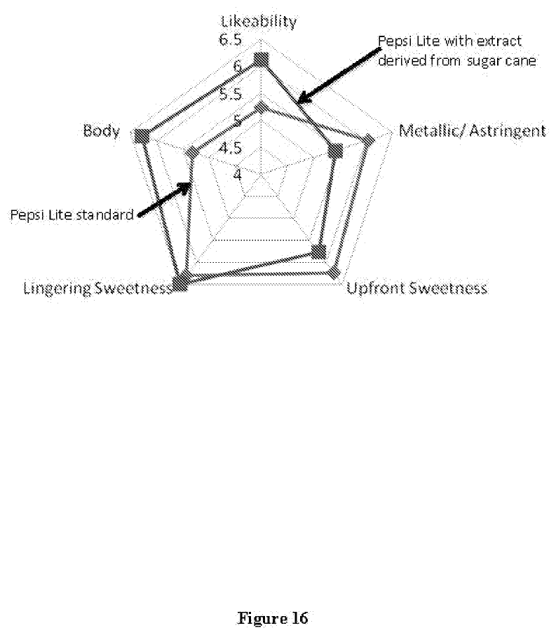

The evaluation results are exhibited in the radar chart comparison of Pepsi Lite vs Pepsi Lite with added 0.1% of an extract derived from sugar cane according to the present disclosure (FIG. 16).

### Lipton Light Peach Tea

Lipton Light Peach Tea contains a sweetener blend of aspartame and acesulfame potassium.

13 participants were recruited for the study. Each of the participants was given standard samples of Lipton Light Peach Tea and test samples of Lipton Light Peach Tea with 0.1% v/v of an extract derived from sugar cane according to the present disclosure.

Table 20 exhibits the average results of evaluation of the taste and mouthfeel of a standard sample of Lipton Light Peach Tea in comparison to a test sample of Lipton Light Peach Tea with added 0.1% v/v of an extract derived from sugar cane according to the present disclosure.

TABLE 20
Evaluation of the taste and mouthfeel of a standard sample
of Lipton Light Peach Tea in comparison to a test sample of
Lipton Light Peach Tea with added 0.1% v/v of an extract derived
from sugar cane according to the present disclosure.

| | Standard (average) | Test (average) |
|---|---|---|
| Likeability | 6.15 | 6.65 |
| Metallic/Astringent | 5.19 | 5.04 |
| Upfront Sweetness | 5.46 | 5.27 |
| Lingering Sweetness | 5.73 | 5.38 |
| Body | 5.31 | 6 |

As is demonstrated by the results, 0.1% of an extract derived from sugar cane according to the present disclosure added to Lipton Light Peach Tea provided better body, reduced the metallic note and astringency of Lipton Light Peach Tea and overall, provided a more likeable product. 0.1% of an extract derived from sugar cane according to the present disclosure added to Lipton Light Peach Tea also decreased the upfront sweetness and the lingering sweetness.

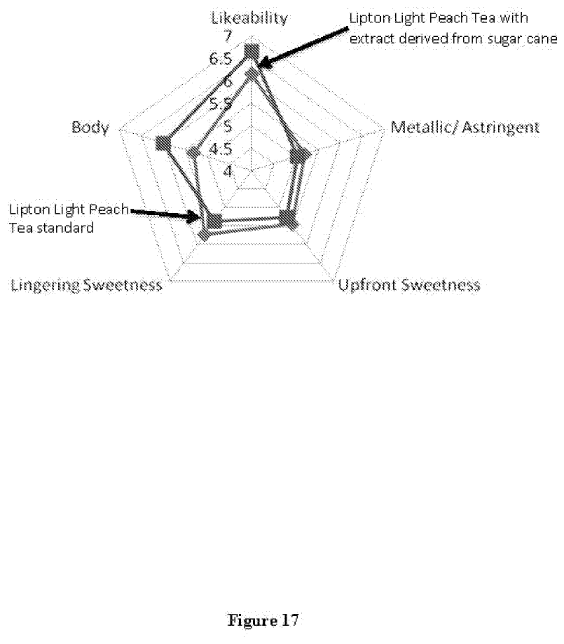

The evaluation results are exhibited in the radar chart comparison of Lipton Light Peach Tea vs Lipton Light Peach Tea with added 0.1% of an extract derived from sugar cane according to the present disclosure (FIG. 17).

### Lipton Peach Tea

Lipton Peach Tea contains the sweetener Stevia and sugar.

13 participants were recruited for the study. Each of the participants was given standard samples of Lipton Peach Tea and test samples of Lipton Peach Tea with 0.1% v/v of an extract derived from sugar cane according to the present disclosure.

Table 21 exhibits the average results of evaluation of the taste and mouthfeel of a standard sample of Lipton Light Peach Tea in comparison to a test sample of Lipton Peach Tea with added 0.1% v/v of an extract derived from sugar cane according to the present disclosure.

TABLE 21
Evaluation of the taste and mouthfeel of a standard sample
of Lipton Peach Tea in comparison to a test sample of Lipton
Peach Tea with added 0.1% v/v of an extract derived from
sugar cane according to the present disclosure.

| | Standard (average) | Test (average) |
|---|---|---|
| Likeability | 5.31 | 6.58 |
| Metallic/Astringent | 6.19 | 4.96 |
| Upfront Sweetness | 5.42 | 5.88 |
| Lingering Sweetness | 6.35 | 5.77 |
| Body | 5.54 | 6.5 |

As is demonstrated by the results, 0.1% of an extract derived from sugar cane according to the present disclosure added to Lipton Peach Tea provided better body, reduced the metallic note and astringency of Lipton Peach Tea and overall, provided a more likeable product. 0.1% of an extract derived from sugar cane according to the present disclosure added to Lipton Peach Tea also increased the upfront sweetness and decreased the lingering sweetness. Although not presented in the table above, participants described that the peach flavours of the tea were decreased and that the black tea taste was enhanced by the addition of 0.1% of an extract derived from sugar cane according to the present disclosure to Lipton Peach Tea.

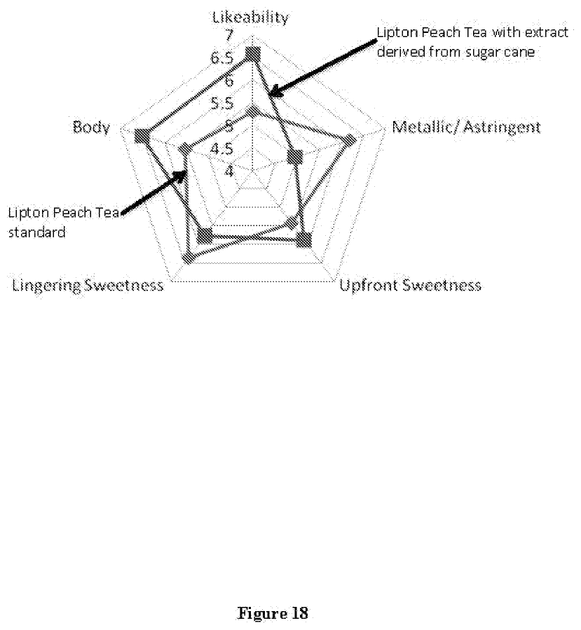

The evaluation results are exhibited in the radar chart comparison of Lipton Peach Tea vs Lipton Peach Tea with added 0.1% of an extract derived from sugar cane according to the present disclosure (FIG. 18).

Schweppes Sunkist Sugar Free Schweppes Sunkist Sugar Free contains the sweetener blend of sucralose, aspartame and acesulfame potassium.

13 participants were recruited for the study. Each of the participants was given standard samples of Schweppes Sunkist Sugar Free and test samples of Schweppes Sunkist Sugar Free with 0.1% v/v of an extract derived from sugar cane according to the present disclosure.

Table 22 exhibits the average results of evaluation of the taste and mouthfeel of a standard sample of Schweppes Sunkist Sugar Free in comparison to a test sample of Schweppes Sunkist Sugar Free with added 0.1% v/v of an extract derived from sugar cane according to the present disclosure.

TABLE 22
Evaluation of the taste and mouthfeel of a standard sample of
Schweppes Sunkist Sugar Free in comparison to a test sample of
Schweppes Sunkist Sugar Free with added 0.1% v/v of an extract
derived from sugar cane according to the present disclosure.

| | Standard (average) | Test (average) |
|---|---|---|
| Likeability | 5.77 | 6.31 |
| Metallic/Astringent | 6.73 | 5.92 |
| Upfront Sweetness | 6.15 | 5.85 |
| Lingering Sweetness | 6.69 | 6.35 |
| Body | 5.73 | 6.58 |

As is demonstrated by the results, 0.1% of an extract derived from sugar cane according to the present disclosure added to Schweppes Sunkist Sugar Free provided better body, reduced the metallic note and astringency of Schweppes Sunkist Sugar Free and overall, provided a more likeable product. 0.1% of an extract derived from sugar cane according to the present disclosure added to Schweppes Sunkist Sugar Free also decreased the upfront sweetness and the lingering sweetness.

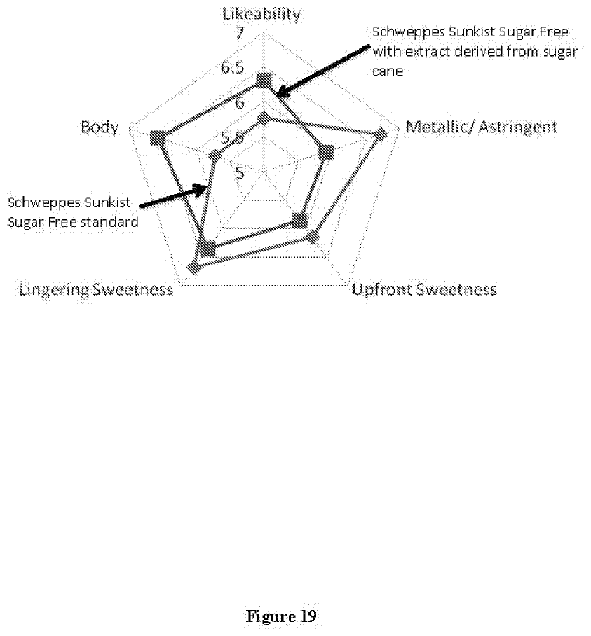

The evaluation results are exhibited in the radar chart comparison of Schweppes Sunkist Sugar Free vs Schweppes Sunkist Sugar Free with added 0.1% of an extract derived from sugar cane according to the present disclosure (FIG. 19).

### Powerade Zero

Powerade Zero contains the sweetener blend of sucralose and acesulfame potassium.

13 participants were recruited for the study. Each of the participants was given standard samples of Powerade Zero and test samples of Powerade Zero with 0.1% v/v of an extract derived from sugar cane according to the present disclosure.

Table 23 exhibits the average results of evaluation of the taste and mouthfeel of a standard sample of Powerade Zero in comparison to a test sample of Powerade Zero with added 0.1% v/v of an extract derived from sugar cane according to the present disclosure.

TABLE 23
Evaluation of the taste and mouthfeel of a standard sample
of Powerade Zero in comparison to a test sample of Powerade
Zero with added 0.1% v/v of an extract derived from sugar
cane according to the present disclosure.

| | Standard (average) | Test (average) |
|---|---|---|
| Likeability | 6.23 | 6.31 |
| Metallic/Astringent | 5.88 | 5.23 |
| Upfront Sweetness | 6.42 | 6.12 |
| Lingering Sweetness | 6.65 | 6.45 |
| Body | 5.62 | 6.15 |

As is demonstrated by the results, 0.1% of an extract derived from sugar cane according to the present disclosure added to Powerade Zero provided better body, reduced the metallic note and astringency of Powerade Zero and overall, provided a more likeable product. 0.1% of an extract derived from sugar cane according to the present disclosure added to Powerade Zero also decreased the upfront sweetness and decreased the lingering sweetness.

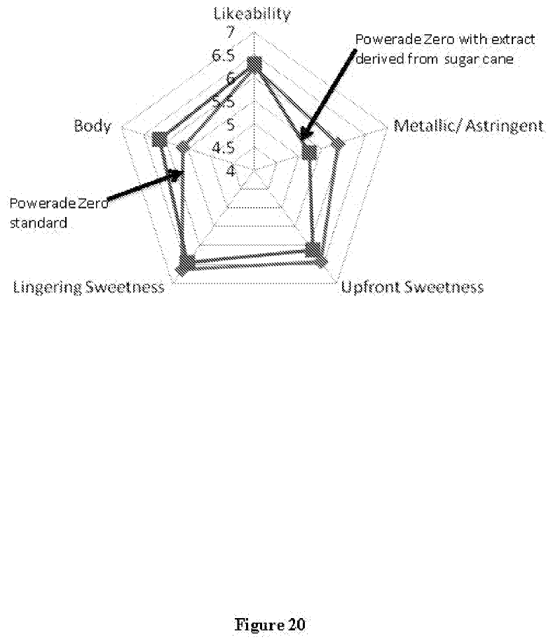

The evaluation results are exhibited in the radar chart comparison of Powerade Zero vs Powerade Zero with added 0.1% of an extract derived from sugar cane according to the present disclosure (FIG. 20).

### V Zero

V Zero contains the sweetener blend of acesulfame potassium and sucralose.

13 participants were recruited for the study. Each of the participants was given standard samples of V Zero and test samples of V Zero with 0.1% v/v of an extract derived from sugar cane according to the present disclosure.

Table 24 exhibits the average results of evaluation of the taste and mouthfeel of a standard sample of V Zero in comparison to a test sample of V Zero with added 0.1% v/v of an extract derived from sugar cane according to the present disclosure.

TABLE 24
Evaluation of the taste and mouthfeel of a standard
sample of V Zero in comparison to a test sample of
V Zero with added 0.1% v/v of an extract derived from
sugar cane according to the present disclosure.

| | Standard (average) | Test (average) |
|---|---|---|
| Likeability | 5 | 6.27 |
| Metallic/Astringent | 6.81 | 5.73 |
| Upfront Sweetness | 5.5 | 5.81 |
| Lingering Sweetness | 5.96 | 5.96 |
| Body | 5.04 | 6.08 |

As is demonstrated by the results, 0.1% of an extract derived from sugar cane according to the present disclosure added to V Zero provided better body, reduced the metallic note and astringency of V Zero and overall, provided a more likeable product. 0.1% of an extract derived from sugar cane according to the present disclosure added to V Zero also increased the upfront sweetness.

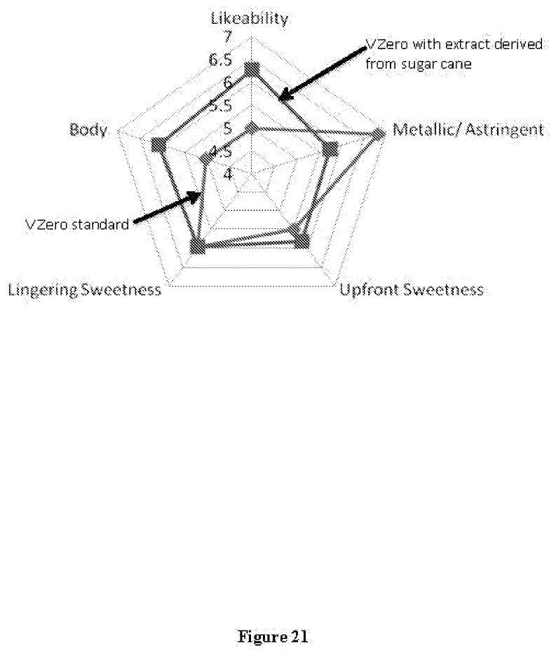

The evaluation results are exhibited in the radar chart comparison of V Zero vs V Zero with added 0.1% of an extract derived from sugar cane according to the present disclosure (FIG. 21).

### V Sugar Free

V Sugar Free contains the sweetener blend of acesulfame potassium and sucralose.

13 participants were recruited for the study. Each of the participants was given standard samples of V Sugar Free and test samples of V Sugar Free with 0.1% v/v of an extract derived from sugar cane according to the present disclosure.

Table 25 exhibits the average results of evaluation of the taste and mouthfeel of a standard sample of V Sugar Free in comparison to a test sample of V Sugar Free with added 0.1% v/v of an extract derived from sugar cane according to the present disclosure.

TABLE 25
Evaluation of the taste and mouthfeel of a standard sample
of V Sugar Free in comparison to a test sample of V Sugar
Free with added 0.1% v/v of an extract derived from sugar
cane according to the present disclosure.

| | Standard (average) | Test (average) |
|---|---|---|
| Likeability | 4.85 | 6.23 |
| Metallic/Astringent | 7 | 6.08 |
| Upfront Sweetness | 5.27 | 5.73 |
| Lingering Sweetness | 6.12 | 5.58 |
| Body | 5.19 | 5.96 |

As is demonstrated by the results, 0.1% of an extract derived from sugar cane according to the present disclosure added to V Sugar Free provided better body, reduced the metallic note and astringency of V Sugar Free and overall, provided a more likeable product. 0.1% of an extract derived from sugar cane according to the present disclosure added to V Sugar Free also increased the upfront sweetness and decreased the lingering sweetness.

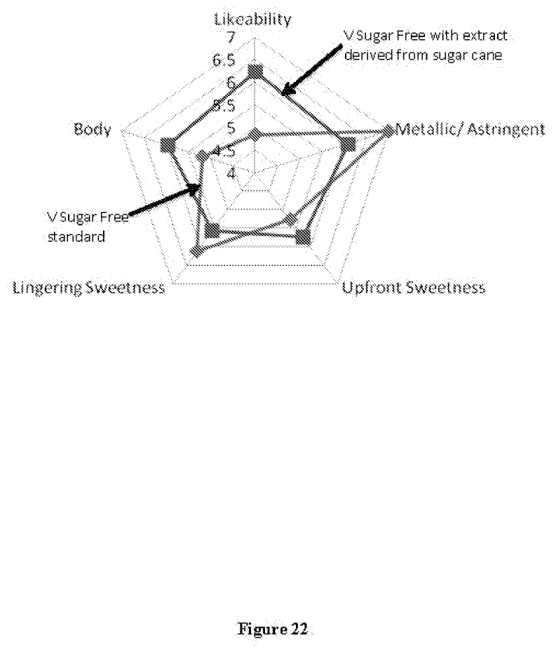

The evaluation results are exhibited in the Radar chart comparison of V Sugar Free vs V Sugar Free with added 0.1% of an extract derived from sugar cane according to the present disclosure (FIG. 22).

### Red Bull Zero

Red Bull Zero contains the sweetener blend of aspartame, sucralose and acesulfame potassium.

13 participants were recruited for the study. Each of the participants was given standard samples of Red Bull Zero and test samples of Red Bull Zero with 0.1% v/v of an extract derived from sugar cane according to the present disclosure.

Table 26 exhibits the average results of evaluation of the taste and mouthfeel of a standard sample of Red Bull Zero in comparison to a test sample of Red Bull Zero with added 0.1% v/v of an extract derived from sugar cane according to the present disclosure.

TABLE 26
Evaluation of the taste and mouthfeel of a standard sample
of Red Bull Zero in comparison to a test sample of Red
Bull Zero with added 0.1% v/v of an extract derived from
sugar cane according to the present disclosure.

| | Standard (average) | Test (average) |
|---|---|---|
| Likeability | 4.31 | 5.23 |
| Metallic/Astringent | 6.77 | 6.04 |
| Upfront Sweetness | 6.08 | 6.08 |
| Lingering Sweetness | 6.27 | 6.08 |
| Body | 4.88 | 5.38 |

As is demonstrated by the results, 0.1% of an extract derived from sugar cane according to the present disclosure added to Red Bull Zero provided better body, reduced the metallic note and astringency of Red Bull Zero and overall, provided a more likeable product. 0.1% of an extract derived from sugar cane according to the present disclosure added to Red Bull Zero also decreased the lingering sweetness.

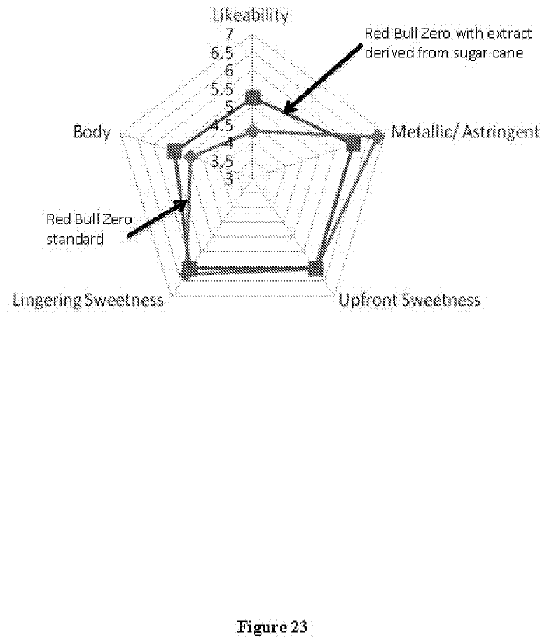

The evaluation results are exhibited in the radar chart comparison of Red Bull Zero vs Red Bull Zero with added 0.1% of an extract derived from sugar cane according to the present disclosure (FIG. 23).

### Red Bull Sugar Free

Red Bull Sugar Free contains the sweetener blend of aspartame, sucralose and acesulfame potassium.

13 participants were recruited for the study. Each of the participants was given standard samples of Red Bull Sugar Free and test samples of Red Bull Sugar Free with 0.1% v/v of an extract derived from sugar cane according to the present disclosure.

Table 27 exhibits the average results of evaluation of the taste and mouthfeel of a standard sample of Red Bull Sugar Free in comparison to a test sample of Red Bull Sugar Free with added 0.1% v/v of an extract derived from sugar cane according to the present disclosure.

TABLE 27
Evaluation of the taste and mouthfeel of a standard sample
of Red Bull Sugar Free in comparison to a test sample of
Red Bull Sugar Free with added 0.1% v/v of an extract derived
from sugar cane according to the present disclosure.

| | Standard (average) | Test (average) |
|---|---|---|
| Likeability | 4.69 | 5.62 |
| Metallic/Astringent | 6.42 | 5.77 |
| Upfront Sweetness | 5.35 | 5.73 |
| Lingering Sweetness | 5.69 | 5.62 |
| Body | 5.04 | 5.81 |

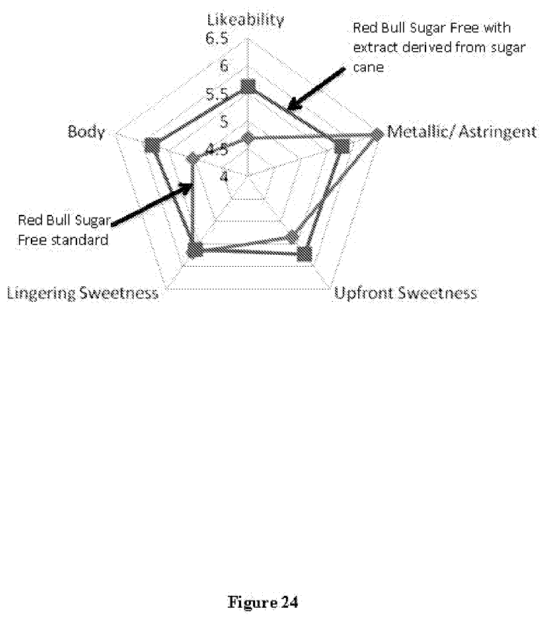

As is demonstrated by the results, 0.1% of an extract derived from sugar cane according to the present disclosure added to Red Bull Sugar Free provided better body, reduced the metallic note and astringency of Red Bull Sugar Free and overall, provided a more likeable product. 0.1% of an extract derived from sugar cane according to the present disclosure added to Red Bull Sugar Free also increased the upfront sweetness and decreased the lingering sweetness. Although not presented in the table above, participants described that the addition of 0.1% of an extract derived from sugar cane according to the present disclosure to Red Bull Zero provided a well rounded beverage. The evaluation results are exhibited in the radar chart comparison of Red Bull Sugar Free vs Red Bull Sugar Free with added 0.1% of an extract derived from sugar cane according to the present disclosure (FIG. 24).

### Example 9. Taste Panel Analysis on Cola Containing Reduced Sugar 1

Extracts derived from sugarcane according to the present disclosure (FIG. 1; sample C) were tested on human participants to evaluate in-use performance of the composition included in cola with 20% reduced sugar relative to standard cola.

Cola containing the standard amount of sugar was prepared with 930.12 g L⁻¹ of carbonated water, 0.295 g L⁻¹ of sodium benzoate, 110 g L⁻¹ of sugar, 1.042 ml L⁻¹ of cola flavour and 1.042 ml L⁻¹ of cola acidulant. Reduced sugar cola was prepared containing 20% less sugar relative to standard cola with 943.92 g L⁻¹ of carbonated water, 0.295 g L⁻¹ of sodium benzoate, 88 g L⁻¹ of sugar, 1.042 ml L⁻¹ of cola flavour and 1.042 ml L⁻¹ of cola acidulant. The test sample was prepared by adding 0.1% v/v of an extract derived from sugar cane to the reduced sugar cola sample.

14 participants were given the standard sample and the test sample and evaluated the samples based on 8 attributes. The participants first tasted the standard sample and from the basis of personal taste provided a rating from 1 to 10; 1 being the lowest perception of that attribute and 10 being the highest perception of that attribute. Participants then tasted the test sample and rated it relative to the standard sample, i.e., whether the perception of the attribute had increased or decreased relative to the standard sample. Results were averaged and plotted on a radar chart.

TABLE 28
Evaluation of the flavours of a standard sample of cola in comparison
to a test sample of reduced sugar cola with added 0.1% v/v of an extract
derived from sugar cane according to the present disclosure.

| | Standard (average) | Test (average) |
|---|---|---|
| Lime | 6.00 | 5.55 |
| Lemon | 5.50 | 5.52 |
| Caramelised sugar | 5.00 | 5.76 |
| Cinnamon | 5.01 | 5.50 |
| Clove | 5.11 | 5.50 |
| Sweet | 6.51 | 5.50 |
| Acid | 5.09 | 5.00 |
| Flavour intensity | 6.51 | 5.90 |

As is demonstrated by the results, the reduced sugar cola sample containing 0.1% v/v of an extract derived from sugar cane according to the present disclosure had a significant difference in the burnt (caramelised) sugar orientation and the sweetness and flavour intensity. Overall, the reduced sugar sample containing 0.1% v/v of an extract derived from sugar cane according to the present disclosure had a comparable flavour profile compared to the standard cola.

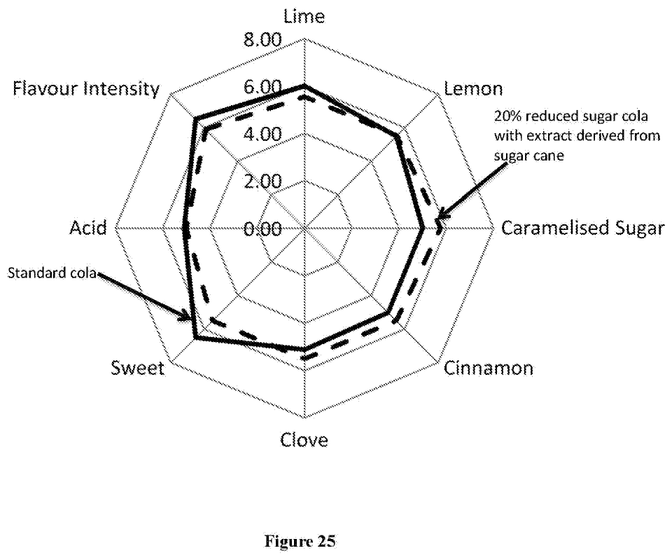

The evaluation results are exhibited in the radar chart comparison of standard cola vs cola containing 20% reduced sugar with added 0.1% v/v of an extract derived from sugar cane according to the present disclosure (FIG. 25).

### Example 10. Taste Panel Analysis on Cola Containing Reduced Sugar 2

Extracts derived from sugarcane according to the present disclosure (FIG. 1; sample C) were tested on human participants to evaluate in-use performance of the composition included in cola with reduced sugar (20% or 30%).

Reduced sugar cola was prepared either containing 20% or 30% less sugar relative to standard cola. Reduced sugar cola containing 20% less sugar was prepared with 943.92 g L⁻¹ of carbonated water, 0.295 g L⁻¹ of sodium benzoate, 88 g L⁻¹ of sugar, 1.042 ml L⁻¹ of cola flavour and 1.042 ml L⁻¹ of cola acidulant. Reduced sugar cola containing 30% less sugar was prepared with 963.12 g L⁻¹ of carbonated water, 0.295 g L⁻¹ of sodium benzoate, 77 g L⁻¹ of sugar, 1.042 ml L⁻¹ of cola flavour and 1.042 ml L⁻¹ of cola acidulant. The test samples were prepared by adding 0.1% v/v of an extract derived from sugar cane to the reduced sugar (20% and 30%) cola samples.

14 participants were given reduced sugar cola samples and the test cola samples and evaluated the samples based on 5 attributes. The participants first tasted the reduced sugar samples and from the basis of personal taste provided a rating from 1 to 10; 1 being the lowest perception of that attribute and 10 being the highest perception of that attribute. Participants then tasted the test samples and rated it relative to the reduced sugar samples, i.e., whether the perception of the attribute had increased or decreased relative to the reduced sugar samples. Results were averaged and plotted on a radar chart.

Table 29 exhibits the average results of evaluation of taste and mouthfeel of the reduced sugar cola samples in comparison to test samples of reduced sugar cola with added 0.1% v/v of an extract derived from sugar cane according to the present disclosure.

TABLE 29
Evaluation of the taste and mouthfeel of the reduced sugar
cola samples in comparison to test samples of reduced
sugar cola with added 0.1% v/v of an extract derived
from sugar cane according to the present disclosure.

| | 20% | 20% reduced | 30% | 30% reduced |
|---|---|---|---|---|
| | reduced | sugar + 0.1% | reduced | sugar + 0.1% |
| | sugar | extract | sugar | extract |
| Upfront sweetness | 4.90 | 5.56 | 4.50 | 4.35 |
| Lingering sweetness | 5.09 | 5.49 | 4.66 | 4.51 |
| Flavour intensity | 5.02 | 6.08 | 4.90 | 4.55 |
| Body | 5.34 | 5.40 | 5.28 | 4.40 |
| Overall likeability | 5.66 | 5.69 | 4.31 | 4.52 |

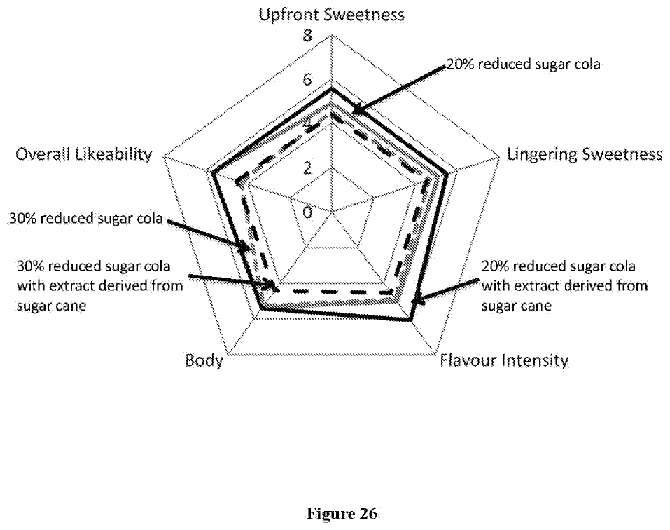

The evaluation results are exhibited in the radar chart comparison of reduced sugar colas vs reduced sugar colas with added 0.1% of an extract derived from sugar cane according to the present disclosure (FIG. 26).

Samples containing 20% reduced sugar with added 0.1% of an extract derived from sugar cane according to the present disclosure had increased flavour intensity, upfront sweetness and lingering sweetness.

### Example 11. Taste Panel Analyses on Reduced Sugar Beverages

Extracts derived from sugarcane according to the present disclosure (FIG. 1; sample C) were tested on human participants to evaluate in-use performance of the composition in beverages containing 20% reduced sugar relative to the equivalent standard beverages. These beverages include chocolate soy milk, lemon tea, a coffee drink, an energy drink and a chocolate cereal drink.

Standard samples of beverages and reduced sugar beverages were prepared or obtained commercially. The test samples were prepared by adding 0.03-0.1% v/v of an extract derived from sugar cane to each of the reduced sugar beverages. For the beverage studies, participants were given the standard sample and the test samples. The participants then evaluated the samples based on 5 attributes. Participants first tasted the standard sample and from the basis of personal taste provided a rating from 1 to 10; 1 being the lowest perception of that attribute and 10 being the highest perception of that attribute. Participants then tasted the test sample and rated the test sample relative to the standard sample, i.e., whether the perception of the attribute had increased or decreased relative to the standard sample. Results were averaged and plotted on a radar chart.

### Chocolate Soy Milk

13 participants were recruited for the study. Each of the participants was given standard samples of chocolate soy milk and chocolate soy milk with 20% reduced sugar relative to the standard with 0.05% v/v of an extract derived from sugar cane according to the present disclosure (FIG. 1; sample C).

Standard and reduced sugar chocolate soy milk samples with an extract derived from sugar cane according to the present disclosure were prepared according to Table 30.

TABLE 30
Chocolate soy milk formulation (per L)

| | | | Quantity in reduced | |
|---|---|---|---|---|
| | Quantity in standard | | sugar formulation with | |
| Ingredient | formulation (Standard) | | extract (Test) | |
| Soy milk | 991.18 | g | 972.5 | g |
| Cocoa powder | 4 | g | 4 | g |
| Sugar | 50 | g | 40 | g |
| Natural chocolate flavour | 3 | ml | 3 | ml |

| | | | |
|---|---|---|---|
| Sugar cane extract | — | 0.5 | ml |

Table 31 exhibits the average results of evaluation of the taste and mouthfeel of a standard sample of chocolate soy milk in comparison to a test sample of chocolate soy milk containing 20% reduced sugar with added 0.05% v/v of an extract derived from sugar cane according to the present disclosure.

TABLE 31
Evaluation of the taste and mouthfeel of a reduced sugar chocolate
soy milk sample in comparison to a test sample of reduced sugar
chocolate soy milk with added 0.05% v/v of an extract derived
from sugar cane according to the present disclosure.

| | Standard (average) | Test (average) |
|---|---|---|
| Upfront sweetness | 6.54 | 5.50 |
| Lingering sweetness | 6.08 | 5.85 |
| Flavour intensity | 6.54 | 6.58 |
| Body | 5.92 | 6.54 |
| Overall likeability | 5.69 | 5.39 |

As is demonstrated by the results, the reduced sugar chocolate soy milk with 0.05% v/v of an extract derived from sugar cane according to the present disclosure had better body compared to the standard chocolate soy milk. Furthermore, according to the participants, the overall attributes of the test sample were comparable to the standard product.

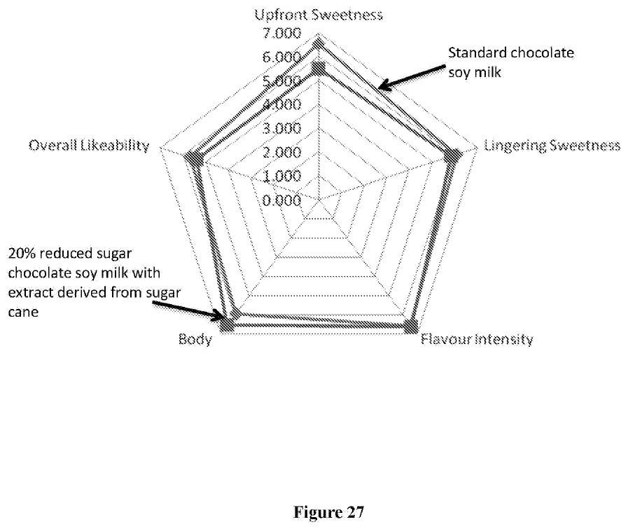

The evaluation results are exhibited in the radar chart comparison of standard chocolate soy milk vs reduced sugar chocolate soy milk with added 0.05% v/v of an extract derived from sugar cane according to the present disclosure (FIG. 27).

### Lemon Tea

13 participants were recruited for the study. Each of the participants was given standard samples of lemon tea and lemon tea with 20% reduced sugar relative to the standard with 0.1% v/v of an extract derived from sugar cane according to the present disclosure (FIG. 1).

Standard and reduced sugar lemon tea samples with an extract derived from sugar cane according to the present disclosure were prepared according to Table 32.

TABLE 32
Lemon tea formulation (per L)

| | | | Quantity in reduced | |
|---|---|---|---|---|
| | Quantity in standard | | sugar formulation with | |
| Ingredient | formulation (Standard) | | extract (Test) | |
| Water | 954.8 | g | 963.16 | g |
| Sugar | 68.3 | g | 54.64 | g |
| Black tea extract | 1.5 | g | 1.5 | g |
| Citric acid | 2.0 | g | 2.0 | g |
| Ascorbic acid | 0.2 | g | 0.2 | g |
| Natural lemon flavour | 1 | ml | 1 | ml |

| | | | |
|---|---|---|---|
| Sugar cane extract | — | 1 | ml |

Table 33 exhibits the average results of evaluation of the taste and mouthfeel of a standard sample of lemon tea in comparison to a test sample of lemon tea containing 20% reduced sugar with added 0.1% v/v of an extract derived from sugar cane according to the present disclosure.

TABLE 33
Evaluation of the taste and mouthfeel of a reduced sugar
lemon tea sample in comparison to a test sample of reduced
sugar lemon tea with added 0.1% v/v of an extract derived
from sugar cane according to the present disclosure.

| | Standard (average) | Test (average) |
|---|---|---|
| Upfront sweetness | 5.46 | 3.808 |
| Lingering sweetness | 5.46 | 5.62 |
| Flavour intensity | 6.54 | 5.50 |
| Body | 5.77 | 6.00 |
| Overall likeability | 5.54 | 5.08 |

As is demonstrated by the results, reduced sugar lemon tea with 0.1% v/v of an extract derived from sugar cane according to the present disclosure had better body compared to the standard lemon tea. Overall, the participants agreed that all the attributes of the test sample were similar to the standard product.

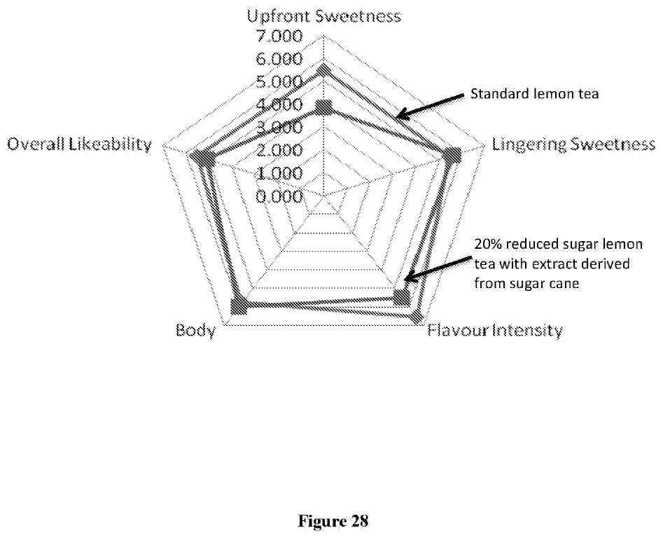

The evaluation results are exhibited in the radar chart comparison of standard lemon tea vs reduced sugar lemon tea with added 0.1% v/v of an extract derived from sugar cane according to the present disclosure (FIG. 28).

### Coffee Drink

13 participants were recruited for the study. Each of the participants was given standard samples of a coffee drink and a coffee drink with 20% reduced sugar relative to the standard with 0.1% v/v of an extract derived from sugar cane according to the present disclosure (FIG. 1; sample C).

Standard and reduced sugar coffee drink samples with an extract derived from sugar cane according to the present disclosure were prepared according to Table 34.

TABLE 34
Coffee drink formulation (per L)

| | | | Quantity in reduced | |
|---|---|---|---|---|
| | Quantity in standard | | sugar formulation with | |
| Ingredient | formulation (Standard) | | extract (Test) | |
| Water | 738.2 | g | 748.83 | g |
| Sugar | 85 | g | 68 | g |
| Coffee powder | 20 | g | 20 | g |
| Milk | 200 | g | 200 | g |
| Natural coffee flavour | 2 | ml | 2 | ml |

| | | | |
|---|---|---|---|
| Sugar cane extract | — | 1 | ml |

Table 35 exhibits the average results of evaluation of the taste and mouthfeel of a standard sample of the coffee drink in comparison to a test sample of the coffee drink containing 20% reduced sugar with added 0.1% v/v of an extract derived from sugar cane according to the present disclosure.

TABLE 35
Evaluation of the taste and mouthfeel of a reduced sugar coffee
drink sample in comparison to a test sample of reduced sugar
coffee drink with added 0.1% v/v of an extract derived from
sugar cane according to the present disclosure.

| | Standard (average) | Test (average) |
|---|---|---|
| Upfront sweetness | 6.92 | 4.85 |
| Lingering sweetness | 6.54 | 4.77 |
| Flavour intensity | 6.69 | 7.42 |
| Body | 6.15 | 6.58 |
| Overall likeability | 6.31 | 6.04 |

As is demonstrated by the results, the reduced sugar coffee drink with 0.1% v/v of an extract derived from sugar cane according to the present disclosure had better body and increased flavour intensity compared to the standard product. According to the participants, the overall likeability of the test sample was also comparable to the standard product.

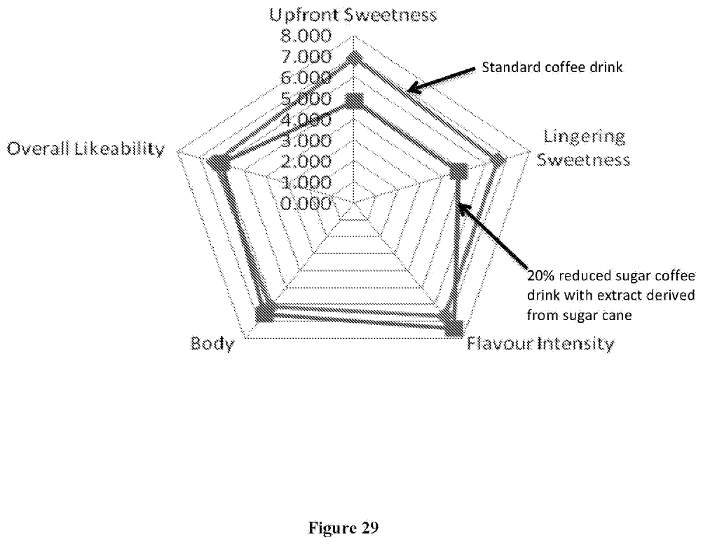

The evaluation results are exhibited in the radar chart comparison of standard coffee drink vs reduced sugar coffee drink with added 0.1% v/v of an extract derived from sugar cane according to the present disclosure (FIG. 29).

### Energy Drink

13 participants were recruited for the study. Each of the participants was given standard samples of an energy drink and an energy drink with 20% reduced sugar relative to the standard with 0.05% v/v of an extract derived from sugar cane according to the present disclosure (FIG. 1; sample C).

Standard and reduced sugar energy drink samples with an extract derived from sugar cane according to the present disclosure were prepared according to Table 36.

TABLE 36
Energy drink formulation (per L)

| | | | Quantity in reduced | |
|---|---|---|---|---|
| | Quantity in standard | | sugar formulation with | |
| Ingredient | formulation (Standard) | | extract (Test) | |
| Carbonated water | 865.58 | g | 892.38 | g |
| Sugar | 212.04 | g | 168.04 | g |
| Sodium benzoate | 0.3 | g | 0.3 | g |
| Citric acid | 3.5 | g | 3.5 | g |
| Caffeine | 0.16 | g | 0.16 | g |
| Mixed fruit flavour | 0.8 | ml | 0.8 | ml |
| Energy flavour | 0.2 | ml | 0.2 | ml |
| Sunset yellow colour | 0.325 | ml | 0.325 | ml |
| (5%) | | | | |
| Tartrazine colour (5%) | 0.1 | ml | 0.1 | ml |

| | | | |
|---|---|---|---|
| Sugar cane extract | — | 0.5 | ml |

Table 37 exhibits the average results of evaluation of the taste and mouthfeel of a standard sample of the energy drink in comparison to a test sample of the energy drink containing 20% reduced sugar with added 0.05% v/v of an extract derived from sugar cane according to the present disclosure.

TABLE 37
Evaluation of the taste and mouthfeel of an energy drink
sample in comparison to a test sample of a reduced sugar
energy drink with added 0.05% v/v of an extract derived
from sugar cane according to the present disclosure.

| | Standard (average) | Test (average) |
|---|---|---|
| Upfront sweetness | 7.35 | 6.92 |
| Lingering sweetness | 7.23 | 6.69 |
| Flavour intensity | 7.23 | 6.85 |
| Body | 6.96 | 7.12 |
| Overall likeability | 5.54 | 6.31 |

As is demonstrated by the results, the reduced sugar energy drink with 0.05% v/v of an extract derived from sugar cane according to the present disclosure had better body and increased overall likeability of the product. Overall, the participants agreed that the reduced sugar energy drink with 0.05% v/v of an extract derived from sugar cane according to the present disclosure was substantially similar to the standard product.

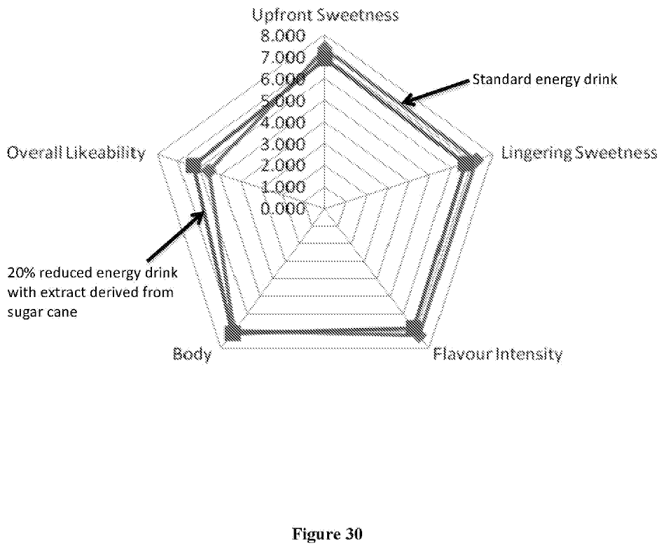

The evaluation results are exhibited in the radar chart comparison of standard energy drink vs reduced sugar energy drink with added 0.05% v/v of an extract derived from sugar cane according to the present disclosure (FIG. 30).

### Chocolate Cereal Drink

13 participants were recruited for the study. Each of the participants was given commercially obtained samples of standard Sanitarium chocolate Up & Go and Sanitarium chocolate Up & Go with 20% reduced sugar relative to the standard with 0.03% v/v of a an extract derived from sugar cane according to the present disclosure (FIG. 1; sample C).

Table 38 exhibits the average results of evaluation of the taste and mouthfeel of a standard sample of chocolate Up & Go in comparison to a test sample of chocolate Up & Go containing 20% reduced sugar with added 0.03% v/v of an extract derived from sugar cane according to the present disclosure.

TABLE 38
Evaluation of the taste and mouthfeel of standard chocolate
Up & Go in comparison to a test sample of a reduced sugar
chocolate Up & Go with added 0.03% v/v of an extract derived
from sugar cane according to the present disclosure.

| | Standard (average) | Test (average) |
|---|---|---|
| Upfront sweetness | 6.15 | 5.48 |
| Lingering sweetness | 5.68 | 5.53 |
| Flavour intensity | 6.20 | 5.82 |
| Body | 5.98 | 5.79 |
| Overall likeability | 6.63 | 4.89 |

As is demonstrated by the results, the reduced sugar chocolate Up & Go with 0.03% v/v of an extract derived from sugar cane according to the present disclosure had comparable body, flavour intensity and lingering sweetness to the standard chocolate Up & Go. Overall, the participants agreed that the reduced sugar chocolate Up & Go with 0.03% v/v of an extract derived from sugar cane according to the present disclosure was substantially similar to the standard chocolate Up & Go.

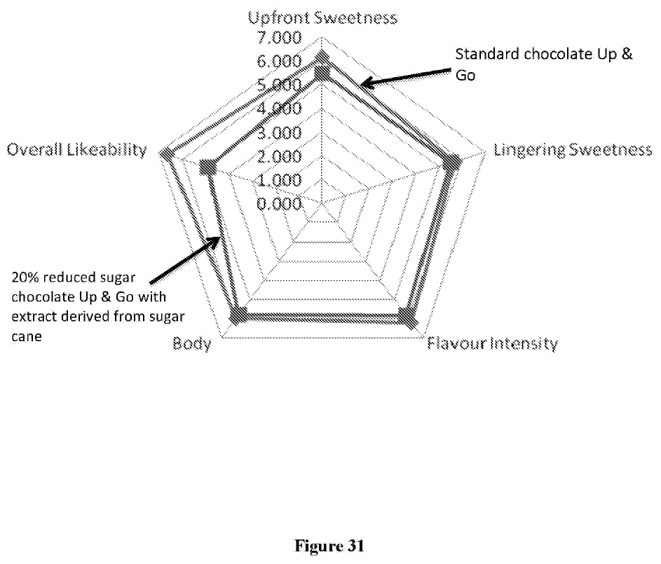

The evaluation results are exhibited in the radar chart comparison of standard Up & Go vs reduced sugar Up & Go with added 0.03% v/v of an extract derived from sugar cane according to the present disclosure (FIG. 31).

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A method for improving or masking taste or mouthfeel of a consumable containing a sugar substitute, the method comprising including from about 0.01 wt % to about 10 wt % or about 0.01% v/v to about 10% v/v of an extract derived from sugar cane in the consumable, the extract comprising from about 10 catechin equivalent (CE) g/L to about 50 CE g/L of polyphenols or from about 100 CE mg/g to about 500 CE mg/g of polyphenols.

2. A method for improving or masking taste or mouthfeel of a low sugar or reduced sugar consumable, the method comprising including from about 0.01 wt % to about 10 wt % or about 0.01% v/v to about 10% v/v of an extract derived from sugar cane in the consumable, the extract comprising from about 10 catechin equivalent (CE) g/L to about 50 CE g/L of polyphenols or from about 100 CE mg/g to about 500 CE mg/g of polyphenols.

3. The method of claim 2, wherein the low sugar consumable contains less than about 5% of sugar.

4. The method of claim 2, wherein the reduced sugar consumable contains about 10% to about 30% less sugar than a standard version of the consumable.

5. The method of claim 1, wherein the consumable comprises from about 0.01 wt % to about 1.0 wt % or about 0.01% v/v to about 1.0% v/v of the extract.

6. The method of claim 1, wherein the sugar substitute is in the range of: i) from about 0.0001 wt % to about 0.1 wt % of the consumable; or ii) from about 0.001 wt % to about 0.01 wt % of the consumable.

7. (canceled)

8. The method of claim 1, wherein the taste is selected from the group consisting of sweet, bitter, metallic, astringent, acidity, sour, fruity, salty, liquorice, umami and combinations thereof.

9. (canceled)

10. The method of claim 1, wherein the mouthfeel is selected from the group consisting of smooth, dry, chalky, grainy, greasy, gummy, watery, oily, tingly, waxy, bound, rough, round, slimy, body and combinations thereof.

11. The method of claim 1, wherein the sugar substitute is selected from the group consisting of stevia, stevioside, steviol glycosides, rebaudioside A, rebaudioside B, rebaudioside C, rebaudioside D, rebaudioside E, rebaudioside F, dulcoside A, dulcoside B, aspartame, acesulfame potassium, sucralose, cyclamate, saccharin, mogroside, mogroside IV, mogroside V, rubusoside, siamenoside, monatin, monatin SS, monatin RR, monatin RS, monatin SR, curculin, glycyrrhizic acid and its salts, thaumatin, monellin, mabinlin, brazzein, hernandulcin, phyllodulcin, glycyphyllin, phloridzin, trilobatin, baiyunoside, osladin, polypodoside, polypodoside A, pterocaryoside, pterocaryoside A, pterocaryoside B, mukurozioside, phlomisoside, phlomisoside I, periandrin, periandrin I, abrusoside, abrusoside A, clocarioside, cyclocarioside I, Monk fruit extracts, neotame, advantame, erythritol, arabitol, isomalt, lactitol, maltitol, mannitol, sorbitol, xylitol, isomaltulose, sugar alcohols, salts and combinations thereof.

12. (canceled)

13. (canceled)

14. (canceled)

15. (canceled)

16. (canceled)

17. (canceled)

18. The method of claim 1, wherein the consumable is a carbonated beverage selected from the group consisting of a cola, fruit-flavoured beverage, a root beer, alcoholic beverage and flavoured water.

19. (canceled)

20. The method of claim 1, wherein the consumable is a beverage selected from the group consisting of a fruit juice, fruit-containing beverage, vegetable juice, vegetable-containing beverage, tea, coffee, dairy beverage, cocoa beverage, soy milk, flavoured animal milk, almond milk, coconut milk, liquid breakfast, sports drink, energy drink, alcoholic beverage, fermented products and flavoured water.

21. (canceled)

22. The method of claim 1, wherein the extract is derived from a sugar cane derived product selected from the group consisting of molasses, massecuite, bagasse, first expressed juice, mill mud, clarified sugar cane juice, clarified syrup, treacle, golden syrup, field trash, cane strippings, dunder and combinations thereof.

23. The method of claim 10, wherein the sugar cane derived product is molasses.

24. The method of claim 1, wherein the extract comprises from about 15 CE g/L to about 40 CE g/L of polyphenols or about 150 CE mg/g to about 400 CE mg/g of polyphenols.

25. The method of claim 1, wherein the polyphenols comprise one or more of syringic acid, chlorogenic acid, caffeic acid, vanillin, sinapic acid, p-coumaric acid, ferulic acid, gallic acid, vanillic acid, diosmin, diosmetin, apigenin, vitexin, orientin, homoorientin, swertisin, tricin, (+)catechin, (−)catechin gallate, (−)epicatechin, quercetin, kaempherol, myricetin, rutin, schaftoside, isoschaftoside and luteolin.

26. (canceled)

27. (canceled)

28. A composition comprising a sugar substitute and a constituent to improve or mask taste or mouthfeel of the sugar substitute, wherein the constituent comprises an extract derived from sugar cane comprising about 10 CE g/L to about 50 CE g/L of polyphenols or from about 100 CE mg/g to about 500 CE mg/g of polyphenols, wherein the constituent contains from about 0.01 wt % to about 10 wt % or about 0.01% v/v to about 10% v/v of the extract derived from sugar cane.

29. The composition of claim 16 in a dry form or a liquid form.

30. The composition of claim 16, wherein the constituent is coated onto the sugar substitute.

31. A consumable or a beverage comprising the composition of claim 16.

32. (canceled)

33. A taste or mouthfeel improving or masking agent, wherein the agent is an extract derived from sugar cane comprising about 10 CE g/L to about 50 CE g/L of polyphenols or from about 100 CE mg/g to about 500 CE mg/g of polyphenols.
